(19) United States
(12) Patent Application Publication
(10) Pub. No.: US 2024/0031600 A1
(43) Pub. Date: Jan. 25, 2024

(54) INTER PREDICTION DIRECTION AND BCW INDEX CODING IN MERGE MODE

(71) Applicant: Tencent America LLC, Palo Alto, CA (US)

(72) Inventors: Guichun LI, San Jose, CA (US); Xin ZHAO, Santa Clara, CA (US); Lien-Fei CHEN, Hsinchu (TW); Shan LIU, San Jose, CA (US)

(73) Assignee: Tencent America LLC, Palo Alto, CA (US)

(21) Appl. No.: 17/984,907

(22) Filed: Nov. 10, 2022

Related U.S. Application Data
(60) Provisional application No. 63/390,565, filed on Jul. 19, 2022.

(51) Int. Cl. H04N 19/577; H04N 19/176; H04N 19/172; H04N 19/70; H04N 19/109; H04N 19/139; H04N 19/513; H04N 19/159

(52) U.S. Cl. CPC H04N 19/577; H04N 19/176; H04N 19/172; H04N 19/70; H04N 19/109; H04N 19/139; H04N 19/513; H04N 19/159

(57) ABSTRACT

Processing circuitry receives a video bitstream and obtains prediction information of a current block in a current picture from the video bitstream. The prediction information is indicative of whether the current block is to be predicted in an inter prediction mode. In response to the current block being predicted in the inter prediction mode, the processing circuitry determines a merge candidate from a merge candidate list, and determines an inter prediction direction based on a syntax element signaled in the video bitstream. The inter prediction direction signaled separately from the merge candidate is one of a first uni-prediction from a first reference picture list, a second uni-prediction from a second reference picture list, and a bi-prediction from the first reference picture list and the second reference picture list. The processing circuitry determines a motion vector, and reconstructs the current block based on the inter prediction direction and the motion vector.

### INCORPORATION BY REFERENCE

The present disclosure claims the benefit of priority to U.S. Provisional Application No. 63/390,565, “Inter prediction direction and BCW index coding in merge mode” filed on Jul. 19, 2022, which is incorporated by reference herein in its entirety.

### TECHNICAL FIELD

The present disclosure describes embodiments generally related to video coding.

### BACKGROUND

The background description provided herein is for the purpose of generally presenting the context of the disclosure. Work of the presently named inventors, to the extent the work is described in this background section, as well as aspects of the description that may not otherwise qualify as prior art at the time of filing, are neither expressly nor impliedly admitted as prior art against the present disclosure.

Uncompressed digital images and/or video can include a series of pictures, each picture having a spatial dimension of, for example, 1920×1080 luminance samples and associated chrominance samples. The series of pictures can have a fixed or variable picture rate (informally also known as frame rate), of, for example 60 pictures per second or 60 Hz. Uncompressed image and/or video has specific bitrate requirements. For example, 1080p60 4:2:0 video at 8 bit per sample (1920×1080 luminance sample resolution at 60 Hz frame rate) requires close to 1.5 Gbit/s bandwidth. An hour of such video requires more than 600 GBytes of storage space.

One purpose of image and/or video coding and decoding can be the reduction of redundancy in the input image and/or video signal, through compression. Compression can help reduce the aforementioned bandwidth and/or storage space requirements, in some cases by two orders of magnitude or more. Although the descriptions herein use video encoding/decoding as illustrative examples, the same techniques can be applied to image encoding/decoding in similar fashion without departing from the spirit of the present disclosure. Both lossless compression and lossy compression, as well as a combination thereof can be employed. Lossless compression refers to techniques where an exact copy of the original signal can be reconstructed from the compressed original signal. When using lossy compression, the reconstructed signal may not be identical to the original signal, but the distortion between original and reconstructed signals is small enough to make the reconstructed signal useful for the intended application. In the case of video, lossy compression is widely employed. The amount of distortion tolerated depends on the application; for example, users of certain consumer streaming applications may tolerate higher distortion than users of television distribution applications. The compression ratio achievable can reflect that: higher allowable/tolerable distortion can yield higher compression ratios.

A video encoder and decoder can utilize techniques from several broad categories, including, for example, motion compensation, transform processing, quantization, and entropy coding.

Video codec technologies can include techniques known as intra coding. In intra coding, sample values are represented without reference to samples or other data from previously reconstructed reference pictures. In some video codecs, the picture is spatially subdivided into blocks of samples. When all blocks of samples are coded in intra mode, that picture can be an intra picture. Intra pictures and their derivations such as independent decoder refresh pictures, can be used to reset the decoder state and can, therefore, be used as the first picture in a coded video bitstream and a video session, or as a still image. The samples of an intra block can be exposed to a transform, and the transform coefficients can be quantized before entropy coding. Intra prediction can be a technique that minimizes sample values in the pre-transform domain. In some cases, the smaller the DC value after a transform is, and the smaller the AC coefficients are, the fewer the bits that are required at a given quantization step size to represent the block after entropy coding.

Traditional intra coding used in, for example, MPEG-2 generation coding technologies, does not use intra prediction. However, some newer video compression technologies include techniques that attempt to perform prediction based on, for example, surrounding sample data and/or metadata obtained during the encoding and/or decoding of blocks of data. Such techniques are henceforth called “intra prediction” techniques. Note that in at least some cases, intra prediction is using reference data only from the current picture under reconstruction and not from reference pictures.

There can be many different forms of intra prediction. When more than one of such techniques can be used in a given video coding technology, a specific technique in use can be coded as a specific intra prediction mode that uses the specific technique. In certain cases, intra prediction modes can have submodes and/or parameters, where the submodes and/or parameters can be coded individually or included in a mode codeword, which defines the prediction mode being used. Which codeword to use for a given mode, submode, and/or parameter combination can have an impact in the coding efficiency gain through intra prediction, and so can the entropy coding technology used to translate the codewords into a bitstream.

A certain mode of intra prediction was introduced with H.264, refined in H.265, and further refined in newer coding technologies such as joint exploration model (JEM), versatile video coding (VVC), and benchmark set (BMS). A predictor block can be formed using neighboring sample values of already available samples. Sample values of neighboring samples are copied into the predictor block according to a direction. A reference to the direction in use can be coded in the bitstream or may itself be predicted.

Referring to FIG. 1A, depicted in the lower right is a subset of nine predictor directions known from the 33 possible predictor directions (corresponding to the 33 angular modes of the 35 intra modes) defined in H.265. The point where the arrows converge (101) represents the sample being predicted. The arrows represent the direction from which the sample is being predicted. For example, arrow (102) indicates that sample (101) is predicted from a sample or samples to the upper right, at a 45 degree angle from the horizontal. Similarly, arrow (103) indicates that sample (101) is predicted from a sample or samples to the lower left of sample (101), in a 22.5 degree angle from the horizontal.

Still referring to FIG. 1A, on the top left there is depicted a square block (104) of 4×4 samples (indicated by a dashed, boldface line). The square block (104) includes 16 samples, each labelled with an “S”, its position in the Y dimension (e.g., row index) and its position in the X dimension (e.g., column index). For example, sample S21 is the second sample in the Y dimension (from the top) and the first (from the left) sample in the X dimension. Similarly, sample S44 is the fourth sample in block (104) in both the Y and X dimensions. As the block is 4×4 samples in size, S44 is at the bottom right. Further shown are reference samples that follow a similar numbering scheme. A reference sample is labelled with an R, its Y position (e.g., row index) and X position (column index) relative to block (104). In both H.264 and H.265, prediction samples neighbor the block under reconstruction; therefore, no negative values need to be used.

Intra picture prediction can work by copying reference sample values from the neighboring samples indicated by the signaled prediction direction. For example, assume the coded video bitstream includes signaling that, for this block, indicates a prediction direction consistent with arrow (102)—that is, samples are predicted from samples to the upper right, at a 45 degree angle from the horizontal. In that case, samples S41, S32, S23, and S14 are predicted from the same reference sample R05. Sample S44 is then predicted from reference sample R08.

In certain cases, the values of multiple reference samples may be combined, for example through interpolation, in order to calculate a reference sample; especially when the directions are not evenly divisible by 45 degrees.

The number of possible directions has increased as video coding technology has developed. In H.264 (year 2003), nine different direction could be represented. That increased to 33 in H.265 (year 2013). Currently, JEM/VVC/BMS can support up to 65 directions. Experiments have been conducted to identify the most likely directions, and certain techniques in the entropy coding are used to represent those likely directions in a small number of bits, accepting a certain penalty for less likely directions. Further, the directions themselves can sometimes be predicted from neighboring directions used in neighboring, already decoded, blocks.

FIG. 1B shows a schematic (110) that depicts 65 intra prediction directions according to JEM to illustrate the increasing number of prediction directions over time.

The mapping of intra prediction direction bits that represent the direction in the coded video bitstream can be different from video coding technology to video coding technology. Such mapping can range, for example, from simple direct mappings, to codewords, to complex adaptive schemes involving most probable modes, and similar techniques. In most cases, however, there can be certain directions that are statistically less likely to occur in video content than certain other directions. As the goal of video compression is the reduction of redundancy, those less likely directions will, in a well working video coding technology, be represented by a larger number of bits than more likely directions.

Image and/or video coding and decoding can be performed using inter-picture prediction with motion compensation. Motion compensation can be a lossy compression technique and can relate to techniques where a block of sample data from a previously reconstructed picture or part thereof (reference picture), after being spatially shifted in a direction indicated by a motion vector (MV henceforth), is used for the prediction of a newly reconstructed picture or picture part. In some cases, the reference picture can be the same as the picture currently under reconstruction. MVs can have two dimensions X and Y, or three dimensions, the third being an indication of the reference picture in use (the latter, indirectly, can be a time dimension).

In some video compression techniques, an MV applicable to a certain area of sample data can be predicted from other MVs, for example from those related to another area of sample data spatially adjacent to the area under reconstruction, and preceding that MV in decoding order. Doing so can substantially reduce the amount of data required for coding the MV, thereby removing redundancy and increasing compression. MV prediction can work effectively, for example, because when coding an input video signal derived from a camera (known as natural video) there is a statistical likelihood that areas larger than the area to which a single MV is applicable move in a similar direction and, therefore, can in some cases be predicted using a similar motion vector derived from MVs of neighboring area. That results in the MV found for a given area to be similar or the same as the MV predicted from the surrounding MVs, and that in turn can be represented, after entropy coding, in a smaller number of bits than what would be used if coding the MV directly. In some cases, MV prediction can be an example of lossless compression of a signal (namely: the MVs) derived from the original signal (namely: the sample stream). In other cases, MV prediction itself can be lossy, for example because of rounding errors when calculating a predictor from several surrounding MVs.

Various MV prediction mechanisms are described in H.265/HEVC (ITU-T Rec. H.265, “High Efficiency Video Coding”, December 2016). Out of the many MV prediction mechanisms that H.265 offers, described with reference to FIG. 2 is a technique henceforth referred to as “spatial merge”.

Referring to FIG. 2, a current block (201) comprises samples that have been found by the encoder during the motion search process to be predictable from a previous block of the same size that has been spatially shifted. Instead of coding that MV directly, the MV can be derived from metadata associated with one or more reference pictures, for example from the most recent (in decoding order) reference picture, using the MV associated with either one of five surrounding samples, denoted A0, A1, and B0, B1, B2 (202 through 206, respectively). In H.265, the MV prediction can use predictors from the same reference picture that the neighboring block is using.

### SUMMARY

Aspects of the disclosure provide methods and apparatuses for video encoding/decoding. In some examples, an apparatus for video decoding includes processing circuitry. In some embodiments, processing circuitry receives a video bitstream that includes a current block in a current picture. The processing circuitry obtains prediction information from the video bitstream. The prediction information is indicative of whether the current block is to be predicted in an inter prediction mode. In response to the current block being predicted in the inter prediction mode, the processing circuitry determines a merge candidate from a merge candidate list, and determines an inter prediction direction based on a syntax element signaled in the video bitstream. The inter prediction direction signaled separately from the merge candidate is one of a first uni-prediction from a first reference picture list, a second uni-prediction from a second reference picture list, and a bi-prediction from the first reference picture list and the second reference picture list. The processing circuitry determines a motion vector for the prediction of the current block based on the merge candidate, and reconstructs the current block based on the inter prediction direction and the motion vector.

In some examples, the processing circuitry decodes one or more signals from the bitstream, the one or more signals indicative of the inter prediction direction. In an example, the one or more signals are after a first syntax that indicates whether the current block is in a merge mode. In another example, the one or more signals are after a second syntax that indicates a merge type for the current block.

In some examples, the processing circuitry infers that the inter prediction direction is the bi-prediction in response to a merge type of the current block being based on the bi-prediction.

In some examples, the one or more signals include a syntax with a first value indicating a uni-prediction and a second value indicating the bi-prediction.

In some examples, the one or more signals include a syntax with a first value indicating the first uni-prediction, a second value indicating the second uni-prediction, and a third value indicating the bi-prediction.

In some examples, the one or more signals includes a first flag indicating whether the first reference picture list is in the inter prediction direction and a second flag indicating whether the second reference picture list is in the inter prediction direction.

In some examples, in response to a high level syntax indicative of an allowance of bi-prediction, the processing circuitry decodes the one or more signals from the bitstream.

In some examples, the inter prediction direction is the bi-prediction, the processing circuitry decodes, from the bitstream, an index that indicates a specific weighting candidate in a weighting candidate list. The weighting candidate list includes a plurality of weighting candidates respectively providing weighting values for combining predictions from the first reference picture list and the second reference picture list. In some examples, the weighting candidate list includes at least a default equal weighting candidate and an inherited weighting candidate from the merge candidate.

In some embodiments, the processing circuitry decodes, from a bitstream, information that indicates a current block in a current picture being an inter prediction block in a merge mode. The bitstream carries a video comprising the current picture. The processing circuitry constructs an extended merge candidate list based on at least a first merge candidate with motion parameters obtained from a neighboring block. The extended merge candidate list includes at least the first merge candidate, and a non-redundant merge candidate extended from the first merge candidate. The non-redundant merge candidate has at least a motion vector of the first merge candidate. The processing circuitry decodes an index indicative of a specific merge candidate in the extended merge candidate list, and reconstructs the current block based on the specific merge candidate.

In some examples, the first merge candidate is a bi-prediction candidate with a first motion vector associated with a first reference picture list and a second motion vector associated with a second reference picture list. The processing circuitry constructs the extended merge candidate list that includes the first merge candidate and at least one of a second merge candidate that is a uni-prediction candidate having the first motion vector associated with the first reference picture list, and a third merge candidate that is a uni-prediction candidate having the second motion vector associated with the second reference picture list.

In some examples, the first merge candidate is a bi-prediction candidate with a first motion vector associated with a first reference picture list and a second motion vector associated with a second reference picture list, the processing circuitry constructs the extended merge candidate list that includes the first merge candidate and at least one of a second merge candidate that is a bi-prediction candidate having the first motion vector associated with the second reference picture list and the second motion vector associated with the first reference picture list, a third merge candidate that is a uni-prediction candidate having the first motion vector associated with the first reference picture list, a fourth merge candidate that is a uni-prediction candidate having the second motion vector associated with the second reference picture list, a fifth merge candidate that is a uni-prediction candidate having the second motion vector associated with the first reference picture list and a six merge candidate that is a uni-prediction candidate having the first motion vector associated with the second reference picture list.

In some examples, the first merge candidate is a bi-prediction candidate coded with bi-prediction with CU level weight (BCW), the first merge candidate includes a first motion vector associated with a first reference picture list and a first weight value and a second motion vector associated with a second reference picture list and a second weight value. The processing circuitry constructs the extended merge candidate list that includes the first merge candidate and a second merge candidate that is a uni-prediction candidate having the first motion vector associated with the first reference picture list in response to the first weight value being larger than the second weight value. The processing circuitry constructs the extended merge candidate list that includes the first merge candidate and a third merge candidate that is a uni-prediction candidate having the second motion vector associated with the second reference picture list in response to the first weight value being smaller than the second weight value.

In some examples, the first merge candidate is a uni-prediction candidate with a first motion vector associated with a first reference picture list. The processing circuitry constructs the extended merge candidate list that includes the first merge candidate and a second merge candidate that is a uni-prediction candidate having the first motion vector associated with a second reference picture list.

In some examples, the first merge candidate is a bi-prediction candidate coded with a first bi-prediction with CU level weight (BCW) index value, the first merge candidate includes motion information with a first motion vector associated with a first reference picture list and a second motion vector associated with a second reference picture list. The processing circuitry constructs the extended merge candidate list that comprises the first merge candidate and one or more second merge candidates that each includes the motion information in the first merge candidate and is coded with a different BCW index value from the first BCW index value.

In some examples, the first merge candidate is a bi-prediction candidate coded with a first bi-prediction with CU level weight (BCW) index value corresponding to non equal weighting, the first merge candidate comprises motion information with a first motion vector associated with a first reference picture list and a second motion vector associated with a second reference picture list. The processing circuitry constructs the extended merge candidate list that includes the first merge candidate and a second merge candidate that comprises the motion information in the first merge candidate and is coded with a second BCW index value corresponding to equal weighting.

In some examples, the processing circuitry orders merge candidates in the extended merge candidate list according to template matching costs.

In some embodiments, the processing circuitry decodes, from a bitstream, information that indicates a current block in a current picture being an inter prediction block in a merge mode. The bitstream carries a video comprising the current picture. The processing circuitry constructs a merge candidate list that comprises a plurality of merge candidates obtained from neighboring blocks, and decoding an index indicative of a specific merge candidate in the merge candidate list. The processing circuitry selects a specific inter prediction direction for associating with the specific merge candidate from a plurality of direction candidates based on template matching costs of the plurality of direction candidates. The processing circuitry reconstructs the current block based on the specific merge candidate with the specific inter prediction direction.

In an example, the processing circuitry determines the specific inter prediction direction for the specific merge candidate in response to the specific merge candidate being obtained from a neighboring block. In another example, the processing circuitry determines the specific inter prediction direction for the specific merge candidate in response to a finish of a motion vector refinement on the specific merge candidate. In another example, the processing circuitry determines the specific inter prediction direction for the specific merge candidate in response to a finish of a template matching based reordering of the plurality of merge candidates. In another example, the processing circuitry determines the specific inter prediction direction for the specific merge candidate in response to the decoding of the index.

Aspects of the disclosure also provide a non-transitory computer-readable medium storing instructions which when executed by a computer for video decoding cause the computer to perform the method for video decoding.

### BRIEF DESCRIPTION OF THE DRAWINGS

Further features, the nature, and various advantages of the disclosed subject matter will be more apparent from the following detailed description and the accompanying drawings in which:

FIG. 1A is a schematic illustration of an exemplary subset of intra prediction modes.

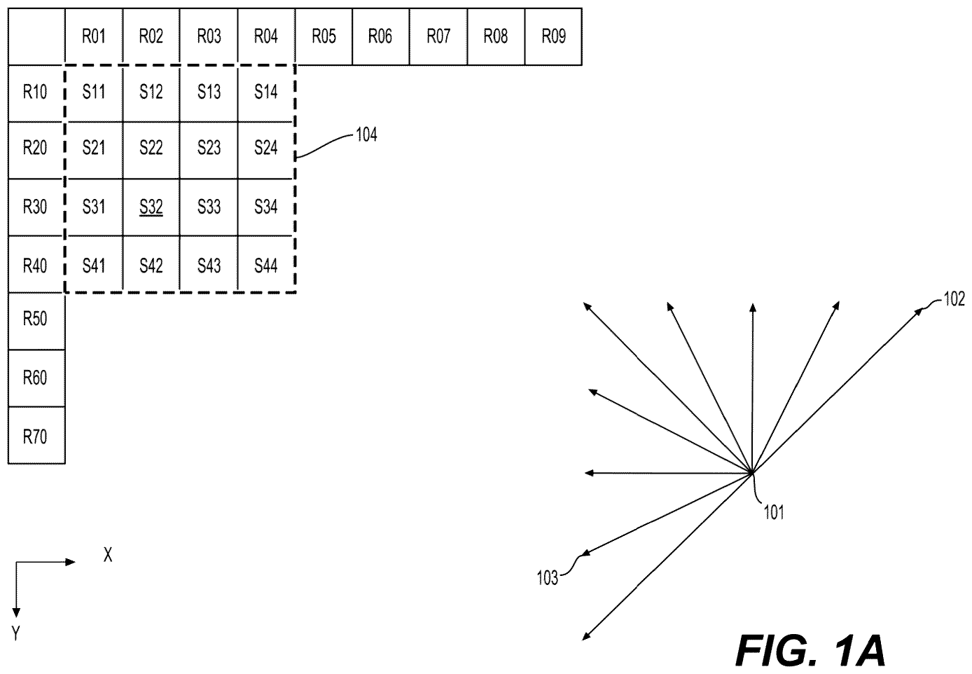

FIG. 1B is an illustration of exemplary intra prediction directions.

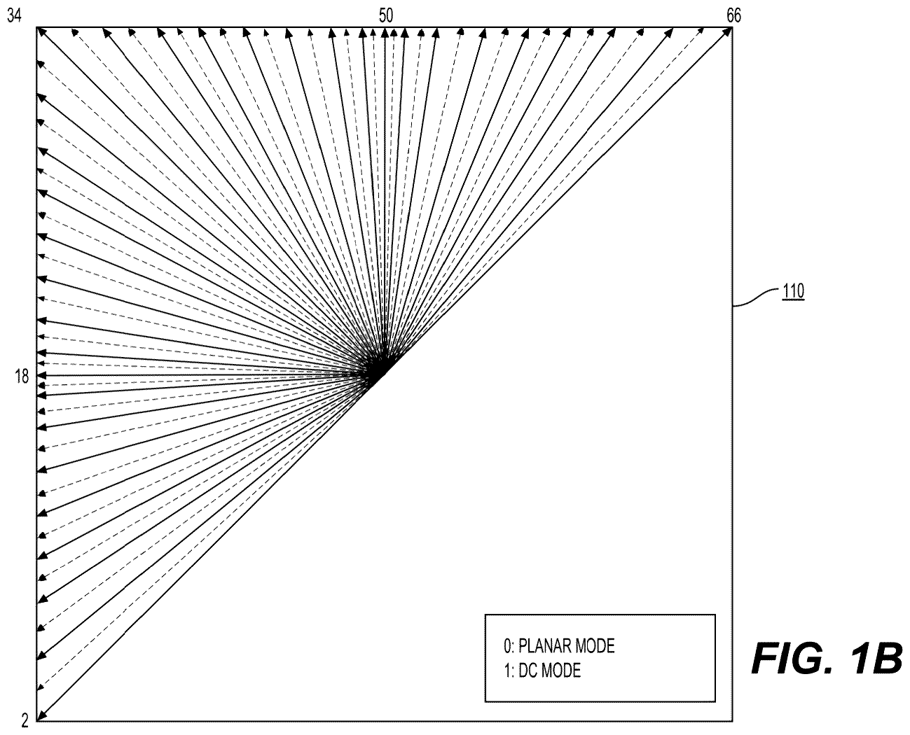

FIG. 2 is a schematic illustration of a current block and its surrounding spatial merge candidates in one example.

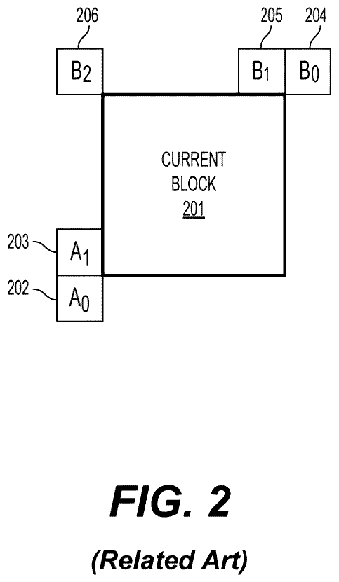

FIG. 3 is a schematic illustration of a simplified block diagram of a communication system (300) in accordance with an embodiment.

FIG. 4 is a schematic illustration of a simplified block diagram of a communication system (400) in accordance with an embodiment.

FIG. 5 is a schematic illustration of a simplified block diagram of a decoder in accordance with an embodiment.

FIG. 6 is a schematic illustration of a simplified block diagram of an encoder in accordance with an embodiment.

FIG. 7 shows a block diagram of an encoder in accordance with another embodiment.

FIG. 8 shows a block diagram of a decoder in accordance with another embodiment.

FIG. 9 shows positions of spatial merge candidates according to an embodiment of the disclosure.

FIG. 10 shows candidate pairs that are considered for a redundancy check of spatial merge candidates according to an embodiment of the disclosure.

FIG. 11 shows exemplary motion vector scaling for a temporal merge candidate.

FIG. 12 shows exemplary candidate positions for a temporal merge candidate of a current coding unit.

FIGS. 13A-13B show affine motion models in some examples.

FIG. 14 shows affine model vector field in an example.

FIG. 15 shows positions of spatial merge candidates in some examples.

FIG. 16 shows control point motion vector inheritance in some examples.

FIG. 17 shows candidate positions for construed affine merge mode in some examples.

FIG. 18 shows an exemplary illustration of the difference between the sample MV and the subblock MV in some examples.

FIGS. 19-20 show an exemplary SbTMVP process used in the SbTMVP mode.

FIG. 21 shows an example of a search process (2100) in a MMVD mode.

FIG. 22 shows examples of search points in a MMVD mode.

FIG. 23 shows a diagram illustrating history parameter tables in some examples.

FIG. 24 shows a diagram illustrating history parameter tables stored in line buffer in some examples.

FIGS. 25A-25B show patterns of obtained non-adjacent spatial neighbors in some examples.

FIG. 26 shows a diagram illustrating an example for constructing merge candidates.

FIG. 27 shows an example of template matching.

FIG. 28 shows a diagram illustrate reference samples of the template of the current block for a merge candidate of bi-prediction.

FIG. 29 shows an example for derivation of template and reference samples of the template for the current block with a subblock-based merge candidate.

FIG. 30 shows a diagram illustrating directions of refinement directions.

FIG. 31 shows a flow chart outlining a process according to some embodiments of the disclosure.

FIG. 32 shows a flow chart outlining a process according to some embodiments of the disclosure.

FIG. 33 shows a flow chart outlining a process according to some embodiments of the disclosure.

FIG. 34 shows a flow chart outlining a process according to some embodiments of the disclosure.

FIG. 35 shows a flow chart outlining a process according to some embodiments of the disclosure.

FIG. 36 shows a flow chart outlining a process according to some embodiments of the disclosure.

FIG. 37 is a schematic illustration of a computer system in accordance with an embodiment.

### DETAILED DESCRIPTION OF EMBODIMENTS

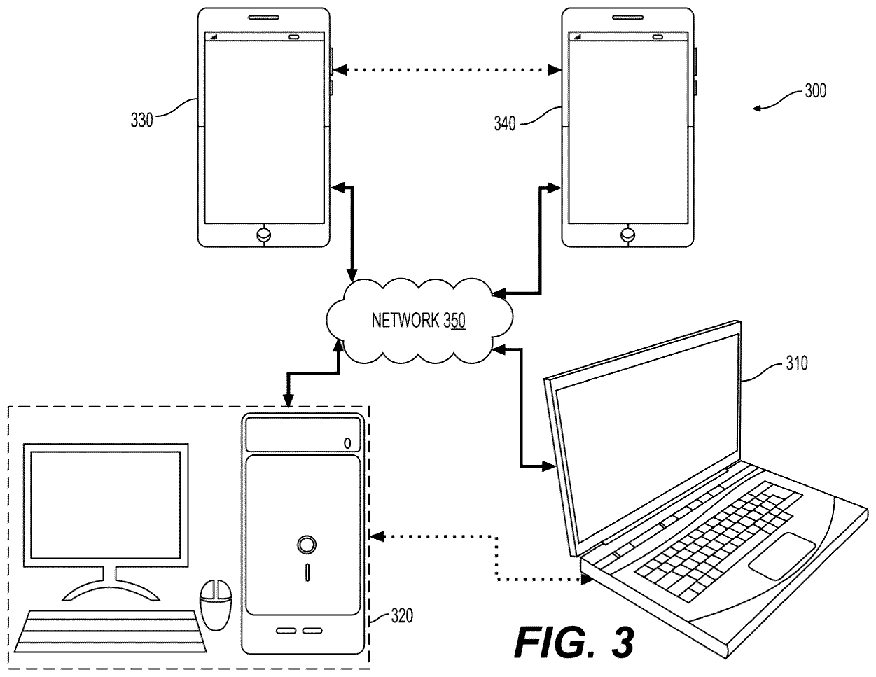

FIG. 3 illustrates an exemplary block diagram of a communication system (300). The communication system (300) includes a plurality of terminal devices that can communicate with each other, via, for example, a network (350). For example, the communication system (300) includes a first pair of terminal devices (310) and (320) interconnected via the network (350). In the FIG. 3 example, the first pair of terminal devices (310) and (320) performs unidirectional transmission of data. For example, the terminal device (310) may code video data (e.g., a stream of video pictures that are captured by the terminal device (310)) for transmission to the other terminal device (320) via the network (350). The encoded video data can be transmitted in the form of one or more coded video bitstreams. The terminal device (320) may receive the coded video data from the network (350), decode the coded video data to recover the video pictures and display video pictures according to the recovered video data. Unidirectional data transmission may be common in media serving applications and the like.

In another example, the communication system (300) includes a second pair of terminal devices (330) and (340) that perform bidirectional transmission of coded video data, for example, during videoconferencing. For bidirectional transmission of data, in an example, each terminal device of the terminal devices (330) and (340) may code video data (e.g., a stream of video pictures that are captured by the terminal device) for transmission to the other terminal device of the terminal devices (330) and (340) via the network (350). Each terminal device of the terminal devices (330) and (340) also may receive the coded video data transmitted by the other terminal device of the terminal devices (330) and (340), and may decode the coded video data to recover the video pictures and may display video pictures at an accessible display device according to the recovered video data.

In the example of FIG. 3, the terminal devices (310), (320), (330) and (340) are respectively illustrated as servers, personal computers and smart phones but the principles of the present disclosure may be not so limited. Embodiments of the present disclosure find application with laptop computers, tablet computers, media players, and/or dedicated video conferencing equipment. The network (350) represents any number of networks that convey coded video data among the terminal devices (310), (320), (330) and (340), including for example wireline (wired) and/or wireless communication networks. The communication network (350) may exchange data in circuit-switched and/or packet-switched channels. Representative networks include telecommunications networks, local area networks, wide area networks and/or the Internet. For the purposes of the present discussion, the architecture and topology of the network (350) may be immaterial to the operation of the present disclosure unless explained herein below.

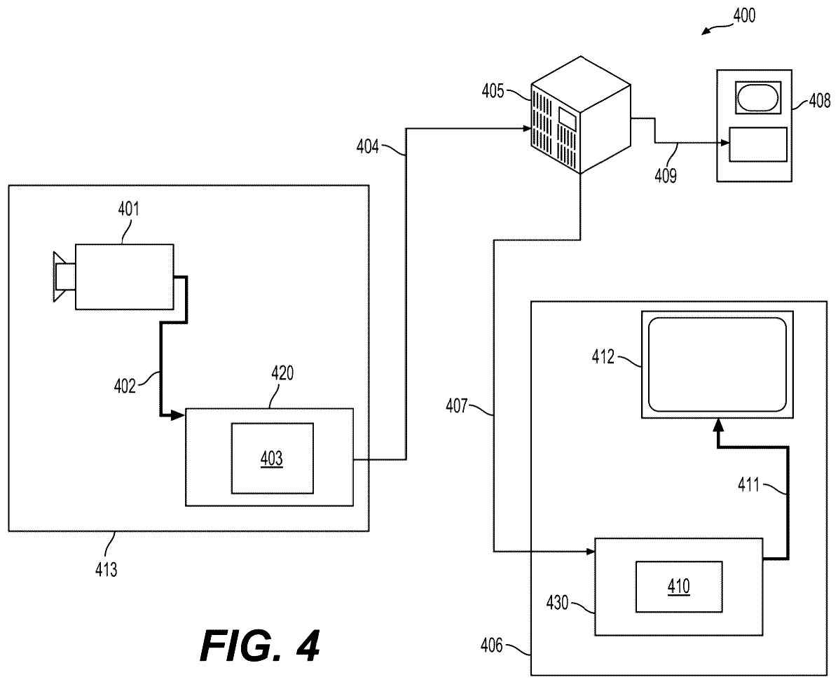

FIG. 4 illustrates, as an example of an application for the disclosed subject matter, a video encoder and a video decoder in a streaming environment. The disclosed subject matter can be equally applicable to other video enabled applications, including, for example, video conferencing, digital TV, streaming services, storing of compressed video on digital media including CD, DVD, memory stick and the like, and so on.

A streaming system may include a capture subsystem (413), that can include a video source (401), for example a digital camera, creating for example a stream of video pictures (402) that are uncompressed. In an example, the stream of video pictures (402) includes samples that are taken by the digital camera. The stream of video pictures (402), depicted as a bold line to emphasize a high data volume when compared to encoded video data (404) (or coded video bitstreams), can be processed by an electronic device (420) that includes a video encoder (403) coupled to the video source (401). The video encoder (403) can include hardware, software, or a combination thereof to enable or implement aspects of the disclosed subject matter as described in more detail below. The encoded video data (404) (or encoded video bitstream), depicted as a thin line to emphasize the lower data volume when compared to the stream of video pictures (402), can be stored on a streaming server (405) for future use. One or more streaming client subsystems, such as client subsystems (406) and (408) in FIG. 4 can access the streaming server (405) to retrieve copies (407) and (409) of the encoded video data (404). A client subsystem (406) can include a video decoder (410), for example, in an electronic device (430). The video decoder (410) decodes the incoming copy (407) of the encoded video data and creates an outgoing stream of video pictures (411) that can be rendered on a display (412) (e.g., display screen) or other rendering device (not depicted). In some streaming systems, the encoded video data (404), (407), and (409) (e.g., video bitstreams) can be encoded according to certain video coding/compression standards. Examples of those standards include ITU-T Recommendation H.265. In an example, a video coding standard under development is informally known as Versatile Video Coding (VVC). The disclosed subject matter may be used in the context of VVC.

It is noted that the electronic devices (420) and (430) can include other components (not shown). For example, the electronic device (420) can include a video decoder (not shown) and the electronic device (430) can include a video encoder (not shown) as well.

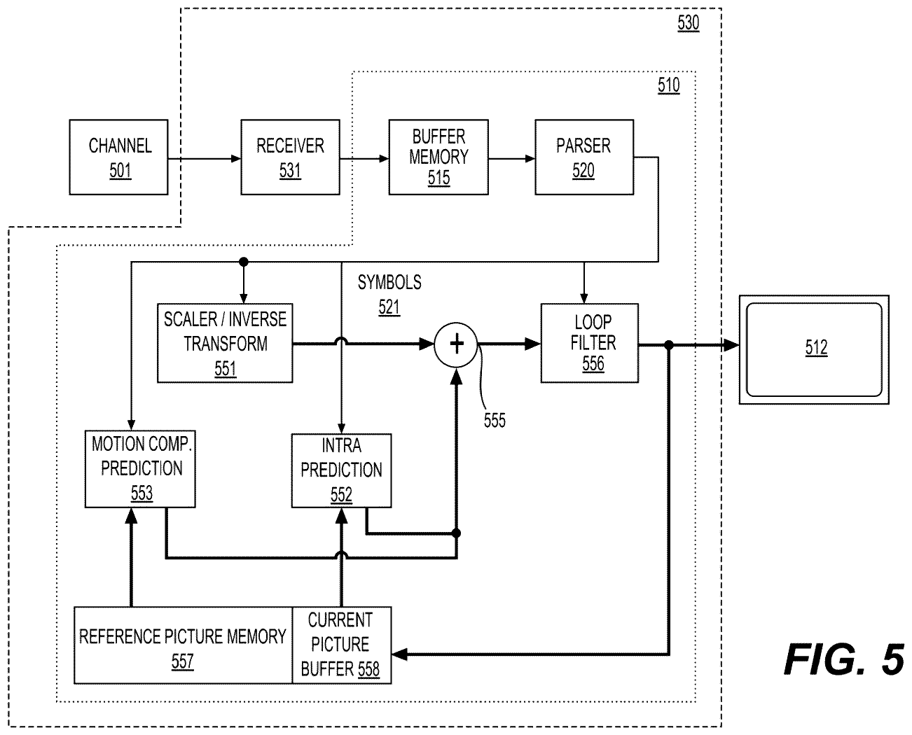

FIG. 5 shows an exemplary block diagram of a video decoder (510). The video decoder (510) can be included in an electronic device (530). The electronic device (530) can include a receiver (531) (e.g., receiving circuitry). The video decoder (510) can be used in the place of the video decoder (410) in the FIG. 4 example.

The receiver (531) may receive one or more coded video sequences to be decoded by the video decoder (510). In an embodiment, one coded video sequence is received at a time, where the decoding of each coded video sequence is independent from the decoding of other coded video sequences. The coded video sequence may be received from a channel (501), which may be a hardware/software link to a storage device which stores the encoded video data. The receiver (531) may receive the encoded video data with other data, for example, coded audio data and/or ancillary data streams, that may be forwarded to their respective using entities (not depicted). The receiver (531) may separate the coded video sequence from the other data. To combat network jitter, a buffer memory (515) may be coupled in between the receiver (531) and an entropy decoder/parser (520) (“parser (520)” henceforth). In certain applications, the buffer memory (515) is part of the video decoder (510). In others, it can be outside of the video decoder (510) (not depicted). In still others, there can be a buffer memory (not depicted) outside of the video decoder (510), for example to combat network jitter, and in addition another buffer memory (515) inside the video decoder (510), for example to handle playout timing. When the receiver (531) is receiving data from a store/forward device of sufficient bandwidth and controllability, or from an isosynchronous network, the buffer memory (515) may not be needed, or can be small. For use on best effort packet networks such as the Internet, the buffer memory (515) may be required, can be comparatively large and can be advantageously of adaptive size, and may at least partially be implemented in an operating system or similar elements (not depicted) outside of the video decoder (510).

The video decoder (510) may include the parser (520) to reconstruct symbols (521) from the coded video sequence. Categories of those symbols include information used to manage operation of the video decoder (510), and potentially information to control a rendering device such as a render device (512) (e.g., a display screen) that is not an integral part of the electronic device (530) but can be coupled to the electronic device (530), as shown in FIG. 5. The control information for the rendering device(s) may be in the form of Supplemental Enhancement Information (SEI) messages or Video Usability Information (VUI) parameter set fragments (not depicted). The parser (520) may parse/entropy-decode the coded video sequence that is received. The coding of the coded video sequence can be in accordance with a video coding technology or standard, and can follow various principles, including variable length coding, Huffman coding, arithmetic coding with or without context sensitivity, and so forth. The parser (520) may extract from the coded video sequence, a set of subgroup parameters for at least one of the subgroups of pixels in the video decoder, based upon at least one parameter corresponding to the group. Subgroups can include Groups of Pictures (GOPs), pictures, tiles, slices, macroblocks, Coding Units (CUs), blocks, Transform Units (TUs), Prediction Units (PUs) and so forth. The parser (520) may also extract from the coded video sequence information such as transform coefficients, quantizer parameter values, motion vectors, and so forth.

The parser (520) may perform an entropy decoding/parsing operation on the video sequence received from the buffer memory (515), so as to create symbols (521).

Reconstruction of the symbols (521) can involve multiple different units depending on the type of the coded video picture or parts thereof (such as: inter and intra picture, inter and intra block), and other factors. Which units are involved, and how, can be controlled by subgroup control information parsed from the coded video sequence by the parser (520). The flow of such subgroup control information between the parser (520) and the multiple units below is not depicted for clarity.

Beyond the functional blocks already mentioned, the video decoder (510) can be conceptually subdivided into a number of functional units as described below. In a practical implementation operating under commercial constraints, many of these units interact closely with each other and can, at least partly, be integrated into each other. However, for the purpose of describing the disclosed subject matter, the conceptual subdivision into the functional units below is appropriate.

A first unit is the scaler/inverse transform unit (551). The scaler/inverse transform unit (551) receives a quantized transform coefficient as well as control information, including which transform to use, block size, quantization factor, quantization scaling matrices, etc. as symbol(s) (521) from the parser (520). The scaler/inverse transform unit (551) can output blocks comprising sample values, that can be input into aggregator (555).

In some cases, the output samples of the scaler/inverse transform unit (551) can pertain to an intra coded block. The intra coded block is a block that is not using predictive information from previously reconstructed pictures, but can use predictive information from previously reconstructed parts of the current picture. Such predictive information can be provided by an intra picture prediction unit (552). In some cases, the intra picture prediction unit (552) generates a block of the same size and shape of the block under reconstruction, using surrounding already reconstructed information fetched from the current picture buffer (558). The current picture buffer (558) buffers, for example, partly reconstructed current picture and/or fully reconstructed current picture. The aggregator (555), in some cases, adds, on a per sample basis, the prediction information the intra prediction unit (552) has generated to the output sample information as provided by the scaler/inverse transform unit (551).

In other cases, the output samples of the scaler/inverse transform unit (551) can pertain to an inter coded, and potentially motion compensated, block. In such a case, a motion compensation prediction unit (553) can access reference picture memory (557) to fetch samples used for prediction. After motion compensating the fetched samples in accordance with the symbols (521) pertaining to the block, these samples can be added by the aggregator (555) to the output of the scaler/inverse transform unit (551) (in this case called the residual samples or residual signal) so as to generate output sample information. The addresses within the reference picture memory (557) from where the motion compensation prediction unit (553) fetches prediction samples can be controlled by motion vectors, available to the motion compensation prediction unit (553) in the form of symbols (521) that can have, for example X, Y, and reference picture components. Motion compensation also can include interpolation of sample values as fetched from the reference picture memory (557) when sub-sample exact motion vectors are in use, motion vector prediction mechanisms, and so forth.

The output samples of the aggregator (555) can be subject to various loop filtering techniques in the loop filter unit (556). Video compression technologies can include in-loop filter technologies that are controlled by parameters included in the coded video sequence (also referred to as coded video bitstream) and made available to the loop filter unit (556) as symbols (521) from the parser (520). Video compression can also be responsive to meta-information obtained during the decoding of previous (in decoding order) parts of the coded picture or coded video sequence, as well as responsive to previously reconstructed and loop-filtered sample values.

The output of the loop filter unit (556) can be a sample stream that can be output to the render device (512) as well as stored in the reference picture memory (557) for use in future inter-picture prediction.

Certain coded pictures, once fully reconstructed, can be used as reference pictures for future prediction. For example, once a coded picture corresponding to a current picture is fully reconstructed and the coded picture has been identified as a reference picture (by, for example, the parser (520)), the current picture buffer (558) can become a part of the reference picture memory (557), and a fresh current picture buffer can be reallocated before commencing the reconstruction of the following coded picture.

The video decoder (510) may perform decoding operations according to a predetermined video compression technology or a standard, such as ITU-T Rec. H.265. The coded video sequence may conform to a syntax specified by the video compression technology or standard being used, in the sense that the coded video sequence adheres to both the syntax of the video compression technology or standard and the profiles as documented in the video compression technology or standard. Specifically, a profile can select certain tools as the only tools available for use under that profile from all the tools available in the video compression technology or standard. Also necessary for compliance can be that the complexity of the coded video sequence is within bounds as defined by the level of the video compression technology or standard. In some cases, levels restrict the maximum picture size, maximum frame rate, maximum reconstruction sample rate (measured in, for example megasamples per second), maximum reference picture size, and so on. Limits set by levels can, in some cases, be further restricted through Hypothetical Reference Decoder (HRD) specifications and metadata for HRD buffer management signaled in the coded video sequence.

In an embodiment, the receiver (531) may receive additional (redundant) data with the encoded video. The additional data may be included as part of the coded video sequence(s). The additional data may be used by the video decoder (510) to properly decode the data and/or to more accurately reconstruct the original video data. Additional data can be in the form of, for example, temporal, spatial, or signal noise ratio (SNR) enhancement layers, redundant slices, redundant pictures, forward error correction codes, and so on.

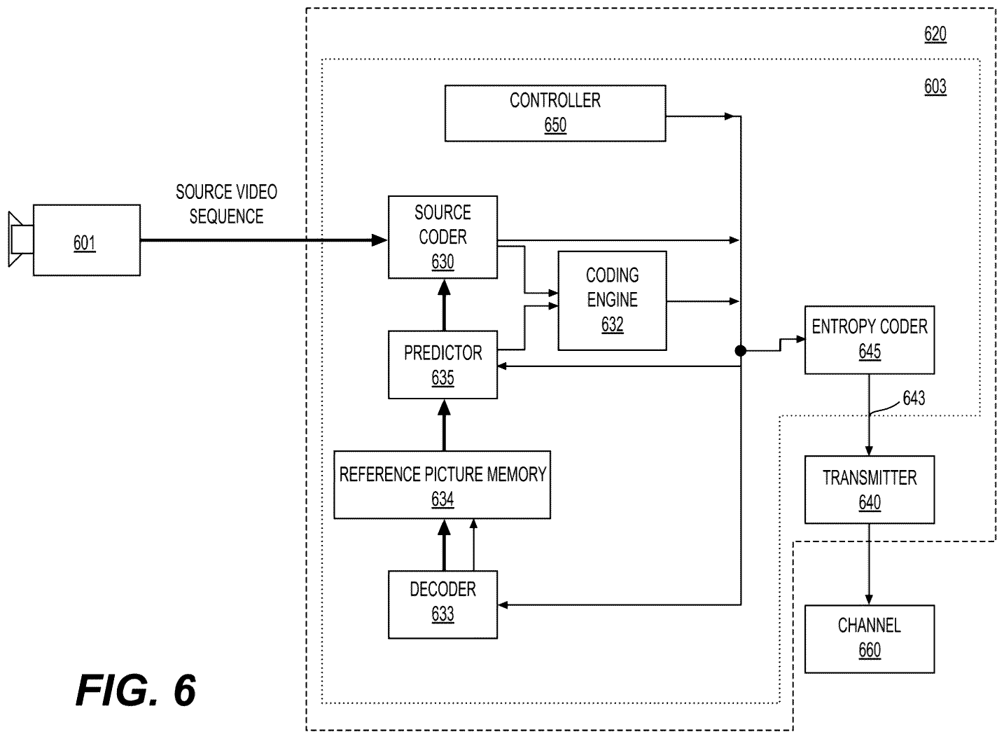

FIG. 6 shows an exemplary block diagram of a video encoder (603). The video encoder (603) is included in an electronic device (620). The electronic device (620) includes a transmitter (640) (e.g., transmitting circuitry). The video encoder (603) can be used in the place of the video encoder (403) in the FIG. 4 example.

The video encoder (603) may receive video samples from a video source (601) (that is not part of the electronic device (620) in the FIG. 6 example) that may capture video image(s) to be coded by the video encoder (603). In another example, the video source (601) is a part of the electronic device (620).

The video source (601) may provide the source video sequence to be coded by the video encoder (603) in the form of a digital video sample stream that can be of any suitable bit depth (for example: 8 bit, 10 bit, 12 bit, . . . ), any colorspace (for example, BT.601 Y CrCB, RGB, . . . ), and any suitable sampling structure (for example Y CrCb 4:2:0, Y CrCb 4:4:4). In a media serving system, the video source (601) may be a storage device storing previously prepared video. In a videoconferencing system, the video source (601) may be a camera that captures local image information as a video sequence. Video data may be provided as a plurality of individual pictures that impart motion when viewed in sequence. The pictures themselves may be organized as a spatial array of pixels, wherein each pixel can comprise one or more samples depending on the sampling structure, color space, etc. in use. A person skilled in the art can readily understand the relationship between pixels and samples. The description below focuses on samples.

According to an embodiment, the video encoder (603) may code and compress the pictures of the source video sequence into a coded video sequence (643) in real time or under any other time constraints as required. Enforcing appropriate coding speed is one function of a controller (650). In some embodiments, the controller (650) controls other functional units as described below and is functionally coupled to the other functional units. The coupling is not depicted for clarity. Parameters set by the controller (650) can include rate control related parameters (picture skip, quantizer, lambda value of rate-distortion optimization techniques, . . . ), picture size, group of pictures (GOP) layout, maximum motion vector search range, and so forth. The controller (650) can be configured to have other suitable functions that pertain to the video encoder (603) optimized for a certain system design.

In some embodiments, the video encoder (603) is configured to operate in a coding loop. As an oversimplified description, in an example, the coding loop can include a source coder (630) (e.g., responsible for creating symbols, such as a symbol stream, based on an input picture to be coded, and a reference picture(s)), and a (local) decoder (633) embedded in the video encoder (603). The decoder (633) reconstructs the symbols to create the sample data in a similar manner as a (remote) decoder also would create. The reconstructed sample stream (sample data) is input to the reference picture memory (634). As the decoding of a symbol stream leads to bit-exact results independent of decoder location (local or remote), the content in the reference picture memory (634) is also bit exact between the local encoder and remote encoder. In other words, the prediction part of an encoder “sees” as reference picture samples exactly the same sample values as a decoder would “see” when using prediction during decoding. This fundamental principle of reference picture synchronicity (and resulting drift, if synchronicity cannot be maintained, for example because of channel errors) is used in some related arts as well.

The operation of the “local” decoder (633) can be the same as of a “remote” decoder, such as the video decoder (510), which has already been described in detail above in conjunction with FIG. 5. Briefly referring also to FIG. 5, however, as symbols are available and encoding/decoding of symbols to a coded video sequence by an entropy coder (645) and the parser (520) can be lossless, the entropy decoding parts of the video decoder (510), including the buffer memory (515), and parser (520) may not be fully implemented in the local decoder (633).

In an embodiment, a decoder technology except the parsing/entropy decoding that is present in a decoder is present, in an identical or a substantially identical functional form, in a corresponding encoder. Accordingly, the disclosed subject matter focuses on decoder operation. The description of encoder technologies can be abbreviated as they are the inverse of the comprehensively described decoder technologies. In certain areas a more detail description is provided below.

During operation, in some examples, the source coder (630) may perform motion compensated predictive coding, which codes an input picture predictively with reference to one or more previously coded picture from the video sequence that were designated as “reference pictures.” In this manner, the coding engine (632) codes differences between pixel blocks of an input picture and pixel blocks of reference picture(s) that may be selected as prediction reference(s) to the input picture.

The local video decoder (633) may decode coded video data of pictures that may be designated as reference pictures, based on symbols created by the source coder (630). Operations of the coding engine (632) may advantageously be lossy processes. When the coded video data may be decoded at a video decoder (not shown in FIG. 6), the reconstructed video sequence typically may be a replica of the source video sequence with some errors. The local video decoder (633) replicates decoding processes that may be performed by the video decoder on reference pictures and may cause reconstructed reference pictures to be stored in the reference picture memory (634). In this manner, the video encoder (603) may store copies of reconstructed reference pictures locally that have common content as the reconstructed reference pictures that will be obtained by a far-end video decoder (absent transmission errors).

The predictor (635) may perform prediction searches for the coding engine (632). That is, for a new picture to be coded, the predictor (635) may search the reference picture memory (634) for sample data (as candidate reference pixel blocks) or certain metadata such as reference picture motion vectors, block shapes, and so on, that may serve as an appropriate prediction reference for the new pictures. The predictor (635) may operate on a sample block-by-pixel block basis to find appropriate prediction references. In some cases, as determined by search results obtained by the predictor (635), an input picture may have prediction references drawn from multiple reference pictures stored in the reference picture memory (634).

The controller (650) may manage coding operations of the source coder (630), including, for example, setting of parameters and subgroup parameters used for encoding the video data.

Output of all aforementioned functional units may be subjected to entropy coding in the entropy coder (645). The entropy coder (645) translates the symbols as generated by the various functional units into a coded video sequence, by applying lossless compression to the symbols according to technologies such as Huffman coding, variable length coding, arithmetic coding, and so forth.

The transmitter (640) may buffer the coded video sequence(s) as created by the entropy coder (645) to prepare for transmission via a communication channel (660), which may be a hardware/software link to a storage device which would store the encoded video data. The transmitter (640) may merge coded video data from the video encoder (603) with other data to be transmitted, for example, coded audio data and/or ancillary data streams (sources not shown).

The controller (650) may manage operation of the video encoder (603). During coding, the controller (650) may assign to each coded picture a certain coded picture type, which may affect the coding techniques that may be applied to the respective picture. For example, pictures often may be assigned as one of the following picture types:

An Intra Picture (I picture) may be one that may be coded and decoded without using any other picture in the sequence as a source of prediction. Some video codecs allow for different types of intra pictures, including, for example Independent Decoder Refresh (“IDR”) Pictures. A person skilled in the art is aware of those variants of I pictures and their respective applications and features.

A predictive picture (P picture) may be one that may be coded and decoded using intra prediction or inter prediction using at most one motion vector and reference index to predict the sample values of each block.

A bi-directionally predictive picture (B Picture) may be one that may be coded and decoded using intra prediction or inter prediction using at most two motion vectors and reference indices to predict the sample values of each block. Similarly, multiple-predictive pictures can use more than two reference pictures and associated metadata for the reconstruction of a single block.

Source pictures commonly may be subdivided spatially into a plurality of sample blocks (for example, blocks of 4×4, 8×8, 4×8, or 16×16 samples each) and coded on a block-by-block basis. Blocks may be coded predictively with reference to other (already coded) blocks as determined by the coding assignment applied to the blocks' respective pictures. For example, blocks of I pictures may be coded non-predictively or they may be coded predictively with reference to already coded blocks of the same picture (spatial prediction or intra prediction). Pixel blocks of P pictures may be coded predictively, via spatial prediction or via temporal prediction with reference to one previously coded reference picture. Blocks of B pictures may be coded predictively, via spatial prediction or via temporal prediction with reference to one or two previously coded reference pictures.

The video encoder (603) may perform coding operations according to a predetermined video coding technology or standard, such as ITU-T Rec. H.265. In its operation, the video encoder (603) may perform various compression operations, including predictive coding operations that exploit temporal and spatial redundancies in the input video sequence. The coded video data, therefore, may conform to a syntax specified by the video coding technology or standard being used.

In an embodiment, the transmitter (640) may transmit additional data with the encoded video. The source coder (630) may include such data as part of the coded video sequence. Additional data may comprise temporal/spatial/SNR enhancement layers, other forms of redundant data such as redundant pictures and slices, SEI messages, VUI parameter set fragments, and so on.

A video may be captured as a plurality of source pictures (video pictures) in a temporal sequence. Intra-picture prediction (often abbreviated to intra prediction) makes use of spatial correlation in a given picture, and inter-picture prediction makes uses of the (temporal or other) correlation between the pictures. In an example, a specific picture under encoding/decoding, which is referred to as a current picture, is partitioned into blocks. When a block in the current picture is similar to a reference block in a previously coded and still buffered reference picture in the video, the block in the current picture can be coded by a vector that is referred to as a motion vector. The motion vector points to the reference block in the reference picture, and can have a third dimension identifying the reference picture, in case multiple reference pictures are in use.

In some embodiments, a bi-prediction technique can be used in the inter-picture prediction. According to the bi-prediction technique, two reference pictures, such as a first reference picture and a second reference picture that are both prior in decoding order to the current picture in the video (but may be in the past and future, respectively, in display order) are used. A block in the current picture can be coded by a first motion vector that points to a first reference block in the first reference picture, and a second motion vector that points to a second reference block in the second reference picture. The block can be predicted by a combination of the first reference block and the second reference block.

Further, a merge mode technique can be used in the inter-picture prediction to improve coding efficiency.

According to some embodiments of the disclosure, predictions, such as inter-picture predictions and intra-picture predictions, are performed in the unit of blocks. For example, according to the HEVC standard, a picture in a sequence of video pictures is partitioned into coding tree units (CTU) for compression, the CTUs in a picture have the same size, such as 64×64 pixels, 32×32 pixels, or 16×16 pixels. In general, a CTU includes three coding tree blocks (CTBs), which are one luma CTB and two chroma CTBs. Each CTU can be recursively quadtree split into one or multiple coding units (CUs). For example, a CTU of 64×64 pixels can be split into one CU of 64×64 pixels, or 4 CUs of 32×32 pixels, or 16 CUs of 16×16 pixels. In an example, each CU is analyzed to determine a prediction type for the CU, such as an inter prediction type or an intra prediction type. The CU is split into one or more prediction units (PUs) depending on the temporal and/or spatial predictability. Generally, each PU includes a luma prediction block (PB), and two chroma PBs. In an embodiment, a prediction operation in coding (encoding/decoding) is performed in the unit of a prediction block. Using a luma prediction block as an example of a prediction block, the prediction block includes a matrix of values (e.g., luma values) for pixels, such as 8×8 pixels, 16×16 pixels, 8×16 pixels, 16×8 pixels, and the like.

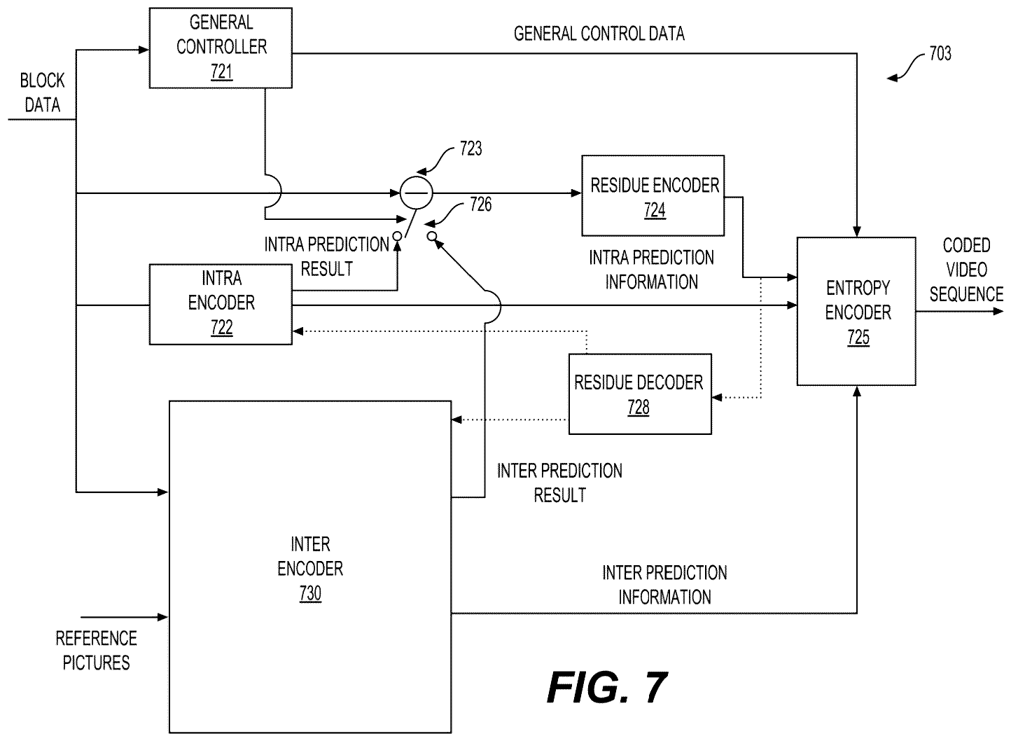

FIG. 7 shows an exemplary diagram of a video encoder (703). The video encoder (703) is configured to receive a processing block (e.g., a prediction block) of sample values within a current video picture in a sequence of video pictures, and encode the processing block into a coded picture that is part of a coded video sequence. In an example, the video encoder (703) is used in the place of the video encoder (403) in the FIG. 4 example.

In an HEVC example, the video encoder (703) receives a matrix of sample values for a processing block, such as a prediction block of 8×8 samples, and the like. The video encoder (703) determines whether the processing block is best coded using intra mode, inter mode, or bi-prediction mode using, for example, rate-distortion optimization. When the processing block is to be coded in intra mode, the video encoder (703) may use an intra prediction technique to encode the processing block into the coded picture; and when the processing block is to be coded in inter mode or bi-prediction mode, the video encoder (703) may use an inter prediction or bi-prediction technique, respectively, to encode the processing block into the coded picture. In certain video coding technologies, merge mode can be an inter picture prediction submode where the motion vector is derived from one or more motion vector predictors without the benefit of a coded motion vector component outside the predictors. In certain other video coding technologies, a motion vector component applicable to the subject block may be present. In an example, the video encoder (703) includes other components, such as a mode decision module (not shown) to determine the mode of the processing blocks.

In the FIG. 7 example, the video encoder (703) includes an inter encoder (730), an intra encoder (722), a residue calculator (723), a switch (726), a residue encoder (724), a general controller (721), and an entropy encoder (725) coupled together as shown in FIG. 7.

The inter encoder (730) is configured to receive the samples of the current block (e.g., a processing block), compare the block to one or more reference blocks in reference pictures (e.g., blocks in previous pictures and later pictures), generate inter prediction information (e.g., description of redundant information according to inter encoding technique, motion vectors, merge mode information), and calculate inter prediction results (e.g., predicted block) based on the inter prediction information using any suitable technique. In some examples, the reference pictures are decoded reference pictures that are decoded based on the encoded video information.

The intra encoder (722) is configured to receive the samples of the current block (e.g., a processing block), in some cases compare the block to blocks already coded in the same picture, generate quantized coefficients after transform, and in some cases also generate intra prediction information (e.g., an intra prediction direction information according to one or more intra encoding techniques). In an example, the intra encoder (722) also calculates intra prediction results (e.g., predicted block) based on the intra prediction information and reference blocks in the same picture.

The general controller (721) is configured to determine general control data and control other components of the video encoder (703) based on the general control data. In an example, the general controller (721) determines the mode of the block, and provides a control signal to the switch (726) based on the mode. For example, when the mode is the intra mode, the general controller (721) controls the switch (726) to select the intra mode result for use by the residue calculator (723), and controls the entropy encoder (725) to select the intra prediction information and include the intra prediction information in the bitstream; and when the mode is the inter mode, the general controller (721) controls the switch (726) to select the inter prediction result for use by the residue calculator (723), and controls the entropy encoder (725) to select the inter prediction information and include the inter prediction information in the bitstream.

The residue calculator (723) is configured to calculate a difference (residue data) between the received block and prediction results selected from the intra encoder (722) or the inter encoder (730). The residue encoder (724) is configured to operate based on the residue data to encode the residue data to generate the transform coefficients. In an example, the residue encoder (724) is configured to convert the residue data from a spatial domain to a frequency domain, and generate the transform coefficients. The transform coefficients are then subject to quantization processing to obtain quantized transform coefficients. In various embodiments, the video encoder (703) also includes a residue decoder (728). The residue decoder (728) is configured to perform inverse-transform, and generate the decoded residue data. The decoded residue data can be suitably used by the intra encoder (722) and the inter encoder (730). For example, the inter encoder (730) can generate decoded blocks based on the decoded residue data and inter prediction information, and the intra encoder (722) can generate decoded blocks based on the decoded residue data and the intra prediction information. The decoded blocks are suitably processed to generate decoded pictures and the decoded pictures can be buffered in a memory circuit (not shown) and used as reference pictures in some examples.

The entropy encoder (725) is configured to format the bitstream to include the encoded block. The entropy encoder (725) is configured to include various information in the bitstream according to a suitable standard, such as the HEVC standard. In an example, the entropy encoder (725) is configured to include the general control data, the selected prediction information (e.g., intra prediction information or inter prediction information), the residue information, and other suitable information in the bitstream. Note that, according to the disclosed subject matter, when coding a block in the merge submode of either inter mode or bi-prediction mode, there is no residue information.

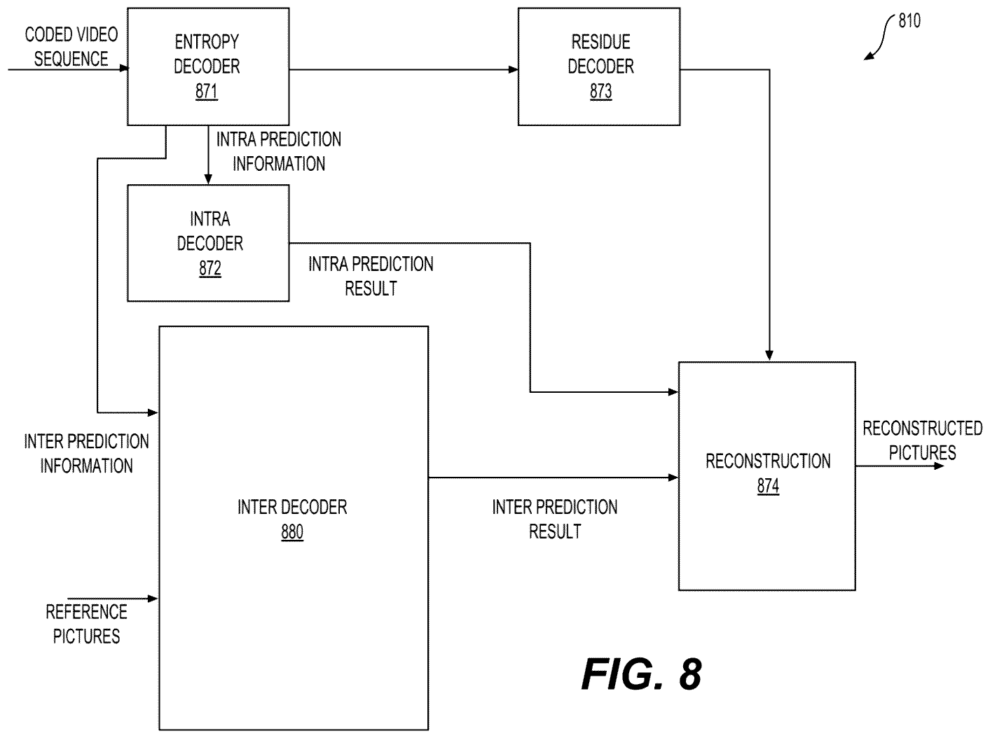

FIG. 8 shows an exemplary diagram of a video decoder (810). The video decoder (810) is configured to receive coded pictures that are part of a coded video sequence, and decode the coded pictures to generate reconstructed pictures. In an example, the video decoder (810) is used in the place of the video decoder (410) in the FIG. 4 example.

In the FIG. 8 example, the video decoder (810) includes an entropy decoder (871), an inter decoder (880), a residue decoder (873), a reconstruction module (874), and an intra decoder (872) coupled together as shown in FIG. 8.

The entropy decoder (871) can be configured to reconstruct, from the coded picture, certain symbols that represent the syntax elements of which the coded picture is made up. Such symbols can include, for example, the mode in which a block is coded (such as, for example, intra mode, inter mode, bi-predicted mode, the latter two in merge submode or another submode) and prediction information (such as, for example, intra prediction information or inter prediction information) that can identify certain sample or metadata that is used for prediction by the intra decoder (872) or the inter decoder (880), respectively. The symbols can also include residual information in the form of, for example, quantized transform coefficients, and the like. In an example, when the prediction mode is inter or bi-predicted mode, the inter prediction information is provided to the inter decoder (880); and when the prediction type is the intra prediction type, the intra prediction information is provided to the intra decoder (872). The residual information can be subject to inverse quantization and is provided to the residue decoder (873).

The inter decoder (880) is configured to receive the inter prediction information, and generate inter prediction results based on the inter prediction information.

The intra decoder (872) is configured to receive the intra prediction information, and generate prediction results based on the intra prediction information.

The residue decoder (873) is configured to perform inverse quantization to extract de-quantized transform coefficients, and process the de-quantized transform coefficients to convert the residual information from the frequency domain to the spatial domain. The residue decoder (873) may also require certain control information (to include the Quantizer Parameter (QP)), and that information may be provided by the entropy decoder (871) (data path not depicted as this may be low volume control information only).

The reconstruction module (874) is configured to combine, in the spatial domain, the residual information as output by the residue decoder (873) and the prediction results (as output by the inter or intra prediction modules as the case may be) to form a reconstructed block, that may be part of the reconstructed picture, which in turn may be part of the reconstructed video. It is noted that other suitable operations, such as a deblocking operation and the like, can be performed to improve the visual quality.

It is noted that the video encoders (403), (603), and (703), and the video decoders (410), (510), and (810) can be implemented using any suitable technique. In an embodiment, the video encoders (403), (603), and (703), and the video decoders (410), (510), and (810) can be implemented using one or more integrated circuits. In another embodiment, the video encoders (403), (603), and (603), and the video decoders (410), (510), and (810) can be implemented using one or more processors that execute software instructions.

Aspects of the disclosure provide techniques for coding of inter prediction direction and BCW index in merge mode.

Various inter prediction modes can be used in VVC. For an inter-predicted CU, motion parameters can include MV(s), one or more reference picture indices, a reference picture list usage index, and additional information for certain coding features to be used for inter-predicted sample generation. A motion parameter can be signaled explicitly or implicitly. When a CU is coded with a skip mode, the CU can be associated with a PU and can have no significant residual coefficients, no coded motion vector delta or MV difference (e.g., MVD) or a reference picture index. A merge mode can be specified where the motion parameters for the current CU are obtained from neighboring CU(s), including spatial and/or temporal candidates, and optionally additional information such as introduced in VVC. The merge mode can be applied to an inter-predicted CU, not only for skip mode. In an example, an alternative to the merge mode is the explicit transmission of motion parameters, where MV(s), a corresponding reference picture index for each reference picture list and a reference picture list usage flag and other information are signaled explicitly per CU.

In an embodiment, such as in VVC, VVC Test model (VTM) reference software includes one or more refined inter prediction coding tools that include: an extended merge prediction, a merge motion vector difference (MMVD) mode, an adaptive motion vector prediction (AMVP) mode with symmetric MVD signaling, an affine motion compensated prediction, a subblock-based temporal motion vector prediction (SbTMVP), an adaptive motion vector resolution (AMVR), a motion field storage ( 1/16th luma sample MV storage and 8×8 motion field compression), a bi-prediction with CU-level weights (BCW), a bi-directional optical flow (BDOF), a prediction refinement using optical flow (PROF), a decoder side motion vector refinement (DMVR), a combined inter and intra prediction (CIIP), a geometric partitioning mode (GPM), and the like. Inter predictions and related methods are described in details below.

Extended merge prediction can be used in some examples. In an example, such as in VTM4, a merge candidate list is constructed by including the following five types of candidates in order: spatial motion vector predictor(s) (MVP(s)) from spatial neighboring CU(s), temporal MVP(s) from collocated CU(s), history-based MVP(s) (HMVP(s)) from a first-in-first-out (FIFO) table, pairwise average MVP(s), and zero MV(s).

A size of the merge candidate list can be signaled in a slice header. In an example, the maximum allowed size of the merge candidate list is 6 in VTM4. For each CU coded in the merge mode, an index (e.g., a merge index) of a best merge candidate can be encoded using truncated unary binarization (TU). The first bin of the merge index can be coded with context (e.g., context-adaptive binary arithmetic coding (CABAC)) and a bypass coding can be used for other bins.

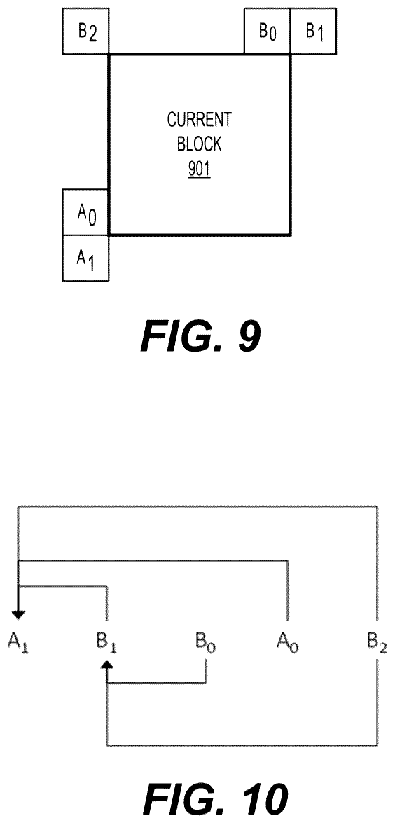

Some examples of a generation process of each category of merge candidates are provided below. In an embodiment, spatial candidate(s) are derived as follows. The derivation of spatial merge candidates in VVC can be identical to that in HEVC. In an example, a maximum of four merge candidates are selected among candidates located in positions depicted in FIG.9. FIG. 9 shows positions of spatial merge candidates according to an embodiment of the disclosure. Referring to FIG. 9, an order of derivation is B1, A1, B0, A0, and B2. The position B2 is considered only when any CU of positions A0, B0, B1, and A1 is not available (e.g., because the CU belongs to another slice or another tile) or is intra coded. After a candidate at the position A1 is added, the addition of the remaining candidates is subject to a redundancy check which ensures that candidates with same motion information are excluded from the candidate list so that coding efficiency is improved.

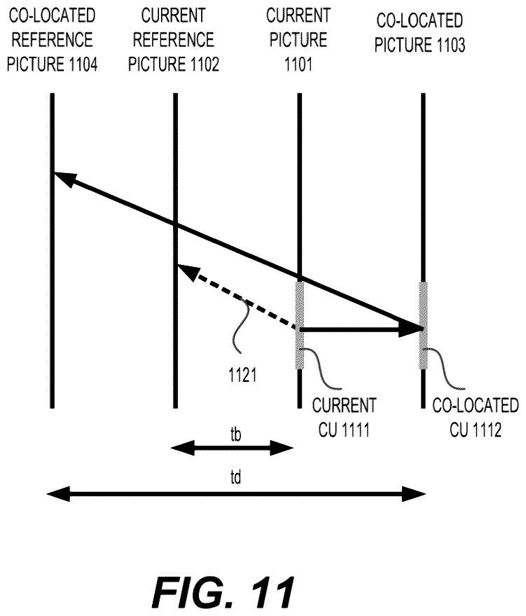

To reduce computational complexity, not all possible candidate pairs are considered in the mentioned redundancy check. Instead, only pairs linked with an arrow in FIG. 10 are considered and a candidate is only added to the candidate list if the corresponding candidate used for the redundancy check does not have the same motion information. FIG. 10 shows candidate pairs that are considered for a redundancy check of spatial merge candidates according to an embodiment of the disclosure. Referring to FIG. 10, the pairs linked with respective arrows include A1 and B1, A1 and A0, A1 and B2, B1 and B0, and B1 and B2. Thus, candidates at the positions B1, A0, and/or B2 can be compared with the candidate at the position A1, and candidates at the positions B0 and/or B2 can be compared with the candidate at the position B1.

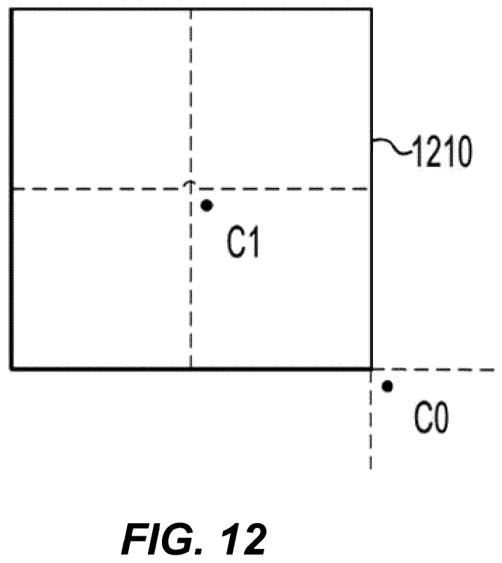

In an embodiment, temporal candidate(s) are derived as follows. In an example, only one temporal merge candidate is added to the candidate list. FIG. 11 shows exemplary motion vector scaling for a temporal merge candidate. To derive the temporal merge candidate of a current CU (1111) in a current picture (1101), a scaled MV (1121) (e.g., shown by a dotted line in FIG. 11) can be derived based on a co-located CU (1112) belonging to a collocated reference picture (1104). A reference picture list used to derive the co-located CU (1112) can be explicitly signaled in a slice header. The scaled MV (1121) for the temporal merge candidate can be obtained as shown by the dotted line in FIG. 11. The scaled MV (1121) can be scaled from the MV of the co-located CU (1112) using picture order count (POC) distances tb and td. The POC distance tb can be defined to be the POC difference between a current reference picture (1102) of the current picture (1101) and the current picture (1101). The POC distance td can be defined to be the POC difference between the collocated reference picture (1104) of the co-located picture (1103) and the co-located picture (1103). A reference picture index of the temporal merge candidate can be set to zero.

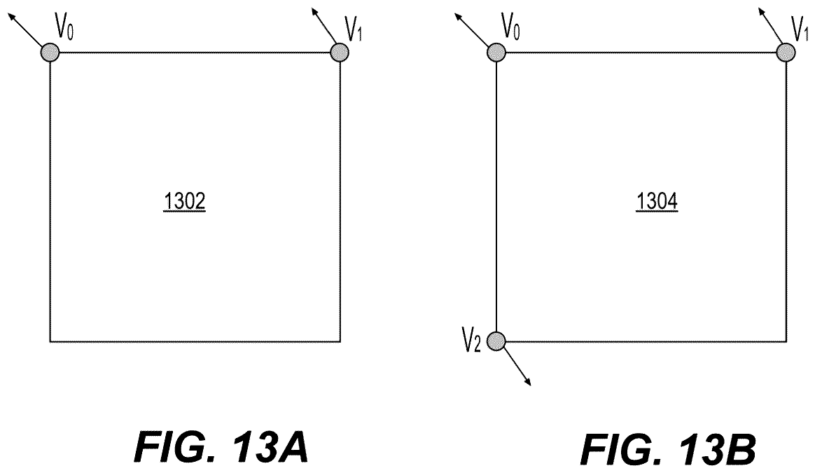

FIG. 12 shows exemplary candidate positions (e.g., C0 and C1) for a temporal merge candidate of a current CU. A position for the temporal merge candidate can be selected from the candidate positions C0 and C1. The candidate position C0 is located at a bottom-right corner of a co-located CU (1210) of the current CU. The candidate position C1 is located at a center of the co-located CU (1210) of the current CU. If a CU at the candidate position C0 is not available, is intra coded, or is outside of a current row of CTUs, the candidate position C1 is used to derive the temporal merge candidate. Otherwise, for example, the CU at the candidate position C0 is available, intra coded, and in the current row of CTUs, the candidate position C0 is used to derive the temporal merge candidate.

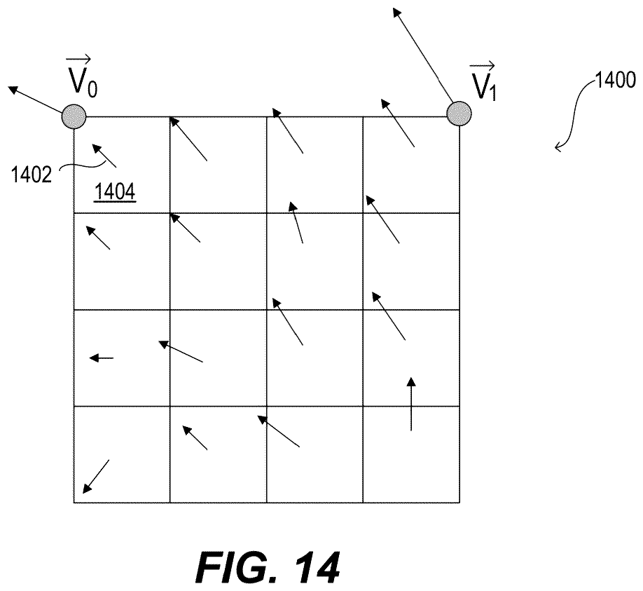

In HEVC, a translation motion model is applied for motion compensation prediction (MCP). While in the real world, many kinds of motions can exist, such as zoom in/out, rotation, perspective motions, and other irregular motions. A block-based affine transform motion compensation prediction can be applied, such as in VTM. FIG. 13A shows an affine motion field of a block (1302) described by motion information of two control points (4-parameter). FIG. 13B shows an affine motion field of a block (1304) described by three control point motion vectors (6-parameter).

As shown in FIG. 13A, in the 4-parameter affine motion model, a motion vector at a sample location (x, y) in the block (1302) can be derived in Eq. (1) as follows:

$$\{ \begin{matrix}{mv}_{x} = \frac{{mv}_{1 x} - {mv}_{0 x}}{W} x + \frac{{mv}_{1 y} - {mv}_{0 y}}{W} y + {mv}_{0 x} \\ {mv}_{y} = - \frac{{mv}_{1 y} - {mv}_{0 y}}{W} x + \frac{{mv}_{1 x} - {mv}_{0 x}}{W} y + {mv}_{0 y}\end{matrix} \qquad Eq . ( 1 )$$

where mvₓ can be the motion vector in a first direction (or X direction) and mv_{y} can be the motion vector in a second direction (or Y direction). The motion vector can also be described in Eq. (2):

$$\{ \begin{matrix}{mv}_{x} = ax + by + c \\ {mv}_{y} = - bx + ay + f\end{matrix} \qquad Eq . ( 2 )$$

As shown in FIG. 13B, in the 6-parameter affine motion model, a motion vector at a sample location (x, y) in the block (1304) can be derived in Eq. (3) as follows:

$$\{ \begin{matrix}{mv}_{x} = \frac{{mv}_{1 x} - {mv}_{0 x}}{W} x + \frac{{mv}_{2 x} - {mv}_{0 x}}{H} y + {mv}_{0 x} \\ {mv}_{y} = \frac{{mv}_{1 y} - {mv}_{0 y}}{W} x + \frac{{mv}_{2 y} - {mv}_{0 y}}{H} y + {mv}_{0 y}\end{matrix} \qquad Eq . ( 3 )$$

The 6-parameter affine motion model can also described in Eq. (4) as follows:

$$\{ \begin{matrix}{mv}_{x} = ax + by + c \\ {mv}_{y} = dx + ey + f\end{matrix} \qquad Eq . ( 4 )$$

As shown in Eq. (1) and Eq. (3), (mv₀ₓ, mv_{0y}) can be a motion vector of a top-left corner control point. (mv₁ₓ, mv_{1y}) can be motion vector of a top-right corner control point. (mv₂ₓ, mv_{2y}) can be a motion vector of a bottom-left corner control point.

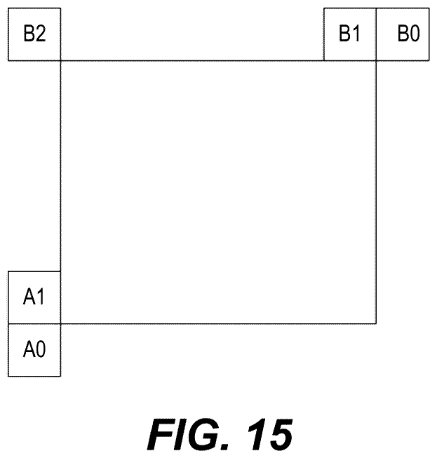

As shown in FIG. 14, to simplify the motion compensation prediction, block based affine transform prediction can be applied. To derive a motion vector of each 4×4 luma sub-block, a motion vector of a center sample (e.g., (1402)) of each sub-block (e.g., (1404)) in a current block (1400) can be calculated according to the equations (1)-(4), and rounded to 1/16 fraction accuracy. Motion compensation interpolation filters can then be applied to generate the prediction of each sub-block with the derived motion vector. A sub-block size of chroma-components can also be set as 4×4. The MV of a 4×4 chroma sub-block can be calculated as an average of MVs of four corresponding 4×4 luma sub-blocks.

In affine merge prediction, an affine merge (AF_MERGE) mode can be applied for CUs with both a width and a height larger than or equal to 8. CPMVs of a current CU can be generated based on motion information of spatial neighboring CUs. Up to five CPMVP candidates can be applied for the affine merge prediction and an index can be signalled to indicate which one of the five CPMVP candidates can be used for the current CU. In affine merge prediction, three types of CPMV candidate can be used to form the affine merge candidate list: (1) inherited affine merge candidates that are extrapolated from CPMVs of neighbour CUs, (2) constructed affine merge candidates with CPMVPs that are derived using translational MVs of neighbour CUs, and (3) Zero MVs.

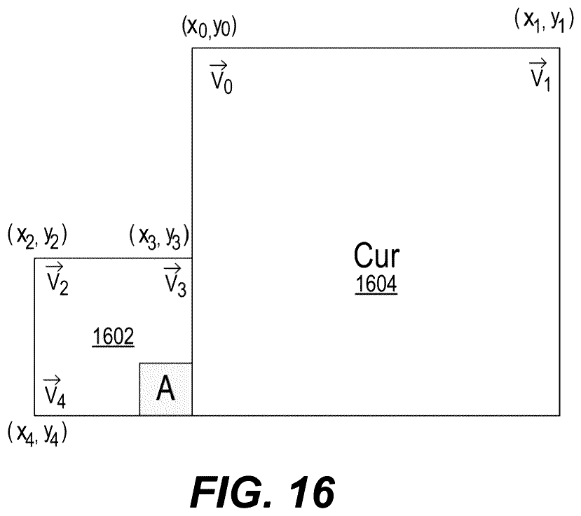

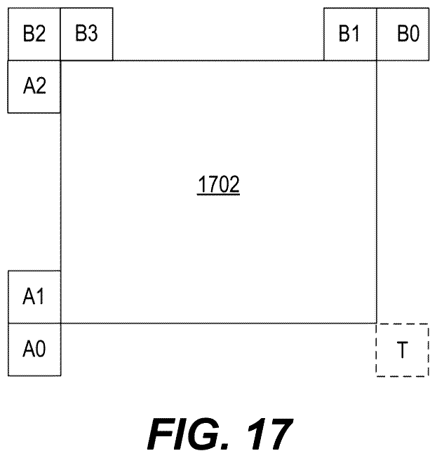

In VTM3, a maximum of two inherited affine candidates can be applied. The two inherited affine candidates can be derived from an affine motion model of neighboring blocks. For example, one inherited affine candidate can be derived from left neighboring CUs and the other inherited affine candidate can be derived from above neighboring CUs. Exemplary candidate blocks can be shown in FIG. 15. As shown in FIG. 15, for a left predictor (or a left inherited affine candidate), a scan order can be A0->A1, and for an above predictor (or an above inherited affine candidate), a scan order can be B0->B1->B2. Thus, only the first available inherited candidate from each side can be selected. No pruning check may be performed between two inherited candidates. When a neighboring affine CU is identified, control point motion vectors of the neighboring affine CU can be used to derive the CPMVP candidate in the affine merge list of the current CU. As shown in FIG. 16, when a neighboring left bottom block A of a current block (1604) is coded in affine mode, motion vectors v₂, v₃ and v₄ of a top left corner, an above right corner, and a left bottom corner of a CU (1602) which contains the block A can be attained. When the block A is coded with 4-parameter affine model, two CPMVs of the current CU (1604) can be calculated according to v₂, and v₃ of the CU (1602). In a case that block A is coded with a 6-parameter affine model, three CPMVs of the current CU (1604) can be calculated according to v₂, v₃ and v₄ of the CU (1602).

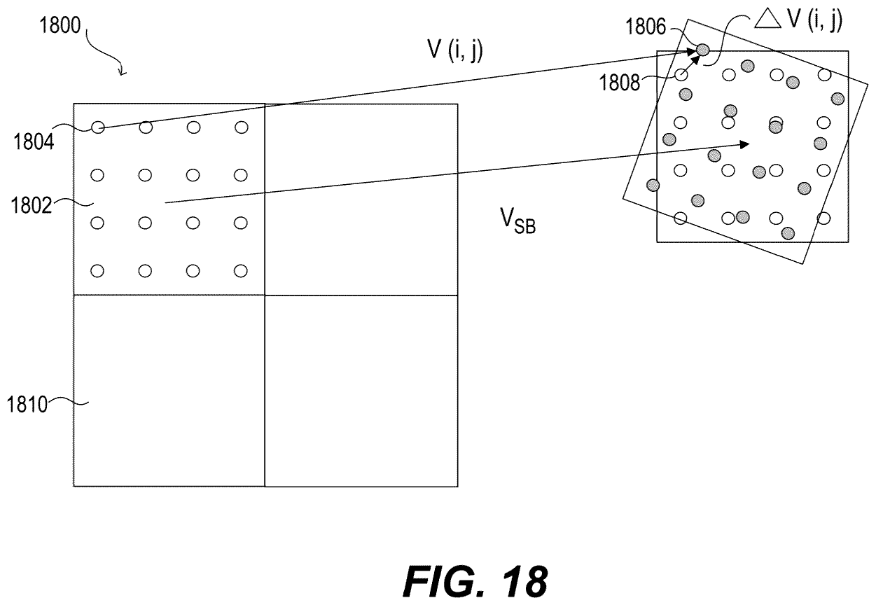

A constructed affine candidate of a current block can be a candidate that is constructed by combining neighbor translational motion information of each control point of the current block. The motion information of the control points can be derived from specified spatial neighbors and a temporal neighbor that can be shown in FIG. 17. As shown in FIG. 17, CPMVₖ (k=1, 2, 3, 4) represents a k-th control point of a current block (1702). For CPMV₁, B2->B3->A2 blocks can be checked and an MV of the first available block can be used. For CPMV₂, B1->B0 blocks can be checked. For CPMV₃, A1->A0 blocks can be checked. TMVP can be used as CPMV₄ if CPM₄ is not available.

After MVs of four control points are attained, affine merge candidates can be constructed for the current block (1702) based on motion information of the four control points. For example, the affine merge candidates can be constructed based on combinations of the MVs of the four control points in an order as follows: {CPMV₁, CPMV₂, CPMV₃}, {CPMV₁, CPMV₂, CPMV₄}, {CPMV₁, CPMV₃, CPMV₄}, {CPMV₂, CPMV₃, CPMV₄}, {CPMV₁, CPMV₂}, and {CPMV₁, CPMV₃}.

The combination of 3 CPMVs can construct a 6-parameter affine merge candidate and the combination of 2 CPMVs can construct a 4-parameter affine merge candidate. To avoid a motion scaling process, if reference indices of control points are different, a related combination of control point MVs can be discarded.

After inherited affine merge candidates and constructed affine merge candidate are checked, if the list is still not full, zero MVs can be inserted to an end of the list.

In affine AMVP prediction, an affine AMVP mode can be applied for CUs with both a width and a height larger than or equal to 16. An affine flag in CU level can be signalled in the bitstream to indicate whether affine AMVP mode is used and then another flag can be signaled to indicate whether a 4-parameter affine or a 6-parameter affine is applied. In affine AMVP prediction, a difference of CPMVs of a current CU and predictors of the CPMVPs of the current CU can be signalled in the bitstream. A size of an affine AMVP candidate list can be 2 and the affine AMVP candidate list can be generated by using four types of CPMV candidate in an order as follows:
(1) Inherited affine AMVP candidates that are extrapolated from the CPMVs of the neighbour CUs,
(2) Constructed affine AMVP candidates with CPMVPs that are derived using the translational MVs of the neighbour CUs,
(3) Translational MVs from neighboring CUs, and
(40 Zero MVs.

A checking order of inherited affine AMVP candidates can be the same as a checking order of inherited affine merge candidates. To determine an AVMP candidate, only an affine CU that has the same reference picture as the current block can be considered. No pruning process may be applied when an inherited affine motion predictor is inserted into the candidate list.

A constructed AMVP candidate can be derived from specified spatial neighbors. As shown in FIG. 17, the same checking order can be applied as the checking order in affine merge candidate construction. In addition, a reference picture index of a neighboring block can also be checked. A first block in the checking order can be inter coded and have the same reference picture as the current CU (1702). One constructed AMVP candidate can be determined when the current CU (1702) is coded with a 4-parameter affine mode, and mv o and mv₁ are both available. The constructed AMPV candidate can further be added to the affine AMVP list. When the current CU (1702) is coded with a 6-parameter affine mode, and all three CPMVs are available, the constructed AMVP candidate can be added as one candidate in the affine AMVP list. Otherwise, the constructed AMVP candidate can be set as unavailable.

If candidates in the affine AMVP list are still less than 2 after the inherited affine AMVP candidates and the constructed AMVP candidate are checked, mv₀, mv₁ and mv₂ can be added, in order. The mv₀, mv₁ and mv₂ can function as translational MVs to predict all control point MVs of the current CU (e.g., (1702)) when available. Finally, zero MVs can be used to fill the affine AMVP list if the affine AMVP is still not full.

Subblock-based affine motion compensation can save memory access bandwidth and reduce computation complexity compared to pixel based motion compensation, at the cost of a prediction accuracy penalty. To achieve a finer granularity of motion compensation, prediction refinement with optical flow (PROF) can be used to refine the subblock-based affine motion compensated prediction without increasing the memory access bandwidth for motion compensation. In VVC, after the subblock-based affine motion compensation is performed, a luma prediction sample can be refined by adding a difference derived by an optical flow equation. The PROF can be described in four steps as follows:

Step (1): the subblock-based affine motion compensation can be performed to generate subblock prediction I(i, j).

Step (2): spatial gradients gₓ(i, j) and g_{y}(i, j) of the subblock prediction can be calculated at each sample location using a 3-tap filter [−1, 0, 1]. The gradient calculation can be the same as gradient calculation in BDOF. For example, the spatial gradients gₓ(i, j) and g_{y}(i, j) can be calculated based on Eq. (5) and Eq. (6) respectively.

gₓ(i, j)=(I(i+1, j)>>shift1)−(I(i−1, j)>>shift1) Eq. (5)

g_{y}(i, j)=(I(i, j+1)>>shift1)−(I(i, j−1)>>shift1) Eq. (6)

As shown in equations (5) and (6), shift1 can be used to control a precision of the gradient. Subblock (e.g., 4×4) prediction can be extended by one sample on each side for the gradient calculation. To avoid additional memory bandwidth and additional interpolation computation, extended samples on extended borders can be copied from a nearest integer pixel position in the reference picture.

Step (3): luma prediction refinement can be calculated by an optical flow equation as shown in Eq. (7).

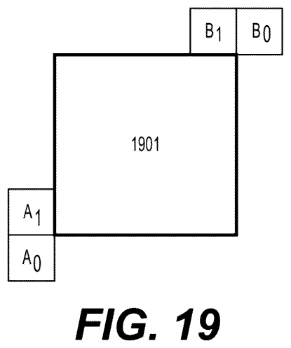

ΔI(i, j)=gₓ(i, j)*Δvₓ(i, j)+g_{y}(i, j)*Δv_{y}(i, j) Eq. (7)

where Δv(i, j) can be a difference between a sample MV computed for a sample location (i, j), denoted by v(i, j), and a subblock MV, denoted by v_{SB}, of a subblock to which the sample (i, j) belongs. FIG. 18 shows an exemplary illustration of the difference between the sample MV and the subblock MV. As shown in FIG. 18, a subblock (1802) can be included in a current block (1800) and a sample (1804) can be included in the subblock (1802). The sample (1804) can include a sample motion vector v(i, j) that corresponds to a reference pixel (1806). The subblock (1802) can include a subblock motion vector V_{SB}. Based on the subblock motion vector v_{SB}, the sample (1804) can correspond to a reference pixel (1808). A difference between the sample MV and the subblock MV, denoted by Δv(i, j), can be indicated by a difference between the reference pixel (1806) and the reference pixel (1808). The Δv(i, j) can be quantized in a unit of 1/32 luma sample precision.

Since affine model parameters and a sample location relative to a subblock center may not be changed from a subblock to another subblock, Δv(i, j) can be calculated for a first subblock (e.g., (1802)), and reused for other subblocks (e.g., (1810)) in the same CU (e.g., (1800)). Let dx(i, j) be a horizontal offset and dy(i, j) be a vertical offset from a sample location (i, j) to a center of a subblock (x_{SB}, y_{SB}), Δv(x, y) can be derived by Eq. (8) and Eq. (9) as follows:

$$\{ \begin{matrix}dx ( i , j ) = i - {x}_{SB} \\ dy ( i , j ) = i - {y}_{SB}\end{matrix} \qquad Eq . ( 8 )$$

$$\{ \begin{matrix}Δ {v}_{x} ( i , j ) = C * dx ( i , j ) + D * dy ( i , j ) \\ Δ {v}_{y} ( i , j ) = E * dx ( i , j ) + F * dy ( i , j )\end{matrix} \qquad Eq . ( 9 )$$

In order to keep accuracy, the center of the subblock (x_{SB}, y_{SB}) can be calculated as ((W_{SB}−1)/2, (H_{SB}−1)/2), where W_{SB} and H_{SB} are the subblock width and height, respectively.

Once Δv(x, y) is obtained, parameters of the affine model can be obtained. For example, for a 4-parameter affine model, the parameters of the affine model can be shown in Eq. (10).

$$\{ \begin{matrix}C = F = \frac{{v}_{1 x} - {v}_{0 x}}{w} \\ E = - D = \frac{{v}_{1 y} - {v}_{0 y}}{w}\end{matrix} \qquad Eq . ( 10 )$$

For a 6-parameter affine model, the parameters of the affine model can be shown in Eq. (11).

$$\{ \begin{matrix}C = \frac{{v}_{1 x} - {v}_{0 x}}{w} \\ D = \frac{{v}_{2 x} - {v}_{0 x}}{h} \\ E = \frac{{v}_{1 y} - {v}_{0 y}}{w} \\ F = \frac{{v}_{2 y} - {v}_{0 y}}{h}\end{matrix} \qquad Eq . ( 11 )$$

where (v₀ₓ, v_{0y}), (v₁ₓ, v_{1y}), (v₂ₓ, v_{2y}) can be a top-left control point motion vector, a top-right control point motion vector, and a bottom-left control point motion vector respectively, and w and h can be a width and a height of the CU respectively.

Step (4): finally, the luma prediction refinement ΔI(i, j) can be added to the subblock prediction I(i, j). A final prediction I′ can be generated as shown in Eq. (12).

I′(i, j)=I(i, j)+ΔI(i, j) Eq. (12)

PROF may not be applied in two cases for an affine coded CU: (1) all control point MVs are the same, which indicates that the CU only has translational motion, and (2) the affine motion parameters are greater than a specified limit because the subblock-based affine MC is degraded to CU-based MC to avoid a large memory access bandwidth requirement.

To improve the coding efficiency and reduce the transmission overhead of MV(s), a subblock level MV refinement can be applied to extend a CU level temporal motion vector prediction (TMVP). In an example, a subblock-based TMVP (SbTMVP) mode allows inheriting motion information at a subblock-level from a collocated reference picture. Each subblock of a current CU (e.g., a current CU with a large size) in a current picture can have respective motion information without explicitly transmitting a block partition structure or the respective motion information. In the SbTMVP mode, motion information for each subblock can be obtained as follows, for example, in three steps. In the first step, a displacement vector (DV) of the current CU can be derived. In the second step, availability of an SbTMVP candidate can be checked and a central motion (e.g., a central motion of the current CU) can be derived. In the third step, subblock motion information can be derived from a corresponding subblock in the collocated block using the DV. The three steps can be combined into one or two steps, and/or an order of the three steps may be adjusted.

Unlike TMVP candidate derivation which derives temporal MVs from a collocated block in a reference frame or a reference picture, in the SbTMVP mode, a DV (e.g., a DV derived from an MV of a left neighboring CU of the current CU) can be applied to locate a corresponding subblock in the collocated picture for each subblock in the current CU that is in the current picture. If the corresponding subblock is not inter-coded, motion information of the current subblock can be set to be the central motion of the collocated block.

The SbTMVP mode can be supported by various video coding standards including for example VVC. Similar to the TMVP mode, for example, in HEVC, in the SbTMVP mode, a motion field (also referred to as a motion information field or an MV field) in the collocated picture can be used to improve MV prediction and a merge mode for CUs in the current picture. In an example, the same collocated picture used by the TMVP mode is used in the SbTVMP mode. In an example, the SbTMVP mode differs from the TMVP mode in the following aspects: (i) the TMVP mode predicts motion information at the CU level while the SbTMVP mode predicts motion information at a sub-CU level; (ii) the TMVP mode fetches the temporal MVs from the collocated block in the collocated picture (e.g., the collocated block is the bottom-right or a center block relative to the current CU) while the SbTMVP mode can apply a motion shift before fetching the temporal motion information from the collocated picture. In an example, the motion shift used in the SbTMVP mode is obtained from an MV of one of spatial neighboring blocks of the current CU.

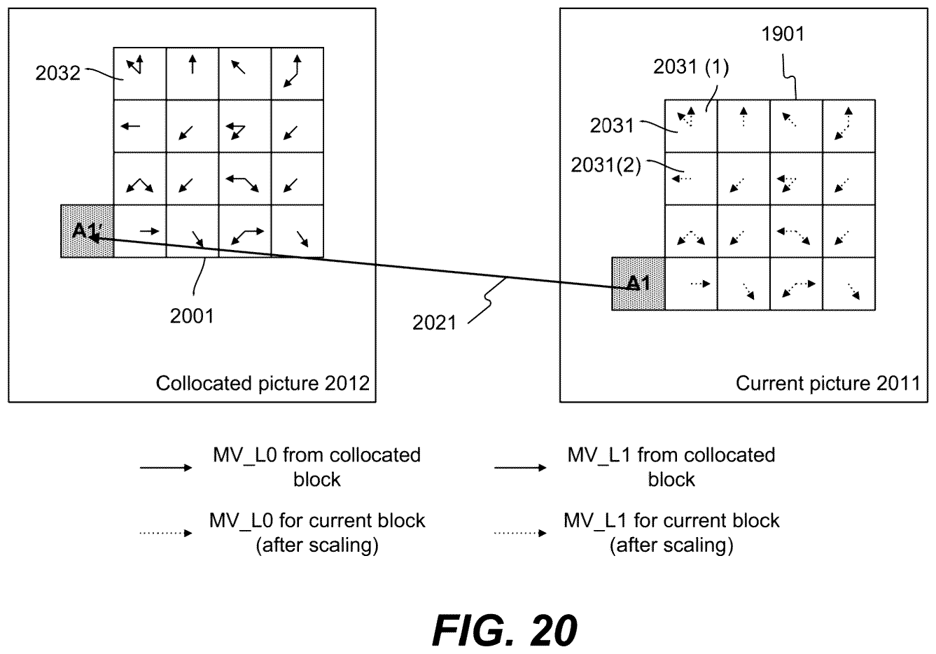

FIGS. 19-20 show an exemplary SbTMVP process used in the SbTMVP mode. The SbTMVP process can predict MVs of sub-CUs (e.g., subblocks) within a current CU (e.g., a current block) (1901) in a current picture (2011), for example, in two steps. In the first step, a spatial neighbor (e.g., A1) of the current block (1901) in FIGS. 19-20 is examined. If the spatial neighbor (e.g., A1) has an MV (2021) that uses a collocated picture (2012) as a reference picture of the spatial neighbor (e.g., A1), the MV (2021) can be selected to be a motion shift (or a DV) to be applied to the current block (1901). If no such MV (e.g., an MV that uses the collocated picture (2012) as a reference picture) is identified, the motion shift or the DV can be set to a zero MV (e.g., (0, 0)). In some examples, MV(s) of additional spatial neighbors, such as A0, B0, B1, and the like are checked if no such MV is identified for the spatial neighbor A1.

In the second step, the motion shift or the DV (2021) identified in the first step can be applied to the current block (1901) (e.g., the DV (2021) is added to coordinates of the current block) to obtain sub-CU level motion information (e.g., including MVs and reference indices) from the collocated picture (2012). In the example shown in FIG. 20, the motion shift or the DV (2021) is set to be the MV of the spatial neighbor A1 (e.g., a block A1) of the current block (1901). For each sub-CU or subblock (2031) in the current block (1901), motion information of a corresponding collocated block (2001) (e.g., motion information of the smallest motion grid that covers a center sample of the collocated block (2001)) in the collocated picture (2012) can be used to derive the motion information for the sub-CU or subblock (2031). After the motion information of the collocated sub-CU (2032) in the collocated block (2001) is identified, the motion information of the collocated sub-CU (2032) can be converted to the motion information (e.g., MV(s) and one or more reference indices) of the current sub-CU (2031), for example, using a scaling method, such as in a similar way as the TMVP process used in HEVC, where temporal motion scaling is applied to align reference pictures of temporal MVs to reference pictures of a current CU.

The motion field of the current block (1901) derived based on the DV (2021) can include motion information of each subblock (2031) in the current block (1901), such as MV(s) and one or more associated reference indices. The motion field of the current block (1901) can also be referred to as an SbTMVP candidate and corresponds to the DV (2021).

FIG. 20 shows an example of the motion field or the SbTMVP candidate of the current block (1901). The motion information of the subblock (2031(1)) that is bi-predicted includes a first MV, a first index indicating a first reference picture in a reference picture list 0 (L0), a second MV and a second index indicating a second reference picture in a reference picture list 1 (L1). In an example, the motion information of the subblock (2031(2)) that is un-predicted includes an MV and an index indicating a reference picture in L0 or L1.

In an example, the DV (2021) is applied to a central position of the current block (1901) to locate a displaced central position in the collocated picture (2012). If a block including the displaced central position is not inter-coded, the SbTMVP candidate is considered not available. Otherwise, if a block (e.g., the collocated block (2001)) including the displaced central position is inter-coded, the motion information of the central position of the current block (1901), referred to as central motion of the current block (1901), can be derived from motion information of the block including the displaced central position in the collocated picture (2012). In an example, a scaling process can be used to derive the central motion of the current block (1901) from the motion information of the block including the displaced central position in the collocated picture (2012). When the SbTMVP candidate is available, the DV (2021) can be applied to find the corresponding subblock (2032) in the collocated picture (2012) for each subblock (2031) of the current block (1901). The motion information of the corresponding subblock (2032) can be used to derive the motion information of the subblock (2031) in the current block (1901), such as in the same way used to derive the central motion of the current block (1901). In an example, if the corresponding subblock (2032) is not inter-coded, the motion information of the current subblock (2031) is set to be the central motion of the current block (1901).

In some examples, bi-prediction with CU-level weight (BCW) can be used to weight predictions from different reference pictures differently. In an example (e.g.., HEVC), the bi-prediction signal is generated by averaging two prediction signals obtained from two different reference pictures and/or using two different motion vectors. In some examples (e.g., VVC), the bi-prediction mode is extended beyond simple averaging to allow weighted averaging of the two prediction signals, such as shown by Eq. (13):

P_{bi-pred}=((8−w)×P₀+w×P₁+4)>>3 Eq. (13)

where P_{bi-pred} denotes the bi-prediction signal, P₀ denotes a first prediction signal from a first reference picture, P₁ denotes a second prediction signal from a second reference picture, and w denotes a weight parameter.

In some examples, five values are allowed for the BCW weight in the weighted averaging bi-prediction, for example w∈{−2, 3, 4, 5, 10}. In some examples, the BCW weights can be represented by BCW weight indices. For each bi-predicted CU, the value of the weight parameter w is determined in one of two ways: 1) for a non-merge CU, a weight index is signalled after the motion vector difference, the weight index indicates a value selected from a list; 2) for a merge CU, the weight index is inferred from neighbouring blocks based on the merge candidate index. In some examples, BCW is only applied to CUs with 256 or more luma samples (i.e., CU width times CU height is greater than or equal to 256). In an example, for low-delay pictures, all 5 weight values are used. For non-low-delay pictures, only 3 weights (e.g., w∈{3, 4, 5}) are used.

In some examples, at the encoder side, a search algorithm, such as a fast search algorithm, is applied to find the weight index without significantly increasing the encoder complexity. When BCW is combined with AMVR, unequal weights are only conditionally checked for 1-pel and 4-pel motion vector precisions if the current picture is a low-delay picture.

In some examples, when BCW is combined with affine, affine ME is performed for unequal weights if and only if the affine mode is selected as the current best mode.

In some examples, when the two reference pictures in bi-prediction are the same, unequal weights are conditionally checked.

In some examples, unequal weights are not searched when certain conditions are met, such as depending on the POC distance between current picture and its reference pictures, the coding QP, and the temporal level.

In some examples, the weight index for BCW is coded using a first context coded bin followed by bypass coded bins. The first context coded bin indicates if equal weight is used; and if unequal weight is used, additional bins are signalled using bypass coding to indicate which unequal weight is used from the list of values for weight parameter.

Some video codecs, such as the H.264/AVC and HEVC standards, support a coding tool that is referred to as weighted prediction (WP) to efficiently code video content with fading. Support for WP is also added into the VVC standard. WP allows weighting parameters (weight and offset) to be signalled for each reference picture in each of the reference picture lists L0 and L1. Then, during motion compensation, the weight(s) and offset(s) of the corresponding reference picture(s) are applied. WP and BCW are designed for different types of video content. In order to avoid interactions between WP and BCW, which will complicate VVC decoder design, if a CU uses WP, then the BCW weight index is not signalled, and w is inferred to be 4 (i.e. equal weight is applied). For a merge CU, the weight index is inferred from neighbouring blocks based on the merge candidate index. This can be applied to both normal merge mode and inherited affine merge mode. For constructed affine merge mode, the affine motion information is constructed based on the motion information of up to 3 blocks. The BCW index for a CU using the constructed affine merge mode is simply set equal to the BCW index of the first control point MV.

In VVC, CIIP and BCW cannot be jointly applied for a CU. When a CU is coded with CIIP mode, the BCW index of the current CU is set to 2, e.g., equal weight.

In an embodiment, a merge with motion vector difference (MMVD) mode is used, such as in VVC, where implicitly derived motion information can be used to predict samples of a CU (e.g., a current CU). MMVD mode is used for either skip or merge modes with a motion vector expression method. A MMVD merge flag can be signaled to specify whether the MMVD mode is used for the CU, for example, after signaling a skip flag or a merge flag.

In some examples, MMVD re-uses merge candidate. Among the merge candidates, a candidate can be selected, and is further expanded by the motion vector expression method. MMVD provides motion vector expression with simplified signaling. In some examples, the motion vector expression method includes starting point, motion magnitude, and motion direction.

In some examples (e.g., VVC), MMVD technique can use a merge candidate list to select the candidate for the starting point. However, in an example, only candidates which are default merge type (MRG_TYPE_DEFAULT_N) are considered for MMVD's expansion.

In some examples, a base candidate index is used to define the starting point. The base candidate index indicates the best candidate among candidates in the list as shown in Table 1. For example, the list is a merge candidate list with motion vector predictors (MVP). The base candidate index can indicate the best candidate in the merge candidate list.

TABLE 1
A example of a base candidate index (IDX)

| Base candidate IDX | 0 | 1 | 2 | 3 |
|---|---|---|---|---|
| N^{th} MVP | 1^{st} MVP | 2^{nd} MVP | 3^{rd} MVP | 4^{th} MVP |

It is noted that in an example, the number of base candidate is equal to 1, then base candidate IDX is not signaled.

In the MMVD mode, after a merge candidate (also referred to as an MV basis or an MV starting point) is selected, the merge candidate can be refined by additional information, such as signaled MVD information. The additional information can include an index (such as a distance index, e.g., mmvd_distance_idx[x0][y0]) used to specify a motion magnitude and an index (such as a direction index, e.g., mmvd_direction_idx[x0][y0]) used to indicate a motion direction. In the MMVD mode, one of the first two candidates in the merge list can be selected as an MV basis. For example, a merge candidate flag (e.g., mmvd_cand_flag[x0][y0]) indicates the one of the first two candidates in the merge list. The merge candidate flag can be signaled to indicate (e.g., specify) which one of the first two candidates is selected. The additional information can indicate a MVD (or a motion offset) to the MV basis. For example, the motion magnitude indicates a magnitude of the MVD, the motion direction indicates a direction of the MVD.

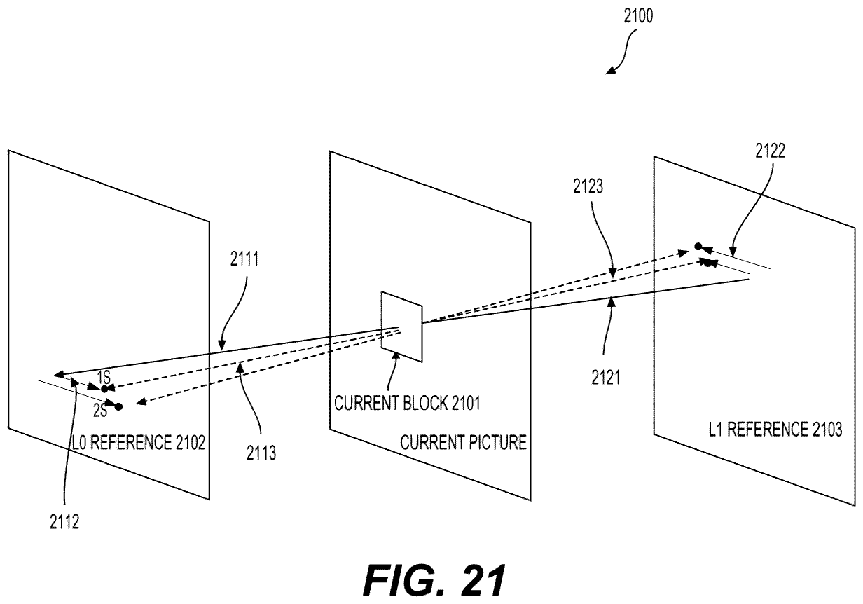

In an example, the merge candidate selected from the merge candidate list is used to provide the starting point or the MV starting point at a reference picture. A motion vector of the current block can be expressed with the starting point and a motion offset (or MVD) including a motion magnitude and a motion direction with respect to the starting point. At an encoder side, selection of the merge candidate and determination of the motion offset can be based on a search process (an evaluation process), such as shown in FIG. 21. At a decoder side, the selected merge candidate and the motion offset can be determined based on signaling from the encoder side.

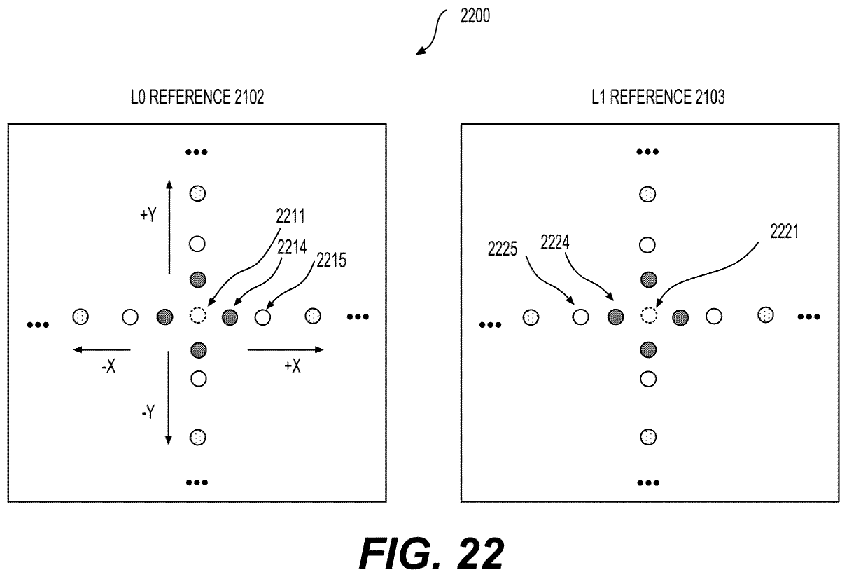

FIG. 21 shows an example of a search process (2100) in a MMVD mode. FIG. 22 shows examples of search points in a MMVD mode. In some examples, a subset or an entire set of the search points in FIG. 22 are used in the search process (2100) in FIG. 21. By performing the search process (2100), for example, at the encoder side, the additional information including the merge candidate flag (e.g., mmvd_cand_flag[x0][y0]), the distance index (e.g., mmvd_distance_idx[x0][y0]), and the direction index (e.g., mmvd_direction_idx[x0][y0]) can be determined for a current block (2101) in a current picture (or a current frame).

A first motion vector (2111) and a second motion vector (2121) belonging to a first merge candidate are shown. The first motion vector (2111) and the second motion vector (2121) are MV starting points used in the search process (2100). The first merge candidate can be a merge candidate on a merge candidate list constructed for the current block (2101). The first and second motion vectors (2111) and (2121) can be associated with two reference pictures (2102) and (2103) in reference picture lists L0 and L1, respectively. Referring to FIGS. 21-22, the first and second motion vectors (2111) and (2121) can point to two starting points (2211) and (2221) in the reference pictures (2102) and (2103), respectively, as shown in FIG. 22.

Referring to FIG. 22, the two starting points (2211) and (2221) in FIG. 22 can be determined at the reference pictures (2102) and (2103). In an example, based on the starting points (2211) and (2221), multiple predefined points extending from the starting points (2211) and (2221) in vertical directions (represented by +Y, or −Y) or horizontal directions (represented by +X and −X) in the reference pictures (2102) and (2103) can be evaluated. In one example, a pair of points mirroring each other with respect to the respective starting point (2211) or (2221), such as the pair of points (2214) and (2224) (e.g., indicated by a shift of 1S in FIG. 21), or the pair of points (2215) and (2225) (e.g., indicated by a shift of 2S in FIG. 21), can be used to determine a pair of motion vectors (e.g., MVs (2113) and (2123) in FIG. 21) which may form a motion vector predictor candidate for the current block (2101). The motion vector predictor candidates (e.g., MVs (2113) and (2123) in FIG. 21) determined based on the predefined points surrounding the starting points (2211) or (2221) can be evaluated.

The distance index (e.g., mmvd_distance_idx[x0][y0]) can specify motion magnitude information and indicate a pre-defined offset (e.g., 1S or 2S in FIG. 21) from the starting point that is indicated by the merge candidate flag. It is noted that the predefined offset is also referred to as MMVD step in an example.

Referring to FIG. 21, an offset (e.g., a MVD (2112) or a MVD (2122)) can be applied (e.g., added) to a horizontal component or a vertical component of the starting MV (e.g., the MV (2111) or (2121)). An exemplary relationship of the distance index (IDX) and the pre-defined offset is specified in Table 2. When a full-pel MMVD is off, for example, a full-pel MMVD flag (e.g., slice_fpel_mmvd_enabled_flag) is equal to 0, a range of MMVD pre-defined offsets can be from 1/4 luma samples to 32 luma samples. When the full-pel MMVD is off, the pre-defined offset can have a non-integer value, such as a fraction of a luma sample (e.g., ¼ pixel or ½ pixel). When the full-pel MMVD is on, for example, the full-pel MMVD flag (e.g., slice_fpel_mmvd_enabled_flag) is equal to 1, the range of MMVD pre-defined offsets can be from 1 luma sample to 128 luma samples. In an example, when the full-pel MMVD is on, the pre-defined offset only has an integer value, such as one or more luma samples.

TABLE 2
An exemplary relationship of a distance
index and an offset (e.g., a pre-defined offset)

| Distance IDX | 0 | 1 | 2 | 3 | 4 | 5 | 6 | 7 |
|---|---|---|---|---|---|---|---|---|
| Offset (in unit of | 1/4 | 1/2 | 1 | 2 | 4 | 8 | 16 | 32 |
| luma sample) | | | | | | | | |
| Full-pel MMVD off | | | | | | | | |
| Offset (in unit of | 1 | 2 | 4 | 8 | 16 | 32 | 64 | 128 |
| luma sample) | | | | | | | | |
| Full-pel MMVD on | | | | | | | | |

The direction index can represent a direction (or a motion direction) of the MVD relative to the starting point. In an example, the direction index represents one of the four directions shown in Table 3. The meaning of MVD sign(s) in Table 3 can vary according to information of starting MV(s). In an example, when the starting MV is a uni-prediction MV or the starting MVs are bi-prediction MVs with both reference lists point to a same side of the current picture (e.g., POCs of two reference pictures are both larger than a POC of the current picture or the POCs of the two reference pictures are both smaller than the POC of the current picture), the MVD sign(s) in Table 3 specifies the sign of the MV offset (or the MVD) that is added to the starting MV.

When the starting MVs are the bi-prediction MVs with the two MVs pointing to different sides of the current picture (e.g., the POC of one reference picture is larger than the POC of the current picture, and the POC of the other reference picture is smaller than the POC of the current picture), the MVD sign in Table 3 specifies the sign of the MV offset (or the MVD) added to the list0 MV component of the starting MV and the MVD sign for the list1 MV has an opposite value. Referring to FIG. 21, the starting MVs (2111) and (2121) are the bi-prediction MVs with the two MVs (2111) and (2121) point to different sides of the current picture. The POC of the L1 reference picture (2103) is larger than the POC of the current picture, and the POC of the L0 reference picture (2102) is smaller than the POC of the current picture. The MVD sign (e.g., the sign “+” for the x-axis) indicated by the direction index (e.g., 00) in Table 2 specifies the sign (e.g., the sign “+” for the x-axis) of the MVD (e.g., the MVD (2112)) added to the list0 MV component of the starting MV (e.g., (2111)) and the MVD sign of the MVD (2122) for the list1 MV component of the starting MV (e.g., (2121)) has an opposite value, such as a sign “−” that is opposite to the sign “+” of the MVD (2112).

Referring to Table 3, the direction index 00 indicates a positive direction in the x-axis, the direction index 01 indicates a negative direction in the x-axis, the direction index 10 indicates a positive direction in the y-axis, and the direction index 11 indicates a negative direction in the y-axis.

TABLE 3
An exemplary relationship between a sign
of an MV offset and a direction index

| Direction IDX | 00 | 01 | 10 | 11 |
|---|---|---|---|---|
| x-axis | + | − | N/A | N/A |
| y-axis | N/A | N/A | + | − |

A syntax element mmvd_merge_flag[x0][y0] can be used to represent the MMVD merge flag of the current CU. In an example, the MMVD merge flag (e.g., mmvd_merge_flag[x0][y0]) equal to 1 specifies that the MMVD mode is used to generate the inter prediction parameters of the current CU. The MMVD merge flag (e.g., mmvd_merge_flag[x0][y0]) equal to 0 specifies that the MMVD mode is not used to generate the inter prediction parameters. The array indices x0 and y0 can specify a location (x0, y0) of a top-left luma sample of the considered coding block (e.g., the current CB) relative to a top-left luma sample of the picture (e.g., the current picture).

When the MMVD merge flag (e.g., mmvd_merge_flag[x0][y0]) is not present for the current CU, the MMVD merge flag (e.g., mmvd_merge_flag[x0][y0]) can be inferred to be equal to 0 for the current CU.

In some examples, such as in VVC specification, a single context is used to signal the MMVD merge flag (e.g., mmvd_merge_flag). For example, the single context is used to code (e.g., encode and/or decode) the MMVD merge flag in a context-adaptive binary arithmetic coding (CABAC).

A syntax element mmvd_cand_flag[x0][y0] can represent the merge candidate flag. In an example, the merge candidate flag (e.g., mmvd_cand_flag[x0][y0]) specifies whether the first (0) or the second (1) candidate in the merging candidate list is used with the MVD derived from the distance index (e.g., mmvd_distance_idx[x0][y0]) and the direction index (e.g., mmvd_direction_idx[x0][y0]). The array indices x0 and y0 can specify the location (x0, y0) of the top-left luma sample of the considered coding block (e.g., the current CB) relative to the top-left luma sample of the picture (e.g., the current picture).

When the merge candidate flag (e.g., mmvd_cand_flag[x0][y0]) is not present, the merge candidate flag (e.g., mmvd_cand_flag[x0][y0]) can be inferred to be equal to 0.

A syntax element mmvd_distance_idx[x0][y0] can represent the distance index. In an example, the distance index (e.g., mmvd_distance_idx[x0][y0]) specifies the index used to derive MmvdDistance[x0][y0], such as specified in Table 4. The array indices x0 and y0 can specify the location (x0, y0) of the top-left luma sample of the considered coding block (e.g., the current CB) relative to the top-left luma sample of the picture (e.g., the current picture).

TABLE 4
An exemplary relationship between a MmvdDistance[ x0 ][ y0 ]
and a mmvd_distance_idx[ x0 ][ y0 ]

| mmvd_dis- | MmvdDistance[ x0 ][ y0 ] | |
|---|---|---|
| tance_idx[ | slice_fpel_mmvd_en- | slice_fpel_mmvd_en- |
| x0 ][ y0 ] | abled_flag = = 0 | abled_flag = = 1 |
| 0 | 1 | 4 |
| 1 | 2 | 8 |
| 2 | 4 | 16 |
| 3 | 8 | 32 |
| 4 | 16 | 64 |
| 5 | 32 | 128 |
| 6 | 64 | 256 |
| 7 | 128 | 512 |

The first column in Table 4 indicates the distance index (e.g., mmvd_distance_idx[x0][y0]). The second column in Table 4 indicates the motion magnitude (e.g., the MmvdDistance[x0][y0]) when the full-pel MMVD is off, for example, the full-pel MMVD flag (e.g., slice_fpel_mmvd_enabled_flag) is equal to 0. The third column in Table 4 indicates the motion magnitude (e.g., the MmvdDistance[x0][y0]) when the full-pel MMVD is on, for example, the full-pel MMVD flag (e.g., slice_fpel_mmvd_enabled_flag) is equal to 1.

In an example, the units of the second column and the third column in Table 4 are ¼ luma samples. Referring to the first row of Table 4, when the distance index (e.g., mmvd_distance_idx[x0][y0]) is 0, the motion magnitude (e.g., the MmvdDistance[x0][y0]) is 1 when the full-pel MMVD is off (e.g., slice_fpel_mmvd_enabled_flag being 0). The motion magnitude (e.g., the MmvdDistance[x0][y0]) is 1×¼ luma samples or ¼ luma samples. When the distance index (e.g., mmvd_distance_idx[x0][y0]) is 0, the motion magnitude (e.g., the MmvdDistance[x0][y0]) is 4 when the full-pel MMVD is on (e.g., slice_fpel_mmvd_enabled_flag being 1). The motion magnitude (e.g., the MmvdDistance[x0][y0]) is 4×¼ luma samples or 1 luma sample.

In an example, the second column (in units of ¼ luma samples) in Table 4 corresponds to the second row (in units of a luma sample) in Table 1, and the third column (in units of ¼ luma samples) in Table 4 corresponds to the third row (in units of a luma sample) in Table 2.

A syntax element mmvd_direction_idx[x0][y0] can represent the direction index. In an example, the direction index (e.g., mmvd_direction_idx[x0][y0]) specifies the index used to derive the motion direction (e.g., MmvdSign[x0][y0]) as specified in Table 5. The array indices x0 and y0 specify the location (x0, y0) of the top-left luma sample of the considered coding block (e.g., the current CB) relative to the top-left luma sample of the picture (e.g., the current picture). The first column in Table 4 indicates the direction index (e.g., mmvd_distance_idx[x0][y0]). The second column in Table 5 indicates a first sign (e.g., MmvdSign[x0][y0][0]) of a first component (e.g., MVDₓ or MmvdOffset[x0][y0][0]) of the MVD. The third column in Table 5 indicates a second sign (e.g., MmvdSign[x0][y0][1]) of a second component (e.g., MVD_{y} or MmvdOffset[x0][y0][1]) of the MVD.

TABLE 5
An exemplary relationship between
MmvdSign[ x0 ][ y0 ] and
mmvd_direction_idx[ x0 ][ y0 ]

| mmvd_direc- | | |
|---|---|---|
| tion_idx[ x0 ][ y0 ] | MmvdSign[ x0 ][ y0 ][0] | MmvdSign[ x0 ][ y0 ][1] |
| 0 | +1 | 0 |
| 1 | −1 | 0 |
| 2 | 0 | +1 |
| 3 | 0 | −1 |

The first component (e.g., MmvdOffset[x0][y0][0]) and the second component (e.g., MmvdOffset[x0][y0][1]) of the MVD or the offset MmvdOffset[x0][y0] can be derived as follows:

MmvdOffset[x0][y0][0]=(MmvdDistance[x0][y0]<<2)×MmvdSign[x0][y0][0] (Eq. 14)

MmvdOffset[x0][y0][1]=(MmvdDistance[x0][y0]<<2)×MmvdSign[x0][y0][1] (Eq. 15)

In an example, the distance index (e.g., mmvd_distance_idx[x0][y0]) is 3, and the direction index (e.g., mmvd_distance_idx[x0][y0]) is 2. Based on Table 5 and the direction index (e.g., mmvd_direction_idx[x0][y0]) being 2, the first sign (e.g., MmvdSign[x0][y0][0]) of the first component (e.g., MVDₓ or MmvdOffset[x0][y0][0]) of the MVD is 0, and the second sign (e.g., MmvdSign[x0][y0][1]) of the second component (e.g., MVD_{y} or MmvdOffset[x0][y0][1]) of the MVD is “+1”. In this example, the MVD is along the positive vertical direction (+y) and has no horizontal component.

When the full-pel MMVD flag (e.g., slice_fpel_mmvd_enabled_flag) is equal to 0 and the full-pel MMVD is off, based on Table 4 and the distance index (e.g., mmvd_distance_idx[x0][y0]) being 3, the motion magnitude indicated by MmvdDistance[x0][y0] is 8. Based on Eqs. 10-11, the first component (e.g., MmvdOffset[x0][y0][0]) of the MVD is (8<<2)×0=0, and the second component (e.g., MmvdOffset[x0][y0][1]) of the MVD is (8<<2)×(+1)=2 (luma samples).

When the full-pel MMVD flag (e.g., slice_fpel_mmvd_enabled_flag) is equal to 1 and the full-pel MMVD is on, based on Table 4 and the distance index (e.g., mmvd_distance_idx[x0][y0]) being 3, the motion magnitude indicated by MmvdDistance[x0][y0] is 32. Based on (Eq. 35) and (Eq. 36), the first component (e.g., MmvdOffset[x0][y0][0]) of the MVD is (32<<2)×0=0, and the second component (e.g., MmvdOffset[x0][y0][1]) of the MVD is (32<<2)×(+1)=8 (luma samples).

According to an aspect of the disclosure, affine merge with motion vector difference (affine MMVD) can be used in video coding. The affine MMVD selects an available affine merge candidate from the sub-block based merge list as a base predictor. The affine MMVD applies a motion vector offset to each control point's motion vector value from the base predictor. In an example, when no affine merge candidate is available, the affine MMVD will not be used. In some examples, a distance index and an offset direction index can be subsequently signaled.

In some examples, the distance index is signaled to indicate which distance offset to use from an offset table, such as shown in Table 6:

TABLE 6
An Example of Offset Table

| Distance IDX | 0 | 1 | 2 | 3 | 4 |
|---|---|---|---|---|---|
| Distance-offset | ½-pel | 1-pel | 2-pel | 4-pel | 8-pel |

In some examples, the direction index can represent four directions as shown in Table 7, where only x or y direction may have an MV difference, but not in both directions.

TABLE 7
An Example Of Direction Table

| Offset Direction IDX | 00 | 01 | 10 | 11 |
|---|---|---|---|---|
| x-dir-factor | +1 | −1 | 0 | 0 |
| y-dir-factor | 0 | 0 | +1 | −1 |

In some examples, the inter prediction is Uni-prediction, the signaled distance offset is applied on the offset direction for each control point predictor to generate the results that include the MV value of each control point.

In some examples, the inter prediction is bi-prediction, the signaled distance offset can be applied on the signaled offset direction for control point predictor's L0 motion vector, and the offset to be applied on L1 MV can be applied on a mirrored or a scaled basis as in following specified example.

In a specific example, the inter prediction is bi-prediction, the signaled distance offset is applied on the signaled offset direction for control point predictor's L0 motion vector. For L1 CPMV, the offset is applied on a mirrored basis, which means the same amount of distance offset with the opposite direction is applied.

In another specific example, a POC distance based offset mirroring method is used for Bi-prediction. When the base candidate is bi-predicted, the offset applied to L0 is as signaled, and the offset on L1 depends on the temporal position of the reference pictures on the list L0 and list L1. For example, when both reference pictures are on the same temporal side of the current picture, the same distance offset and same offset directions are applied for CPMVs of both L0 and L1. In another example, when the two reference pictures are on different sides of the current picture, the CPMVs of L1 can have the distance offset applied on the opposite offset direction.

In another specific example, a POC distance based offset scaling method is used for Bi-prediction. When the base candidate is bi-predicted, the offset applied to L0 is as signaled, and the offset on L1 can be scaled based on the temporal distance of reference pictures on list 0 and list 1.

In some examples, the distance offset value range is extended. For example, 3 sets of distance offset values can be provided, and a set of distance offset values can be adaptively selected based on the picture resolution. In one example, the offset table is selected based on picture resolution. Table 8 shows an example of an extended distance offset table that includes 3 sets of distance offset values respectively associated with different picture resolutions. A set of distance offset values can be selected based on the picture resolution.

TABLE 8
An Example of Extended Distance-offset Table

| Distance IDX | 0 | 1 | 2 | 3 | 4 | Condition |
|---|---|---|---|---|---|---|
| Distance- | 1/2-pel | 1-pel | 2-pel | 4-pel | 8-pel | Picture Height >= 1080 |
| offset 1 | | | | | | |
| Distance- | 1/8-pel | 1/4-pel | 1/2-pel | 1-pel | 2-pel | 720 <= Picture Height < 1080 |
| offset 2 | | | | | | |
| Distance- | 1/16-pel | 1/8-pel | 1/4-pel | 1/2-pel | 1-pel | Picture Height < 720 |
| offset 3 | | | | | | |

In some examples, diversity reordering is applied based on template matching cost. Diversity reordering can increase diversity, and improve index coding efficiency. In some examples, to create diversity inside a merge candidate list, candidates that are too redundant in the rate-distortion (RD) sense are detected. In an example, a candidate is considered as redundant if the template matching cost difference between a candidate and its predecessor is inferior to a lambda value such as expressed by |D1−D2|<λ, where D1 and D2 are the template matching costs obtained during the first ARMC ordering and λ is the Lagrangian parameter used in the RD criterion at encoder side.

In some examples, an algorithm for diversity reordering can be executed. The algorithm can determine the minimum template matching cost difference between each candidate and its predecessor among all candidates in the merge candidate list. When the minimum template matching cost difference is superior or equal to λ, the merge candidate list is considered diverse enough and the reordering stops. When the minimum template matching cost difference is inferior to λ, a candidate that has the minimum template matching cost difference is considered as redundant and the candidate is moved at a further position in the merge candidate list. The further position is the first position where the candidate is diverse enough compared to its predecessor.

The algorithm can stop after a finite number of iterations (if the minimum cost difference is not inferior to λ).

In some examples, the algorithm is applied to the various merge modes, such as the regular merge mode, merge with template matching mode, merge with bilateral matching mode, affine merge mode and the like in ECM-5.0. In some examples, a similar algorithm is applied to the merge MMVD and sign MVD prediction methods which also use ARMC for the reordering.

In some examples, the value of λ is set equal to the λ of the rate distortion criterion used to select the best merge candidate at the encoder side for low delay configuration and to the value λ corresponding to a QP for random access configuration. In some examples, a set of λ values corresponding to each signaled QP offset is provided in the SPS or in the slice header for the QP offsets which are not present in the SPS.

In some examples, MVD sign prediction techniques are used. In an example, possible MVD sign combinations (e.g., various combinations of signs in x direction and y direction) are sorted according to the template matching costs of the possible MVD sign combinations and an index corresponding to the true MVD sign combination is derived and context coded. According to the MVD sign prediction techniques, the true MVD sign combination has a high possibility in a front portion of the sorted order. Thus, suitable signaling techniques can be used to signaling the index with low signaling cost.

In an example, at decoder side, the true MVD sign can be derived. For example, the magnitude of MVD components can be parsed, and a context-coded MVD sign prediction index is parsed from the bitstream carrying the video. Further, MV candidates can be formed by creating combinations from possible MVD sign combinations and magnitude of the MVD components and the MV candidates can be added to an MV predictor list. Template matching costs for the MV candidates in the MV predictor list can be calculated. The MV candidates in the MV predictor list can be sorted according to the template matching costs. Then, context-coded MVD sign prediction index is used to pick the true MVD sign combination from the MV predictor list. The MVD sign prediction techniques can be applied to various modes involving MVD, such as inter AMVP, affine AMVP, MMVD and affine MMVD modes.

In some examples, techniques referred to as history-parameter-based affine model inheritance can be used. Specifically, in some examples, a first history-parameter table (HPT) and a second HPT are established.

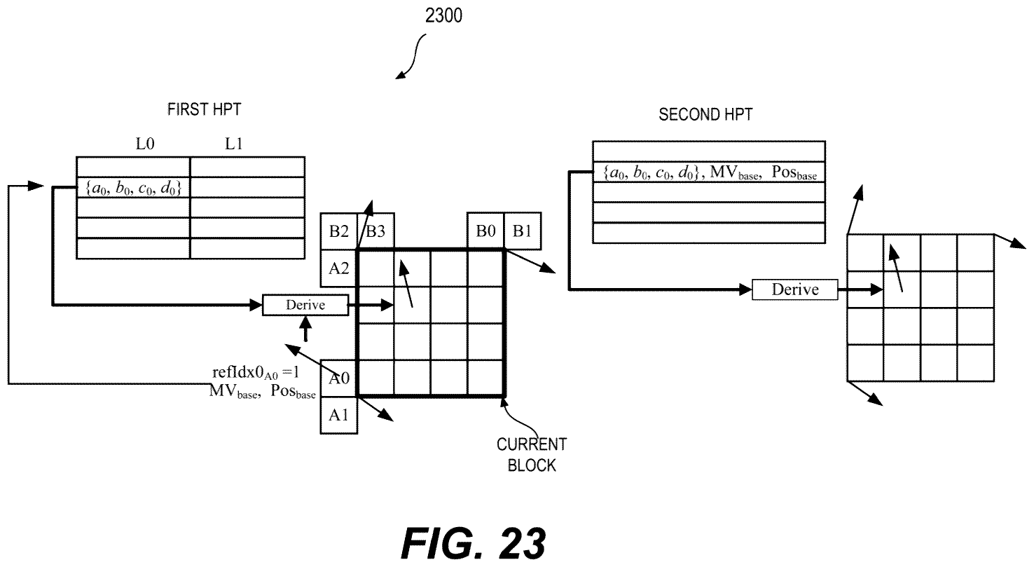

FIG. 23 shows a diagram (2300) illustrating a first HPT and a second HPT in some examples.

As shown in FIG. 23, an entry of the first HPT stores a set of affine parameters for an affine model, such as a, b, c and d, each of affine parameters is represented by a 16-bit signed integer. Entries in first HPT is categorized by reference list (e.g., reference picture list L0 or reference picture list L1) and reference index. Five reference indices are supported for each reference list in the first HPT. In a formular way, in an example, the category of the first HPT (denoted as HPTCat) is calculated as Eq. (16):

HPTCat (RefList, RefIdx)=5×RefList+min (RefIdx, 4) Eq. (16)

wherein RefList represents a reference picture list (0 or 1), and RefIdx represents a reference index.

For each category, at most seven entries can be stored, resulting in 70 entries totally in the first HPT. At the beginning of each CTU row, the number of entries for each category is initialized as zero. After decoding an affine-coded CU with reference list RefList_{cur} and RefIdx_{cur}, the affine parameters are utilized to update entries in the category HPTCat(RefList_{cur}, RefIdx_{cur}) in a way similar to HMVP table updating.

In some examples, a history-affine-parameter-based candidate (HAPC) is derived from one of the seven neighbouring 4×4 blocks denoted as A0, A1, A2, B0, B1, B2 or B3 in FIG. 23 and a set of affine parameters stored in a corresponding entry in the first HPT. The MV of a neighbouring 4×4 block served as the base MV. In a formulating way, the MV of the current block at position (x, y) is calculated as Eq. (17):

$$\{ \begin{matrix}{mv}^{h} ( x , y ) = a ( x - {x}_{base} ) + c ( y - {y}_{base} ) + {mv}_{base}^{h} \\ {mv}^{v} ( x , y ) = b ( x - {x}_{base} ) + d ( y - {y}_{base} ) + {mv}_{base}^{v}\end{matrix} , \qquad Eq . ( 17 )$$

where (mv^{h}_{base}, mv^{v}_{base}) represents the MV of the neighboring 4×4 block, (x_{base}, y_{base}) represents the center position of the neighboring 4×4 block. (x, y) can be the top-left, top-right and bottom-left corner of the current block to obtain the corner-position MVs (CPMVs) for the current block, or (x, y) can be the center of the current block to obtain a regular MV for the current block.

The second history-parameter table (HPT) with base MV information is also appended. The second HPT can include nine entries, and an entry can include a base MV, a reference index and four affine parameters for each reference list, and a base position. In an example, an additional merge HAPC can be generated from the base MV information and the corresponding affine model (e.g., the affine parameters) stored in an entry of the second HPT.

Further, in some examples, pair-wised affine merge candidates are generated by two affine merge candidates which are history-derived or not history-derived. In an example, a pair-wised affine merge candidates is generated by averaging the CPMVs of existing affine merge candidates in a candidate list.

In some examples, as a response to new HAPCs being introduced, the size of sub-block-based merge candidate list is increased from 5 to 15, which can all be involved in the ARMC process.

In the above description, the HPTs (e.g., the first HPT and the second HPT) are updated online. Besides the HPT updated one line, HPTs stored in the CTU above/above-right to the current CTU can be used by blocks in the current CTU in some examples. After coding/decoding a CTU, the HPTs may be stored in the line buffer for the usage in the next CTU row.

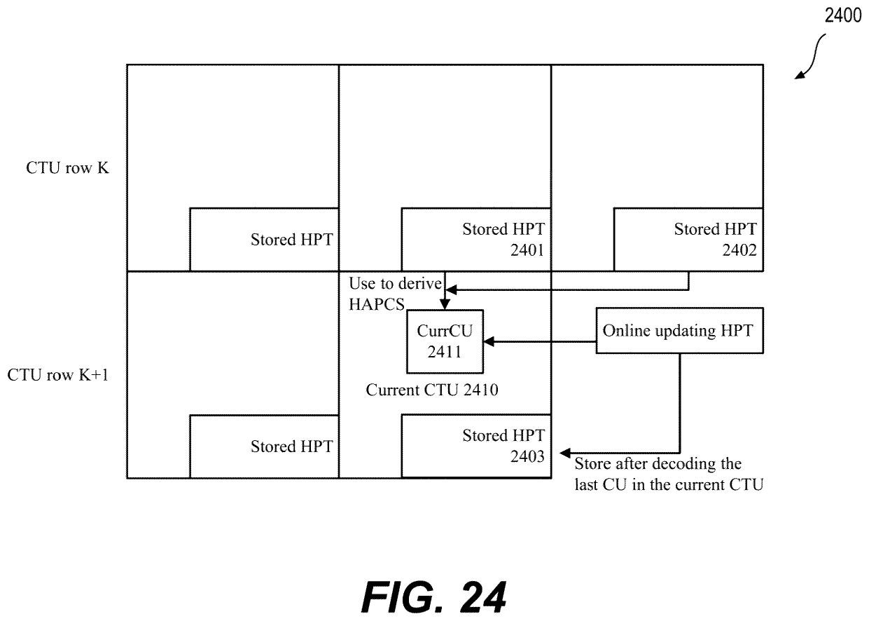

FIG. 24 shows a diagram illustrating history parameter tables stored in line buffer in some examples. In FIG. 24, a picture (2400) is partitioned into CTUs. FIG. 24 shows a CTU row k and a CTU row k+1. The current CTU (2410) is in the CTU row k+1. For the coding of a current block (2411), HPTs (2401) stored in the CTU above the current CTU (2410), and the HPTs (2402) stored in the CTU above-right to the current CTU (2410) can be used by blocks in the current CTU in some examples. The HPTs (e.g., the first HPT and the second HPT) are updated online, and are stored in the line buffer of the current CTU (2410) after the decoding of the last coding block in the current CTU.

According to an aspect of the disclosure, non-adjacent spatial neighbors can be used for affine mode.

In the affine mode with non-adjacent spatial neighbors (NA-AFF), the non-adjacent spatial neighbors can be obtained.

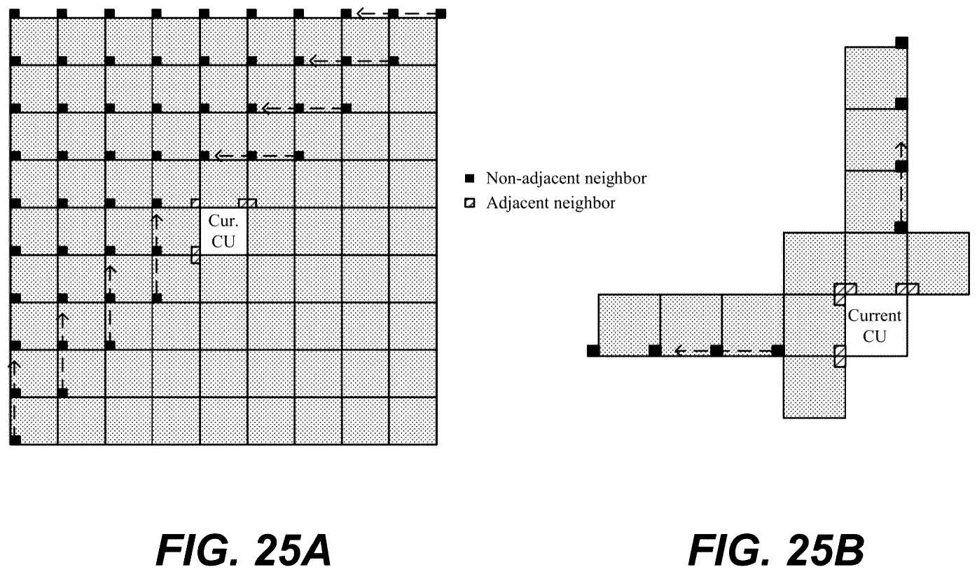

FIGS. 25A-25B show patterns of obtained non-adjacent spatial neighbors in some examples. Same as the existing non-adjacent regular merge candidates, the distances between non-adjacent spatial neighbors and current CU in the NA-AFF are also defined based on the width and height of current CU.

The motion information of the non-adjacent spatial neighbors is utilized to generate additional inherited and constructed affine merge/AMVP candidates. FIG. 25A illustrates to generate additional inherited affine merge/AMVP candidates, and FIG. 25B illustrates to generate additional constructed affine merge/AMVP candidates.

Specifically, as shown by FIG. 25A, for inherited candidates, the same derivation process of the inherited affine merge/AMVP candidates in the VVC is kept unchanged except that the CPMVs are inherited from non-adjacent spatial neighbors. The non-adjacent spatial neighbors are checked based on their distances to the current block, i.e., from near to far. At a specific distance, only the first available neighbor (that is coded with the affine mode) from each side (e.g., the left and above) of the current block is included for inherited candidate derivation. As indicated by the dash arrows in FIG. 25A, the checking orders of the neighbors on the left and above sides are bottom-to-up and right-to-left, respectively.

For the first type of constructed candidates, as shown by FIG. 25B, the positions of one left and above non-adjacent spatial neighbors are firstly determined independently. After that, the location of the top-left neighbor can be determined accordingly which can enclose a rectangular virtual block together with the left and above non-adjacent neighbors.

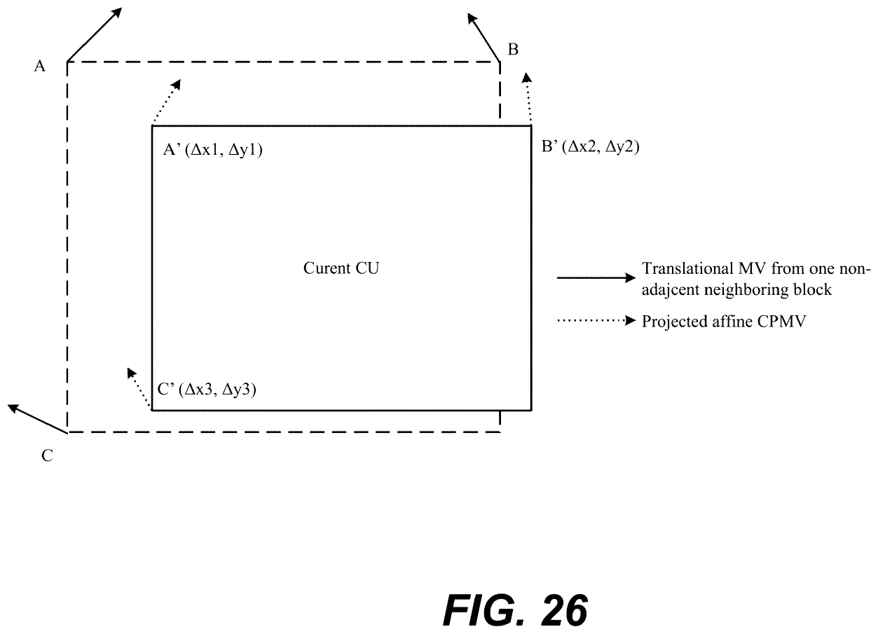

Then, as shown in the FIG. 26, the motion information of the three non-adjacent neighbors is used to form the CPMVs at the top-left (A), top-right (B) and bottom-left (C) of the virtual block, which is then projected to the current CU to generate the corresponding constructed candidates.

In some examples, for the second type of constructed candidates, the derivation process is similar as the construction scheme in history-based affine model inheritance (HAMI). However, instead of using history-based look-up table, the non-translational affine parameters are inherited from the non-adjacent spatial neighbors. Specifically, the second type of affine constructed candidates are generated from the combination of 1) the translational affine parameters of adjacent neighboring 4x4 blocks; and 2) the non-translational affine parameters inherited from the non-adjacent spatial neighbors as defined in FIG. 25A.

In some examples, the NA-AFF candidates are inserted into the existing affine merge candidate list and affine AMVP candidate list according to certain orders.

In an example, in the affine merge mode, the order includes: 1. SbTMVP candidate, if available; 2. inherited from adjacent neighbors; 3. inherited from non-adjacent neighbors; 4. constructed from adjacent neighbors; 5. the second type of constructed affine candidates from non-adjacent neighbors; 6. the first type of constructed affine candidates from non-adjacent neighbors; 7. zero MVs.

In another example, in the affine AMVP mode, the order includes: 1. inherited from adjacent neighbors; 2. constructed from adjacent neighbors; 3. translational MVs from adjacent neighbors; 4. translational MVs from temporal neighbors; 5. inherited from non-adjacent neighbors; 6. the first type of constructed affine candidates from non-adjacent neighbors; 7. zero MVs.

Due to the inclusion of the additional candidates generated by NA-AFF, the size of the affine merge candidate list is increased from 5 to 15. The subgroup size of ARMC for the affine merge mode is increased from 3 to 15.

In some video codecs (e.g., ECM-5.0 software), NA-AFF is implemented without adding constraints for memory usage.

In some examples (e.g., VVC), a geometric partitioning mode (GPM) is supported for inter prediction. The geometric partitioning mode is signalled using a CU-level flag as one kind of merge mode with other merge modes, such as the regular merge mode, the MMVD mode, the CIIP mode, the subblock merge mode, and the like. In some examples, a total of 64 partitions are supported by geometric partitioning mode for each possible CU size w×h=2^{m}×2ⁿ with m, n∈{3 . . . 6} excluding 8×64 and 64×8.

In some examples, when the geometric partitioning mode is used, a CU is split into two parts by a geometrically located straight line that is also referred to as a splitting line. The location of the splitting line can be mathematically derived based on the angle and offset parameters of a specific partition. Each part of the two geometric partitions by the splitting line in the CU is inter-predicted using its own motion; only uni-prediction is allowed for each partition. Thus, each part has one motion vector and one reference index. The uni-prediction motion constraint is applied to ensure that the a CU in GPM mode is able to be coded as the conventional bi-prediction, for example, two motion compensated predictions are performed for each CU. In some examples, when geometric partitioning mode is used for the current CU, then a geometric partition index indicating the partition mode of the geometric partition (e.g., indicating angle and offset), and two merge indices (one for each partition) are further signalled.

A template matching (TM) technique is a decoder-side MV derivation technique to refine the motion information of the current CU by finding the closest match between a template (i.e., top and/or left neighboring blocks of the current CU) in the current picture and a block (i.e., same size to the template) in a reference picture.

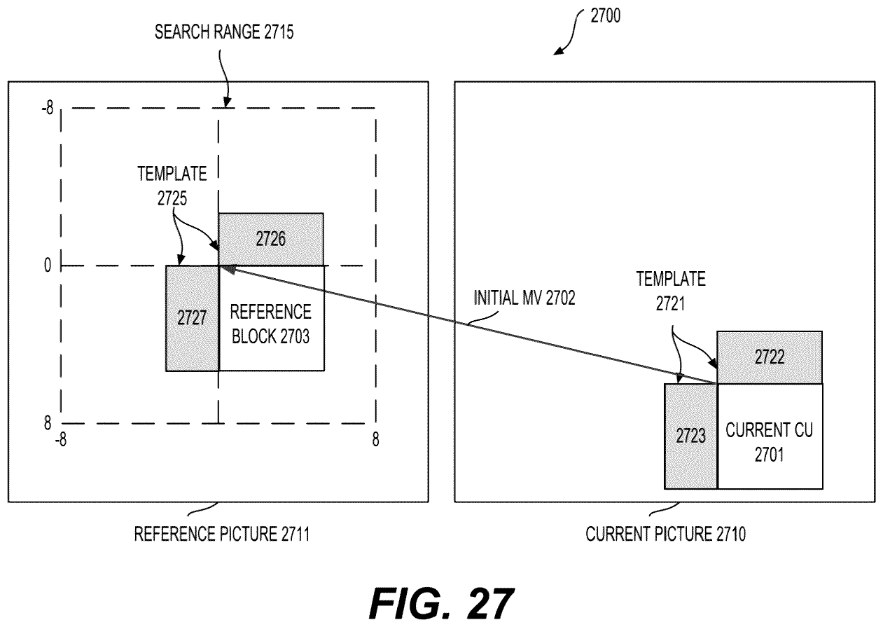

FIG. 27 shows an example of template matching (2700). The TM can be used to derive motion information (e.g., deriving final motion information from initial motion information, such as an initial MV 2702) of a current CU (e.g., a current block) (2701) by determining the closest match between a template (e.g., a current template) (2721) of the current CU (2701) in a current picture (2710) and a template (e.g., a reference template) of a plurality of possible templates (e.g., one of the plurality of possible templates being a template (2725)) in a reference picture (2711). The template (2721) of the current CU (2701) can have any suitable shape and any suitable size.

In an embodiment, the template (2721) of the current CU (2701) includes a top template (2722) and a left template (2723). Each of the top template (2722) and the left template (2723) can have any suitable shape and any suitable size.

The top template (2722) can include samples in one or more top neighboring blocks of the current CU (2701). In an example, the top template (2722) includes four rows of samples in one or more top neighboring blocks of the current CU (2701). The left template (2723) can include samples in one or more left neighboring blocks of the current CU (2701). In an example, the left template (2723) includes four columns of samples in the one or more left neighboring blocks of the current CU (2701).

Each one (e.g., the template (2725)) of the plurality of possible templates in the reference picture (2711) corresponds to the template (2721) in the current picture (2710). In an embodiment, the initial MV (2702) points from the current CU (2701) to a reference block (2703) in the reference picture (2711). Each one (e.g., the template (2725)) of the plurality of possible templates in the reference picture (2711) and the template (2721) in the current picture (2710) can have an identical shape and an identical size. For example, the template (2725) of the reference block (2703) includes a top template (2726) in the reference picture (2711) and a left template (2727) in the reference picture (2711). The top template (2726) can include samples in one or more top neighboring blocks of the reference block (2703). The left template (2727) can include samples in one or more left neighboring blocks of the reference block (2703).

A TM cost can be determined based on a pair of templates, such as the template (e.g., the current template) (2721) and the template (e.g., the reference template) (2725). The TM cost can indicate matching between the template (2721) and the template (2725). An optimized MV (or a final MV) can be determined based on a search around the initial MV (2702) of the current CU (2701) within a search range (2715). The search range (2715) can have any suitable shape and any suitable number of reference samples. In an example, the search range (2715) in the reference picture (2711) includes a [−L, L]-pel range where L is a positive integer, such as 8 (e.g., 8 samples). For example, a difference (e.g., [0, 1]) is determined based on the search range (2715), and an intermediate MV is determined by a summation of the initial MV (2702) and the difference (e.g., [0, 1]). An intermediate reference block and a corresponding template in the reference picture (2711) can be determined based on the intermediate MV. A TM cost can be determined based on the template (2721) and the intermediate template in the reference picture (2711). The TM costs can correspond to the differences (e.g., [0, 0] corresponding to the initial MV (2702), [0, 1], and the like) that are determined based on the search range (2715). In an example, the difference corresponding to the smallest TM cost is selected, and the optimized MV is the summation of the difference corresponding to the smallest TM cost and the initial MV (2702). As described above, the TM can derive the final motion information (e.g., the optimized MV) from the initial motion information (e.g., the initial MV 2702).

In the FIG. 27 example, a better MV can be searched around the initial motion vector of the current CU within a search range, such as [−8 pel, +8 pel].

In some examples, the search step size in template matching is determined based on AMVR mode and TM can be cascaded with bilateral matching process in merge modes.

In some examples, in AMVP mode, an MVP candidate is determined based on template matching error to select the one which reaches the minimum difference between the current block template and the reference block template, and then TM is performed only for this particular MVP candidate for MV refinement. For example, TM refines this MVP candidate, starting from full-pel MVD precision (or 4-pel for 4-pel AMVR mode) within a [−8, +8]-pel search range by using iterative diamond search. The AMVP candidate can be further refined by using cross search with full-pel MVD precision (or 4-pel for 4-pel AMVR mode), followed sequentially by half-pel and quarter-pel ones depending on AMVR mode as specified in Table 9. This search process ensures that the MVP candidate keeps the same MV precision as indicated by the AMVR mode after TM process. In the search process, if the difference between the previous minimum cost and the current minimum cost in the iteration is less than a threshold that is equal to the area of the block, the search process terminates.

TABLE 9
Search patterns of AMVR and merge mode with AMVR.

| Search | AMVR mode | | | | Merge mode | |
|---|---|---|---|---|---|---|
| pattern | 4-pel | Full-pel | Half-pel | Quarter-pel | AltIF = 0 | AltIF = 1 |
| 4-pel | V | | | | | |
| diamond | | | | | | |
| 4-pel cross | V | | | | | |
| Full-pel | | v | v | v | v | v |
| diamond | | | | | | |
| Full-pel | | v | v | v | v | v |
| cross | | | | | | |
| Half-pel | | | v | v | v | v |
| cross | | | | | | |
| Quarter- | | | | v | v | |
| pel cross | | | | | | |
| 1/8-pel | | | | | v | |
| cross | | | | | | |

In some examples, in merge mode, similar search process is applied to the merge candidate indicated by the merge index. As Table 9 shows, TM can perform all the way down to ⅛-pel MVD precision or skipping those beyond half-pel MVD precision, depending on whether the alternative interpolation filter (that is used when AMVR is of half-pel mode) is used according to merged motion information. Besides, when TM mode is enabled, template matching can work as an independent process or an extra MV refinement process between block-based and subblock-based bilateral matching (BM) methods, depending on whether BM can be enabled or not according to its enabling condition check.

According to an aspect of disclosure, template matching based candidate reordering techniques can be used to reduce signaling overhead. For example, techniques that are referred to as adaptive reordering of merge candidates with template matching (ARMC-TM) can be used.

In some examples, using ARMC-TM, the merge candidates are adaptively reordered with template matching (TM). The ARMC-TM can be applied to regular merge mode, template matching (TM) merge mode, and affine merge mode (excluding the SbTMVP candidate). For the TM merge mode, merge candidates are reordered before the refinement process.

In some examples, using ARMC-TM, after a merge candidate list is constructed, merge candidates are divided into several subgroups. In an example, the subgroup size is set to 5 for regular merge mode and TM merge mode. In another example, the subgroup size is set to 3 for affine merge mode. Merge candidates in each subgroup are reordered ascendingly according to cost values based on template matching. For simplification, merge candidates in the last but not the first subgroup are not reordered in some examples.

The template matching cost of a merge candidate is measured by the sum of

absolute differences (SAD) between samples of a template of the current block and the corresponding reference samples to the template (also referred to as reference template in an example). The template comprises a set of reconstructed samples neighboring to the current block. Reference samples of the template are located according to the motion information of the merge candidate.

When a merge candidate utilizes bi-directional prediction, the reference samples of the template of the merge candidate are also generated by bi-prediction.

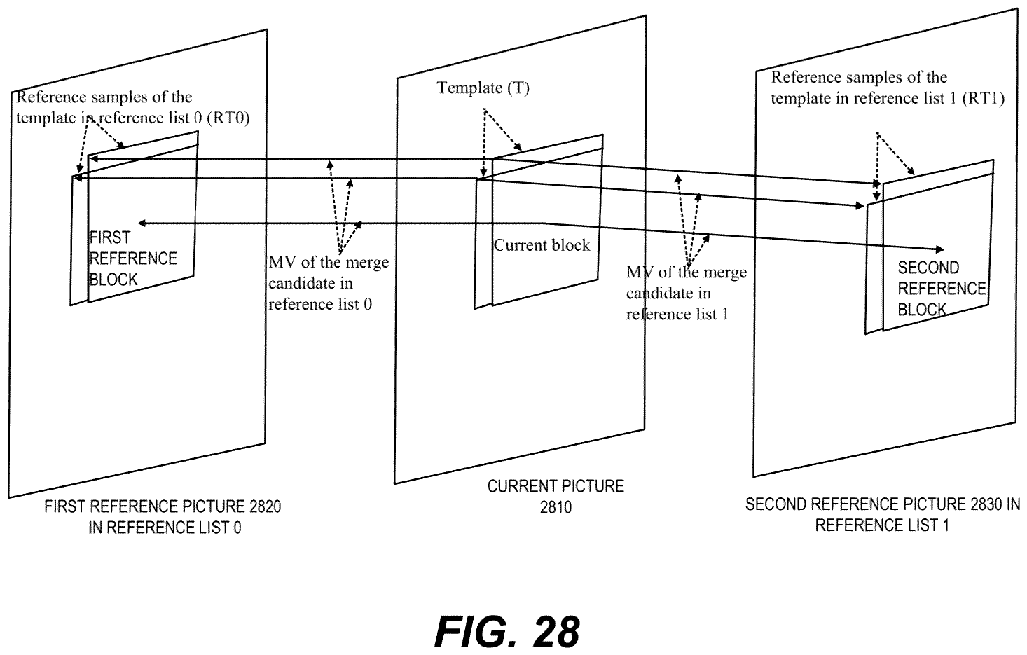

FIG. 28 shows a diagram illustrate reference samples of the template of the current block for a merge candidate of bi-prediction. In FIG. 28, the current picture (2810) includes the current block for coding. When a merge candidate is bi-prediction merge candidate, the MV of the merge candidate can point to a first reference block in a reference picture (2820), and a second reference block in a second reference picture (2830). The template of the current block is denoted by (T), and the template includes a set of reconstructed samples neighboring to the current block. A first set of reference samples of the template is in the first reference picture (2820) neighboring to the first reference block, and a second set of reference samples of the template is in the second reference picture (2830) neighboring to the second reference block. In an example, the template matching cost of the merge candidate of bi-prediction is calculated by an addition of a first sum of absolute differences (SAD) between samples of the template of the current block and the first set of reference samples of the template and a second sum of absolute differences (SAD) between samples of the template of the current block and the second set of reference samples of the template.

In some examples, the merge candidates can be subblock-based merge candidates. In an examples, for a subblock-based merge candidate with a subblock size equal to Wsub×Hsub, an above template can include several sub-templates with the size of Wsub×1, and a left template can include several sub-templates with a size of 1×Hsub. Wsub can be a width of the subblock and Hsub can be a height of the subblock.

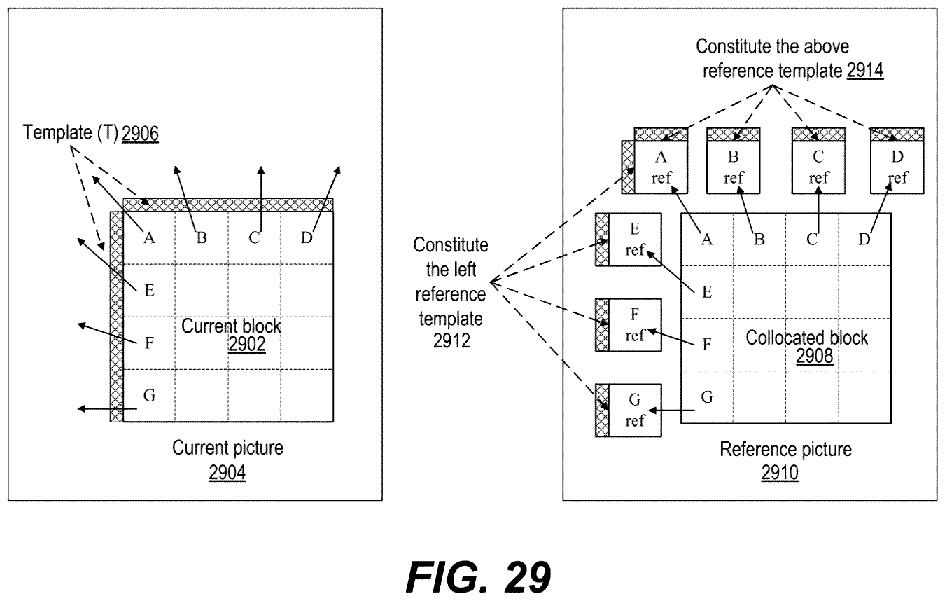

An exemplary derivation of template and reference samples of the template for the current block with a subblock-based merge candidate can be shown in FIG. 29. As shown in FIG. 29, a current block (2902) can be included in a current picture (2904). The current block (2902) can include subblocks A-G in a first row and a first column. The current block (2902) can include templates (2906) adjacent to a top side and a left side of the current block (2902). A collocated block (2908) for the current block (2902) is in a reference picture (2910). The collocated block (2908) can include subblocks A-G in a first row and a first column that correspond to the subblocks A-G in the current block (2902). Subblock motion information (e.g., corresponding to affine motion vector) of the subblocks A-G in the first row and the first column of the current block (2902) can be used to derive reference samples of sub-templates (or sub reference templates) of the collocated block (2908). For example, the motion information of the subblocks A, E, F, and G of the current block (2902) can be applied to derive the reference samples of the sub-templates that are positioned adjacent to left sides of the subblocks A, E, F, and G of the collocated block (2908). The sub-templates adjacent to the left sides of the subblocks A, E, F, and G of the collocated block (2908) can form a left reference template of the collocated block (2908). The motion information of the subblocks A, B, C, and D of the current block (2902) can be applied to derive the reference samples of the sub-templates that are positioned adjacent to top sides of the subblocks A, B, C, and D of the collocated block (2908). The sub-templates adjacent to the top sides of the subblocks A, B, C, and D of the collocated block (2908) can further form an above reference template of the collocated block (2908).

In some examples, MV candidate type based ARMC can be used. For example, merge candidates of one single candidate type, e.g., TMVP or non-adjacent MVP (NA-MVP), are reordered based on the ARMC TM cost values. The reordered candidates are then added into the merge candidate list. For example, the TMVP candidate type ARMC can add more TMVP candidates with more temporal positions and different inter prediction directions to perform the reordering and the selection. Moreover, NA-MVP candidate type ARMC extends the non-adjacent MVPs with more spatially non-adjacent positions. The target reference picture of the TMVP candidate can be selected from any one of reference pictures in the list according to a scaling factor. For example, the selected reference picture is the one whose scaling factor is the closest to 1.

According to an aspect of the disclosure, template Matching based candidate reordering can be performed on MMVD and Affine MMVD.

In some examples, MMVD offsets are extended to more positions for MMVD and affine MMVD modes.

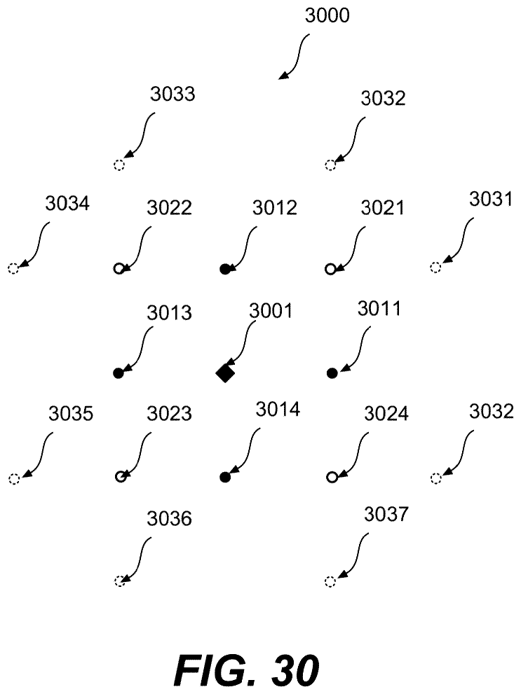

FIG. 30 shows a diagram illustrating directions in which refinement directions can be added for MMVD. In FIG. 30, additional refinement positions along k×π/8 diagonal angles are added, where k is an integer number. A position (3001) corresponds to a base candidate and can be a starting point, positions (3011)-(3014) are respectively in the directions of 0, π/2, π, and 3π/2. More directions are added. For example, positions (3021)-(3024) are respectively in the directions of π/4, 3π/4, and 5π/4, and 7π/4; and positions (3031)-(3038) are respectively in the directions of π/8, 3π/8, 5π/8, 7π/8, 9π/8, 11π/8, 13π/8, and 15π/8. Thus, the number of directions is increased from 4 to 16. Further, in an example, each direction can have 6 MMVD refinement positions. The total number of possible MMVD refinement positions is 16×6.

According to an aspect of the disclosure, SAD cost between the current template (e.g., one row above and one column left to the current block) and reference template can be calculated for each refinement position. Based on the SAD costs of the refinement positions, all the possible MMVD refinement positions (16×6) for each base candidate are reordered. Then, a top portion of the refinement positions, such as the top ⅛ refinement positions (e.g., 12), such as with the smallest template SAD costs are kept as available positions, consequently for MMVD index coding. The MMVD index is binarized by the rice code with the parameter equal to 2.

In some examples, refinement positions for affine MMVD can be increased, and template matching based candidate reordering can be applied for affine MMVD reordering. For example, affine MMVD refinement positions are in the directions along k×π/4 diagonal angles, such as in the 8 directions respectively of 0, π/4, π/2, 3π/4, π, 5π/4, 3π/2 and 7π/4. Each direction can have 6 affine MMVD refinement positions. The total number of possible affine MMVD refinement positions is 8×6. In an example, SAD cost between the current template (e.g., one row above and one column left to the current block) and reference template can be calculated for each refinement position. Based on the SAD costs of the refinement positions, all the possible affine MMVD refinement positions (8×6) for each base candidate are reordered. Then, a top portion of the refinement positions, such as the top ½ refinement positions (e.g., 24), such as with the smallest template SAD costs are kept as available positions, consequently for affine MMVD index coding.

According to an aspect of the disclosure, in some related examples, (e.g., current VVC and ECM), the inter prediction direction information (e.g., uni-prediction or bi-prediction, or L0 of uni-prediction, or L1 of uni-prediction) of merge mode is determined based on motion information from the merge candidate.

Some aspects of the disclosure provide techniques for coding the inter prediction direction and BCW index in merge mode to improve coding efficiency. For example, the inter prediction direction for merge mode can be determined (e.g., signalled), then motion vector information is signalled on top of the inter prediction direction.

According to an aspect of the disclosure, signaling of inter prediction direction, such as bi-prediction or uni-prediction, is added at coding block level for a merge mode, such as regular merge mode, merge MMVD mode, affine merge mode, affine MMVD mode, merge with TM refinement mode.

In an embodiment, a syntax of the inter prediction direction is signaled after a general merge flag. For example, after a flag that indicates a merge mode is signaled, a syntax that indicates the inter prediction direction is signal.

In another embodiment, a syntax of inter prediction direction is signaled after a merge type flag is signaled. For example, after a flag that indicates a merge type, such as sub-block based merge, a regular merge, and the like, a syntax that indicates the inter prediction direction is signal. In some examples, some merge types are associated with bi-prediction, thus the inter prediction direction can be inferred. For example, GPM mode is a bi-prediction based merge type. Thus, when the merge type is determined to be GPM, then the syntax of the inter prediction direction can be inferred to be bi-prediction.

In an embodiment, the inter prediction direction information is signaled by a single syntax. In an example, the single syntax has two possible values that indicate uni-prediction and bi-prediction, respectively. In another example, the single syntax has three possible values, such as a first possible value indicating uni-prediction of reference list L0, a second possible value indicating uni-prediction of reference list L1, and a third possible value indicating bi-prediction.

In another embodiment, the inter prediction direction information is signaled by two flags, one for each reference list, to indicate which reference list or both reference lists are used. In an example, a first flag inter_pred_idc[0] is used to indiate whehter the reference picture list L0 is involved in the inter prediction, and a second flag inter_pred_idc[1] is used to indicate whether the reference picture list L1 is involeve in the inter prediction.

In an embodiment, the signaling of inter prediction direction is used only when bi-prediction is allowed at a higher level, such as slice level, picture level, etc. In an example, when the slice type of a current slice is B slice, the bi-prediction is allowed for the current slice. For blocks in the current slice, the signaling of inter prediction direction is performed at the coding block level.

In some embodiments, when a merge candidate is signaled with bi-prediction being the inter prediction direction, BCW index is signaled explicitly. In an example, the BCW index is always be signaled explicitly for a bi-prediction merge candidate. In another example, for a bi-prediction merge candidate, a flag (e.g. signal_bcw_idx) is first signaled to indicate whether the BCW is signaled. If the flag is signaled to be true, a BCW index, selected from a set of BCW weighting candidates excluding the one inherited from the merge candidate, is subsequently signaled. In an example, when the flag is signaled to be false, the BCW index is inherited from the merge candidate.

In some examples, the BCW index values are mapped to a re-ordered list. In an example, default (equal weighting, e.g., BCW weight value is 4, and at third position in the original BCW value list, e.g., {−2, 3, 4, 5, 10}) has the lowest index value, e.g., 0; and the inherited BCW index from the merge candidate has the second lowest value, e.g., 1; and followed by remaining BCW index values in the re-ordered list. Then, an index for the re-ordered list can be signaled. In some examples, the default and the inherited BCW index have higher possibility to be used, thus coding BCW using the re-ordered list has higher coding efficiency than using the original BCW index.

In another example, to map the BCW index values to a re-ordered list, the inherited BCW index has the lowest value, e.g., 0; default (equal weighting) has the second lowest index value, e.g., 1; and remaining BCW index values can be put in the re-ordered list in later positions.

In some examples, only the default BCW index for equal weighting and inherited BCW index of a merge candidate can be used in association with the merge candidate. Thus, one flag (e.g., one bit) can be used to signal which BCW index to use. In some examples, when the inherited BCW index indicates equal weighting, a predefined unequal weighting (e.g., a second default BCW index) can be another weighting option. Then, in an example, a flag is signaled to indicate whether the inherited equal weighting is applied, or the pre-defined unequal weighting is used.

According to an aspect of the disclosure, additional merge candidates can be formed by extending existing merge candidates to more possible inter prediction directions, the additional merge candidates can be added into an extended list of candidates with existing merge candidates. In an example, the extended list of candidates can be used directly in signaling. In another example, the extended list of candidates can be reordered using TM cost based candidate reordering before signaling.

In an embodiment, for a merge candidate of bi-prediction, an extension process is performed to generate more merge candidates in bi-prediction and/or uni-prediction. After the extension process, both the original merge candidate and the extended new merge candidates are put in the extended list of candidates.

In an example, an original merge candidate of bi-prediction is extended to up to three merge candidates, including the original merge candidate, and two merge candidates of uni-prediction using the motion information from each reference picture list of the original merge candidate.

In another example, an original merge candidate of bi-prediction is extended to up to six candidates, including: the original merge candidate of bi-prediction; a bi-prediction candidate with MVs on the two reference picture lists swapped; two uni-prediction candidates generated by the motion information of each reference picture list of the original bi-prediction candidate; two uni-prediction candidates generated by the motion information of the MV swapped bi-prediction candidate.

In an example, when a bi-prediction candidate is coded by BCW, the bi-prediction candidate can be converted to a uni-prediction candidate using the motion vector and reference list associated with a weighting value greater than a pre-defined threshold.

In some embodiments, for a uni-prediction candidate, the uni-prediction candidate may be extended to two uni-prediction candidates, with the same MV but on different reference picture lists.

In some embodiments, a bi-prediction merge candidate may be extended to multiple candidates based on BCW index values. In an example, a bi-prediction candidate is extended to multiple candidates, each have the same MV values, but with different applicable BCW index values.

In another example, when a bi-prediction candidate is having a BCW index which is not corresponding to the default equal weighting, the bi-prediction candidate is extended to two candidates including the original bi-prediction candidate with the original BCW index, and an additional bi-prediction candidate with a BCW index for equal weighting.

In some embodiments, when template matching is allowed, an extended candidate list can be reordered based on template matching cost to form a reordered list. Then, an index of the reordered list is signaled in the bitstream to indicate which candidate to use. In some embodiments, when template matching is not allowed, the index of the extended candidate list is signaled directly to determine which candidate to use.

According to an aspect of disclosure, when a merge candidate is a bi-directional predictor, the inter prediction direction of the merge candidate can be determined using the template-matching during the merge candidate list construction. For example, when a merge candidate is a bi-directional predictor, the template-matching process is applied to the merge candidate to calculate the template-matching (TM) cost for reference picture list L0 only, reference picture list L1 only, and both reference picture lists L0 and L1 respectively. The inter prediction direction with the smallest cost is determined for the merge candidate. It is noted that the total number of the merge candidates in the candidate list is not changed during the merge candidate list construction.

In some examples, the determination of the inter prediction direction for a merge candidate by using the template-matching process is applied when the merge candidate is determined from the spatial or temporal neighboring blocks.

In some examples, the determination of the inter prediction direction for a merge candidate by using the template-matching process is applied when the motion vector refinement of the merge candidate is finished.

In some examples, the determination of the inter prediction direction of a merge candidate by using the template-matching process is applied for the merge candidate when the template-matching based reordering of merge candidate list construction is finished.

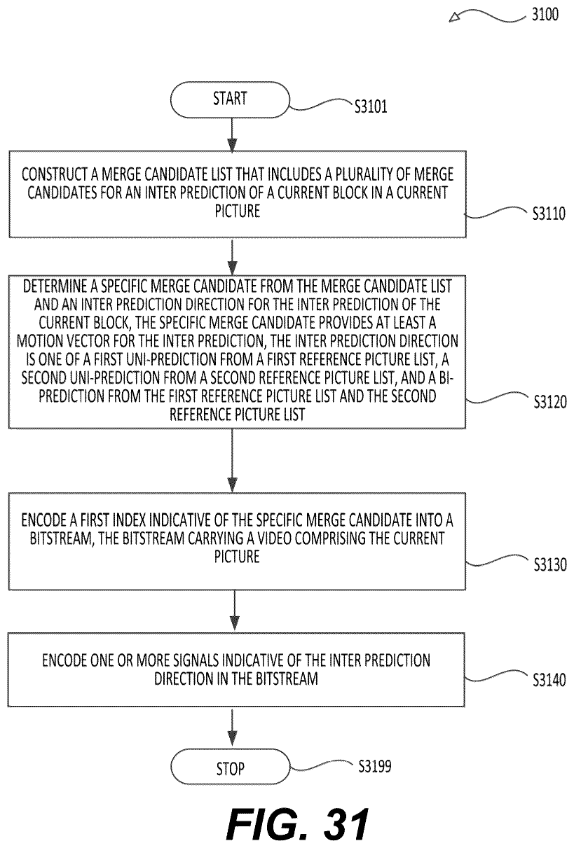

FIG. 31 shows a flow chart outlining a process (3100) according to an embodiment of the disclosure. The process (3100) can be used in a video encoder. In various embodiments, the process (3100) is executed by processing circuitry, such as the processing circuitry in the terminal devices (310), (320), (330) and (340), the processing circuitry that performs functions of the video encoder (403), the processing circuitry that performs functions of the video encoder (603), the processing circuitry that performs functions of the video encoder (703), and the like. In some embodiments, the process (3100) is implemented in software instructions, thus when the processing circuitry executes the software instructions, the processing circuitry performs the process (3100). The process starts at (S3101) and proceeds to (S3110).

At (S3110), a merge candidate list that includes a plurality of merge candidates is constructed for an inter prediction of a current block in a current picture.

At (S3120), a specific merge candidate from the merge candidate list and an inter prediction direction for the inter prediction of the current block are determined. The specific merge candidate provides at least a motion vector for the inter prediction, the inter prediction direction is selected as one of a first uni-prediction from a first reference picture list, a second uni-prediction from a second reference picture list, and a bi-prediction from the first reference picture list and the second reference picture list.

At (S3130), a first index indicative of the specific merge candidate is encoded into a bitstream (also referred to as video bitstream), the bitstream carries a video comprising the current picture.

At (S3140), one or more signals indicative of the inter prediction direction in the bitstream is encoded into the bitstream. It is noted that in some examples, (S3140) is executed before (S3130).

In some examples, the one or more signals are after a first syntax that indicates whether the current block is in a merge mode. In some examples, the one or more signals are after a second syntax that indicates a merge type for the current block.

In some examples, the one or more signals includes a syntax with a first value indicating a uni-prediction and a second value indicating the bi-prediction.

In some examples, the one or more signals includes a syntax with a first value indicating the first uni-prediction, a second value indicating the second uni-prediction, and a third value indicating the bi-prediction.

In some examples, the one or more signals includes a first flag indicating whether the first reference picture list is in the inter prediction direction, and a second flag indicating whether the second reference picture list is in the inter prediction direction.

In some examples, the inter prediction direction is the bi-prediction, and a specific weighting candidate in a weighting candidate list is determined, the weighting candidate list includes a plurality of weighting candidates (e.g., a set of BCW weights, a set of BCW indices) respectively providing weighting values for combining predictions from the first reference picture list and the second reference picture list. A second index is encoded and indicate the specific weighting candidate from the weighting candidate list.

In some examples, the weighting candidate includes at least a default equal weighting candidate (e.g., a BCW weight of 4, or a BCW index of 2) and an inherited weighting candidate associated with the specific merge candidate. In an example, the weighting candidate list includes, in an order, the default equal weighting candidate, the inherited weighting candidate from the merge candidate and other weighting candidates, thus the default equal weighting candidate corresponds to the second index being 0, and the inherited weighing candidate corresponds to the second index being 1. In another example, the weighting candidate list includes, in an order, the inherited weighting candidate from the merge candidate, the default equal weighting candidate and other weighting candidates thus the default equal weighting candidate corresponds to the second index being 1, and the inherited weighing candidate corresponds to the second index being 0.

In another example, the weighting candidate list includes only the default equal weighting candidate and the inherited weighting candidate from the merge candidate. Then, a flag is encoded, the flag indicates which one to use. In a case the inherited weighting candidate is equal weighting, a secondary default BCW index can be used as the other weighting candidate.

Then, the process proceeds to (S3199) and terminates.

The process (3100) can be suitably adapted. Step(s) in the process (3100) can be modified and/or omitted. Additional step(s) can be added. Any suitable order of implementation can be used.

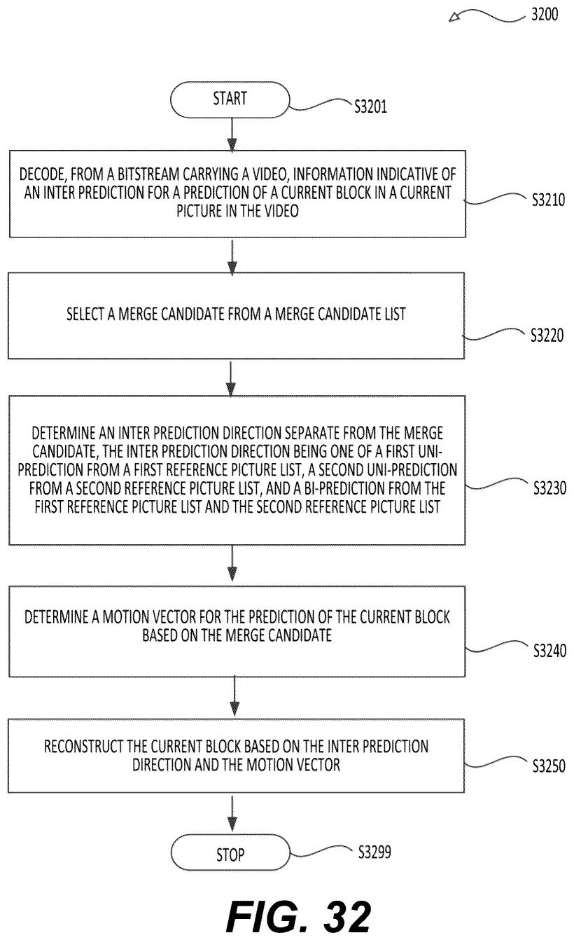

FIG. 32 shows a flow chart outlining a process (3200) according to an embodiment of the disclosure. The process (3200) can be used in a video decoder. In various embodiments, the process (3200) is executed by processing circuitry, such as the processing circuitry in the terminal devices (310), (320), (330) and (340), the processing circuitry that performs functions of the video decoder (410), the processing circuitry that performs functions of the video decoder (510), and the like. In some embodiments, the process (3200) is implemented in software instructions, thus when the processing circuitry executes the software instructions, the processing circuitry performs the process (3200). The process starts at (S3201) and proceeds to (S3210).

At (S3210), from a bitstream (also referred to as video bitstream) carrying a video, information indicative of an inter prediction for a prediction of a current block in a current picture of the video is decoded. In some examples, processing circuitry receives a video bitstream and obtains prediction information of a current block in a current picture from the video bitstream. The prediction information is indicative of whether the current block is to be predicted in an inter prediction mode.

At (S3220), a merge candidate list is constructed and a merge candidate is selected from the merge candidate list. For example, in response to the current block being predicted in the inter prediction mode, the processing circuitry determines a merge candidate from a merge candidate list.

At (S3230), an inter prediction direction is determined separately from the merge candidate, the inter prediction direction is one of a first uni-prediction from a first reference picture list, a second uni-prediction from a second reference picture list, and a bi-prediction from the first reference picture list and the second reference picture list. For example, the processing circuitry determines an inter prediction direction based on a syntax element signaled in the video bitstream. The inter prediction direction signaled separately from the merge candidate is one of a first uni-prediction from a first reference picture list, a second uni-prediction from a second reference picture list, and a bi-prediction from the first reference picture list and the second reference picture list.

At (S3240), a motion vector for the prediction of the current block is determined based on the merge candidate.

At (S3250), the current block is reconstructed based on the inter prediction direction and the motion vector.

In some embodiments, to determine the inter prediction direction, one or more signals are decoded from the bitstream, the one or more signals are indicative of the inter prediction direction. In an example, the one or more signals are after a first syntax that indicates whether the current block is in a merge mode. In another example, the one or more signals are after a second syntax that indicates a merge type for the current block.

In some examples, the inter prediction direction is inferred to be the bi-prediction in response to a merge type of the current block being based on the bi-prediction.

In an example, the one or more signals includes a syntax with a first value indicating a uni-prediction and a second value indicating the bi-prediction.

In another example, the one or more signals include a syntax with a first value indicating the first uni-prediction, a second value indicating the second uni-prediction, and a third value indicating the bi-prediction.

In another example, the one or more signals includes a first flag indicating whether the first reference picture list is in the inter prediction direction and a second flag indicating whether the second reference picture list is in the inter prediction direction.

In another example, in response to a high level syntax indicative of an allowance of bi-prediction, one or more signals are decoded from the bitstream.

In some examples, the inter prediction direction is the bi-prediction, and an index that indicates a specific weighting candidate in a weighting candidate list is decoded. The weighting candidate list includes a plurality of weighting candidates (e.g., a set of BCW weight, a set of BCW indices) respectively providing weighting values for combining predictions from the first reference picture list and the second reference picture list.

In an example, a flag is decoded, the flag indicates whether BCW is signal. When the flag is true, the index can be decoded. When the flag is false, an inherited BCW weight or BCW index from the merge candidate can be used.

In some examples, the weighting candidate includes at least a default equal weighting candidate (e.g., a BCW weight of 4, or a BCW index of 2) and an inherited weighting candidate associated with the specific merge candidate. In an example, the weighting candidate list includes, in an order, the default equal weighting candidate, the inherited weighting candidate from the merge candidate and other weighting candidates, thus the default equal weighting candidate corresponds to the second index being 0, and the inherited weighing candidate corresponds to the second index being 1. In another example, the weighting candidate list includes, in an order, the inherited weighting candidate from the merge candidate, the default equal weighting candidate and other weighting candidates thus the default equal weighting candidate corresponds to the second index being 1, and the inherited weighing candidate corresponds to the second index being 0.

In another example, the weighting candidate list includes only the default equal weighting candidate and the inherited weighting candidate from the merge candidate. Then, a flag is decoded, the flag indicates which one to use. In a case the inherited weighting candidate is equal weighting, a secondary default BCW index can be used as the other weighting candidate.

Then, the process proceeds to (S3299) and terminates.

The process (3200) can be suitably adapted. Step(s) in the process (3200) can be modified and/or omitted. Additional step(s) can be added. Any suitable order of implementation can be used.

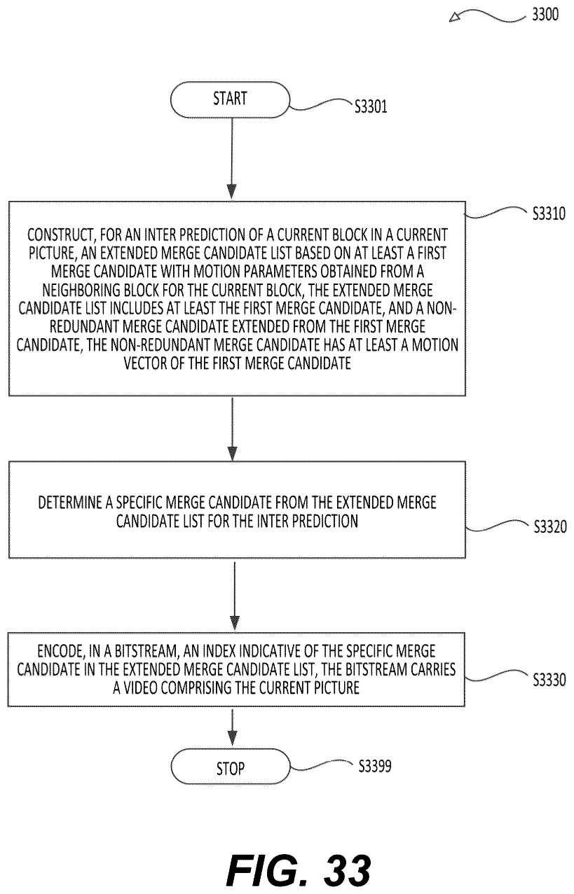

FIG. 33 shows a flow chart outlining a process (3300) according to an embodiment of the disclosure. The process (3300) can be used in a video encoder. In various embodiments, the process (3300) is executed by processing circuitry, such as the processing circuitry in the terminal devices (310), (320), (330) and (340), the processing circuitry that performs functions of the video encoder (403), the processing circuitry that performs functions of the video encoder (603), the processing circuitry that performs functions of the video encoder (703), and the like. In some embodiments, the process (3300) is implemented in software instructions, thus when the processing circuitry executes the software instructions, the processing circuitry performs the process (3300). The process starts at (S3301) and proceeds to (S3310).

At (S3310), for an inter prediction of a current block in a current picture, an extended merge candidate list is constructed based on at least a first merge candidate with motion parameters obtained from a neighboring block for the current block. The neighboring block can be a spatial neighboring block or a temporal neighboring block of the current block. The extended merge candidate list includes at least the first merge candidate, and a non-redundant merge candidate extended from the first merge candidate. The non-redundant merge candidate has at least a motion vector of the first merge candidate.

At (S3320), a specific merge candidate is determined from the extended merge candidate list for the inter prediction.

At (S3330), an index indicative of the specific merge candidate in the extended merge candidate list is encoded in a bitstream, the bitstream carries a video comprising the current picture.

In some examples, the first merge candidate is a bi-prediction candidate with a first motion vector associated with a first reference picture list and a second motion vector associated with a second reference picture list. The extended merge candidate includes the first merge candidate and at least one of a second merge candidate that is a uni-prediction candidate having the first motion vector associated with the first reference picture list and a third merge candidate that is a uni-prediction candidate having the second motion vector associated with the second reference picture list.

In some examples, the first merge candidate is a bi-prediction candidate with a first motion vector associated with a first reference picture list and a second motion vector associated with a second reference picture list. The extended merge candidate list includes the first merge candidate and at least one of a second merge candidate that is a bi-prediction candidate having the first motion vector associated with the second reference picture list and the second motion vector associated with the first reference picture list, a third merge candidate that is a uni-prediction candidate having the first motion vector associated with the first reference picture list, a fourth merge candidate that is a uni-prediction candidate having the second motion vector associated with the second reference picture list, a fifth merge candidate that is a uni-prediction candidate having the second motion vector associated with the first reference picture list, and a six merge candidate that is a uni-prediction candidate having the first motion vector associated with the second reference picture list.

In some examples, the first merge candidate is a bi-prediction candidate coded with bi-prediction with CU level weight (BCW), the first merge candidate includes a first motion vector associated with a first reference picture list and a first weight value and a second motion vector associated with a second reference picture list and a second weight value. In an example, in response to the first weight value being larger than the second weight value, the extended merge candidate list includes the first merge candidate and a second merge candidate that is a uni-prediction candidate having the first motion vector associated with the first reference picture list. In another example, in response to the first weight value being smaller than the second weight value, the extended merge candidate list includes the first merge candidate and a third merge candidate that is a uni-prediction candidate having the second motion vector associated with the second reference picture list.

In some examples, the first merge candidate is a uni-prediction candidate with a first motion vector associated with a first reference picture list. The extended merge candidate list includes the first merge candidate and a second merge candidate that is a uni-prediction candidate having the first motion vector associated with a second reference picture list.

In some examples, the first merge candidate is a bi-prediction candidate coded with a first bi-prediction with CU level weight (BCW) index value, the first merge candidate includes motion information with a first motion vector associated with a first reference picture list and a second motion vector associated with a second reference picture list. The extended merge candidate list includes the first merge candidate and one or more second merge candidates that each includes the motion information in the first merge candidate and is coded with a different BCW index value from the first BCW index value.

In some examples, the first merge candidate is a bi-prediction candidate coded with a first bi-prediction with CU level weight (BCW) index value corresponding to non equal weighting, the first merge candidate includes motion information with a first motion vector associated with a first reference picture list and a second motion vector associated with a second reference picture list. The extended merge candidate list includes the first merge candidate and a second merge candidate that comprises the motion information in the first merge candidate and is coded with a second BCW index value corresponding to equal weighting.

In some examples, merge candidates in the extended merge candidate list are reordered according to template matching costs.

Then, the process proceeds to (S3399) and terminates.

The process (3300) can be suitably adapted. Step(s) in the process (3300) can be modified and/or omitted. Additional step(s) can be added. Any suitable order of implementation can be used.

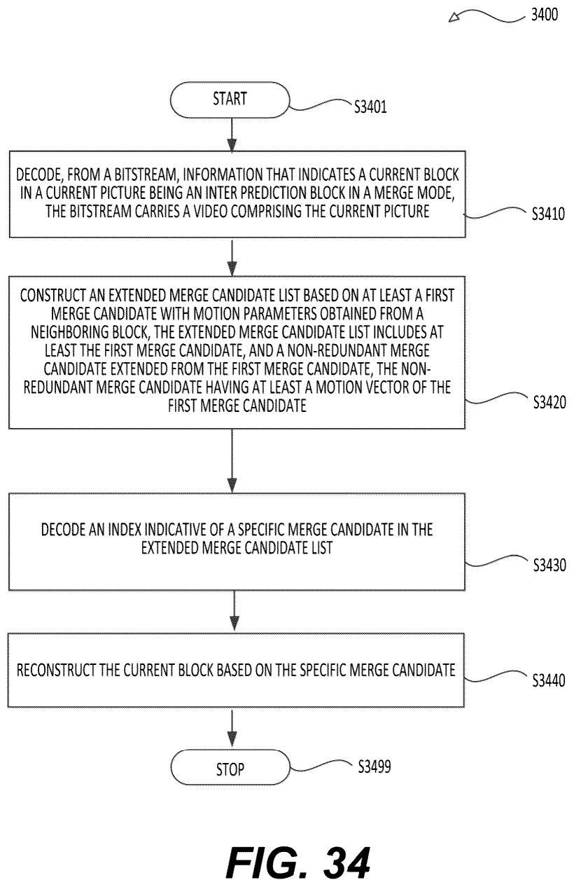

FIG. 34 shows a flow chart outlining a process (3400) according to an embodiment of the disclosure. The process (3400) can be used in a video decoder. In various embodiments, the process (3400) is executed by processing circuitry, such as the processing circuitry in the terminal devices (310), (320), (330) and (340), the processing circuitry that performs functions of the video decoder (410), the processing circuitry that performs functions of the video decoder (510), and the like. In some embodiments, the process (3400) is implemented in software instructions, thus when the processing circuitry executes the software instructions, the processing circuitry performs the process (3400). The process starts at (S3401) and proceeds to (S3410).

At (S3410), information that indicates a current block in a current picture being an inter prediction block in a merge mode is decoded from a bitstream. The bitstream carries a video comprising the current picture.

At (S3420), an extended merge candidate list is constructed based on at least a first merge candidate with motion parameters obtained from a neighboring block. The neighboring block can be a spatial neighboring block or a temporal neighboring block of the current block. The extended merge candidate list includes at least the first merge candidate, and a non-redundant merge candidate extended from the first merge candidate. The non-redundant merge candidate has at least a motion vector of the first merge candidate.

At (S3430), an index indicative of a specific merge candidate in the extended merge candidate list is decoded.

At (S3440), the current block is reconstructed based on the specific merge candidate.

In some examples, the first merge candidate is a bi-prediction candidate with a first motion vector associated with a first reference picture list and a second motion vector associated with a second reference picture list. The extended merge candidate list includes the first merge candidate and at least one of a second merge candidate that is a uni-prediction candidate having the first motion vector associated with the first reference picture list and a third merge candidate that is a uni-prediction candidate having the second motion vector associated with the second reference picture list.

In some examples, the first merge candidate is a bi-prediction candidate with a first motion vector associated with a first reference picture list and a second motion vector associated with a second reference picture list. The extended merge candidate list includes the first merge candidate and at least one of a second merge candidate that is a bi-prediction candidate having the first motion vector associated with the second reference picture list and the second motion vector associated with the first reference picture list, a third merge candidate that is a uni-prediction candidate having the first motion vector associated with the first reference picture list, a fourth merge candidate that is a uni-prediction candidate having the second motion vector associated with the second reference picture list, a fifth merge candidate that is a uni-prediction candidate having the second motion vector associated with the first reference picture list, and a six merge candidate that is a uni-prediction candidate having the first motion vector associated with the second reference picture list.

In some examples, the first merge candidate is a bi-prediction candidate coded with bi-prediction with CU level weight (BCW), the first merge candidate includes a first motion vector associated with a first reference picture list and a first weight value and a second motion vector associated with a second reference picture list and a second weight value. In response to the first weight value being larger than the second weight value, the extended merge candidate list includes the first merge candidate and a second merge candidate that is a uni-prediction candidate having the first motion vector associated with the first reference picture list. In response to the first weight value being smaller than the second weight value, the extended merge candidate list includes the first merge candidate and a third merge candidate that is a uni-prediction candidate having the second motion vector associated with the second reference picture list.

In some examples, the first merge candidate is a uni-prediction candidate with a first motion vector associated with a first reference picture list, the extended merge candidate list includes the first merge candidate and a second merge candidate that is a uni-prediction candidate having the first motion vector associated with a second reference picture list.

In some examples, the first merge candidate is a bi-prediction candidate coded with a first bi-prediction with CU level weight (BCW) index value. The first merge candidate includes motion information with a first motion vector associated with a first reference picture list and a second motion vector associated with a second reference picture list. The extended merge candidate list includes the first merge candidate and one or more second merge candidates that each includes the motion information in the first merge candidate and is coded with a different BCW index value from the first BCW index value.

In some examples, the first merge candidate is a bi-prediction candidate coded with a first bi-prediction with CU level weight (BCW) index value corresponding to non equal weighting, the first merge candidate includes motion information with a first motion vector associated with a first reference picture list and a second motion vector associated with a second reference picture list. The extended merge candidate list includes the first merge candidate and a second merge candidate that comprises the motion information in the first merge candidate and is coded with a second BCW index value corresponding to equal weighting.

In some examples, merge candidates in the extended merge candidate list are reordered according to template matching costs.

Then, the process proceeds to (S3499) and terminates.

The process (3400) can be suitably adapted. Step(s) in the process (3400) can be modified and/or omitted. Additional step(s) can be added. Any suitable order of implementation can be used.

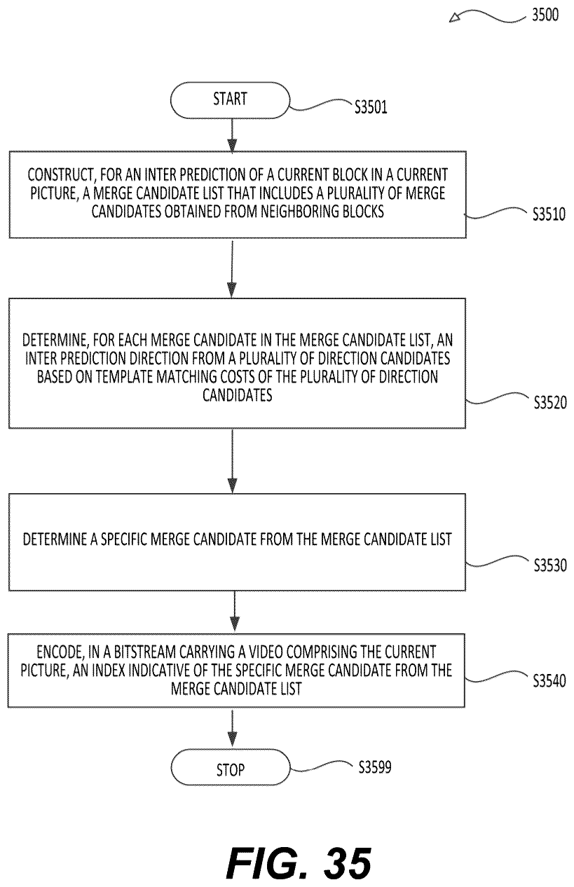

FIG. 35 shows a flow chart outlining a process (3500) according to an embodiment of the disclosure. The process (3500) can be used in a video encoder. In various embodiments, the process (3500) is executed by processing circuitry, such as the processing circuitry in the terminal devices (310), (320), (330) and (340), the processing circuitry that performs functions of the video encoder (403), the processing circuitry that performs functions of the video encoder (603), the processing circuitry that performs functions of the video encoder (703), and the like. In some embodiments, the process (3500) is implemented in software instructions, thus when the processing circuitry executes the software instructions, the processing circuitry performs the process (3500). The process starts at (S3501) and proceeds to (S3510).

At (S3510), for an inter prediction of a current block in a current picture, a merge candidate list that includes a plurality of merge candidates obtained from neighboring blocks is constructed. A neighboring block can be a spatial neighboring block or a temporal neighboring block of the current block.

At (S3520), for each merge candidate in the merge candidate list, an inter prediction direction is determined from a plurality of direction candidates based on template matching costs of the plurality of direction candidates.

At (S3530), a specific merge candidate is determined from the merge candidate list.

At (S3540), an index indicative of the specific merge candidate from the merge candidate list is encoded in a bitstream carrying a video including the current picture.

In an example, the inter prediction direction is determined for the merge candidate in response to the merge candidate being obtained from a neighboring block. In another example, the inter prediction direction is determined for the merge candidate in response to a finish of a motion vector refinement on the merge candidate. In another example, the inter prediction direction is determined for the merge candidate in response to a finish of a template matching based reordering of the plurality of merge candidates.

Then, the process proceeds to (S3599) and terminates.

The process (3500) can be suitably adapted. Step(s) in the process (3500) can be modified and/or omitted. Additional step(s) can be added. Any suitable order of implementation can be used.

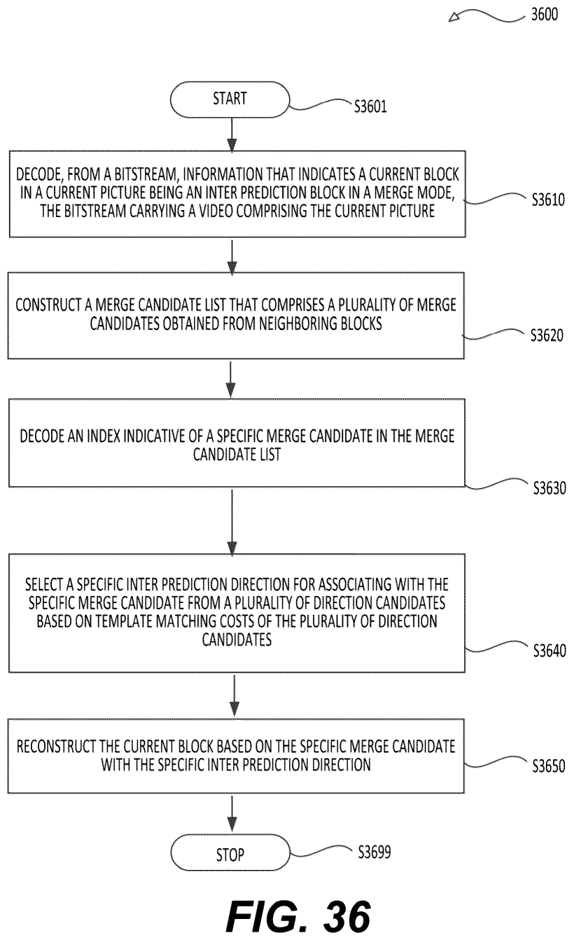

FIG. 36 shows a flow chart outlining a process (3600) according to an embodiment of the disclosure. The process (3600) can be used in a video decoder. In various embodiments, the process (3600) is executed by processing circuitry, such as the processing circuitry in the terminal devices (310), (320), (330) and (340), the processing circuitry that performs functions of the video decoder (410), the processing circuitry that performs functions of the video decoder (510), and the like. In some embodiments, the process (3600) is implemented in software instructions, thus when the processing circuitry executes the software instructions, the processing circuitry performs the process (3600). The process starts at (S3601) and proceeds to (S3610).

At (S3610), from a bitstream, information that indicates a current block in a current picture being an inter prediction block in a merge mode is decoded. The bitstream carries a video comprising the current picture.

At (S3620), a merge candidate list that includes a plurality of merge candidates obtained from neighboring blocks is constructed. A neighboring block can be a spatial neighboring block or a temporal neighboring block of the current block.

At (S3630), an index indicative of a specific merge candidate in the merge candidate list is decoded from the bitstream.

At (S3640), a specific inter prediction direction for associating with the specific merge candidate is selected from a plurality of direction candidates based on template matching costs of the plurality of direction candidates.

At (S3650), the current block is reconstructed based on the specific merge candidate with the specific inter prediction direction.

In an example, the specific inter prediction direction for the specific merge candidate is determined (selected) in response to the specific merge candidate being obtained from a neighboring block.

In another example, the specific inter prediction direction for the specific merge candidate is determined (selected) in response to a finish of a motion vector refinement on the specific merge candidate.

In another example, the specific inter prediction direction for the specific merge candidate is determined in response to a finish of a template matching based reordering of the plurality of merge candidates.

In another example, the specific inter prediction direction for the specific merge candidate is determined in response to the index being decoded.

Then, the process proceeds to (S3699) and terminates.

The process (3600) can be suitably adapted. Step(s) in the process (3600) can be modified and/or omitted. Additional step(s) can be added. Any suitable order of implementation can be used.

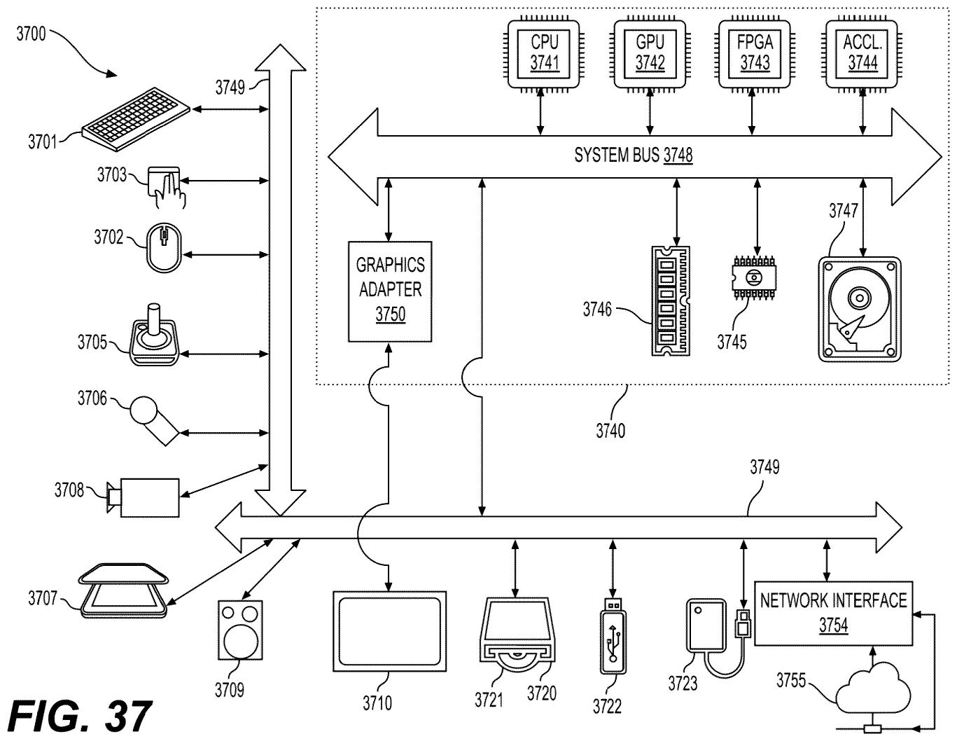

The techniques described above, can be implemented as computer software using computer-readable instructions and physically stored in one or more computer-readable media. For example, FIG. 37 shows a computer system (3700) suitable for implementing certain embodiments of the disclosed subject matter.

The computer software can be coded using any suitable machine code or computer language, that may be subject to assembly, compilation, linking, or like mechanisms to create code comprising instructions that can be executed directly, or through interpretation, micro-code execution, and the like, by one or more computer central processing units (CPUs), Graphics Processing Units (GPUs), and the like.

The instructions can be executed on various types of computers or components thereof, including, for example, personal computers, tablet computers, servers, smartphones, gaming devices, internet of things devices, and the like.

The components shown in FIG. 37 for computer system (3700) are exemplary in nature and are not intended to suggest any limitation as to the scope of use or functionality of the computer software implementing embodiments of the present disclosure. Neither should the configuration of components be interpreted as having any dependency or requirement relating to any one or combination of components illustrated in the exemplary embodiment of a computer system (3700).

Computer system (3700) may include certain human interface input devices. Such a human interface input device may be responsive to input by one or more human users through, for example, tactile input (such as: keystrokes, swipes, data glove movements), audio input (such as: voice, clapping), visual input (such as: gestures), olfactory input (not depicted). The human interface devices can also be used to capture certain media not necessarily directly related to conscious input by a human, such as audio (such as: speech, music, ambient sound), images (such as: scanned images, photographic images obtain from a still image camera), video (such as two-dimensional video, three-dimensional video including stereoscopic video).

Input human interface devices may include one or more of (only one of each depicted): keyboard (3701), mouse (3702), trackpad (3703), touch screen (3710), data-glove (not shown), joystick (3705), microphone (3706), scanner (3707), camera (3708).

Computer system (3700) may also include certain human interface output devices. Such human interface output devices may be stimulating the senses of one or more human users through, for example, tactile output, sound, light, and smell/taste. Such human interface output devices may include tactile output devices (for example tactile feedback by the touch-screen (3710), data-glove (not shown), or joystick (3705), but there can also be tactile feedback devices that do not serve as input devices), audio output devices (such as: speakers (3709), headphones (not depicted)), visual output devices (such as screens (3710) to include CRT screens, LCD screens, plasma screens, OLED screens, each with or without touch-screen input capability, each with or without tactile feedback capability—some of which may be capable to output two dimensional visual output or more than three dimensional output through means such as stereographic output; virtual-reality glasses (not depicted), holographic displays and smoke tanks (not depicted)), and printers (not depicted).

Computer system (3700) can also include human accessible storage devices and their associated media such as optical media including CD/DVD ROM/RW (3720) with CD/DVD or the like media (3721), thumb-drive (3722), removable hard drive or solid state drive (3723), legacy magnetic media such as tape and floppy disc (not depicted), specialized ROM/ASIC/PLD based devices such as security dongles (not depicted), and the like.

Those skilled in the art should also understand that term “computer readable media” as used in connection with the presently disclosed subject matter does not encompass transmission media, carrier waves, or other transitory signals.

Computer system (3700) can also include an interface (3754) to one or more communication networks (3755). Networks can for example be wireless, wireline, optical. Networks can further be local, wide-area, metropolitan, vehicular and industrial, real-time, delay-tolerant, and so on. Examples of networks include local area networks such as Ethernet, wireless LANs, cellular networks to include GSM, 3G, 4G, 5G, LTE and the like, TV wireline or wireless wide area digital networks to include cable TV, satellite TV, and terrestrial broadcast TV, vehicular and industrial to include CANBus, and so forth. Certain networks commonly require external network interface adapters that attached to certain general purpose data ports or peripheral buses (3749) (such as, for example USB ports of the computer system (3700)); others are commonly integrated into the core of the computer system (3700) by attachment to a system bus as described below (for example Ethernet interface into a PC computer system or cellular network interface into a smartphone computer system). Using any of these networks, computer system (3700) can communicate with other entities. Such communication can be uni-directional, receive only (for example, broadcast TV), uni-directional send-only (for example CANbus to certain CANbus devices), or bi-directional, for example to other computer systems using local or wide area digital networks. Certain protocols and protocol stacks can be used on each of those networks and network interfaces as described above.

Aforementioned human interface devices, human-accessible storage devices, and network interfaces can be attached to a core (3740) of the computer system (3700).

The core (3740) can include one or more Central Processing Units (CPU) (3741), Graphics Processing Units (GPU) (3742), specialized programmable processing units in the form of Field Programmable Gate Areas (FPGA) (3743), hardware accelerators for certain tasks (3744), graphics adapters (3750), and so forth. These devices, along with Read-only memory (ROM) (3745), Random-access memory (3746), internal mass storage such as internal non-user accessible hard drives, SSDs, and the like (3747), may be connected through a system bus (3748). In some computer systems, the system bus (3748) can be accessible in the form of one or more physical plugs to enable extensions by additional CPUs, GPU, and the like. The peripheral devices can be attached either directly to the core's system bus (3748), or through a peripheral bus (3749). In an example, the screen (3710) can be connected to the graphics adapter (3750). Architectures for a peripheral bus include PCI, USB, and the like.

CPUs (3741), GPUs (3742), FPGAs (3743), and accelerators (3744) can execute certain instructions that, in combination, can make up the aforementioned computer code. That computer code can be stored in ROM (3745) or RAM (3746). Transitional data can be also be stored in RAM (3746), whereas permanent data can be stored for example, in the internal mass storage (3747). Fast storage and retrieve to any of the memory devices can be enabled through the use of cache memory, that can be closely associated with one or more CPU (3741), GPU (3742), mass storage (3747), ROM (3745), RAM (3746), and the like.

The computer readable media can have computer code thereon for performing various computer-implemented operations. The media and computer code can be those specially designed and constructed for the purposes of the present disclosure, or they can be of the kind well known and available to those having skill in the computer software arts.

As an example and not by way of limitation, the computer system having architecture (3700), and specifically the core (3740) can provide functionality as a result of processor(s) (including CPUs, GPUs, FPGA, accelerators, and the like) executing software embodied in one or more tangible, computer-readable media. Such computer-readable media can be media associated with user-accessible mass storage as introduced above, as well as certain storage of the core (3740) that are of non-transitory nature, such as core-internal mass storage (3747) or ROM (3745). The software implementing various embodiments of the present disclosure can be stored in such devices and executed by core (3740). A computer-readable medium can include one or more memory devices or chips, according to particular needs. The software can cause the core (3740) and specifically the processors therein (including CPU, GPU, FPGA, and the like) to execute particular processes or particular parts of particular processes described herein, including defining data structures stored in RAM (3746) and modifying such data structures according to the processes defined by the software. In addition or as an alternative, the computer system can provide functionality as a result of logic hardwired or otherwise embodied in a circuit (for example: accelerator (3744)), which can operate in place of or together with software to execute particular processes or particular parts of particular processes described herein. Reference to software can encompass logic, and vice versa, where appropriate. Reference to a computer-readable media can encompass a circuit (such as an integrated circuit (IC)) storing software for execution, a circuit embodying logic for execution, or both, where appropriate. The present disclosure encompasses any suitable combination of hardware and software.

### APPENDIX A: ACRONYMS

JEM: joint exploration model
VVC: versatile video coding
BMS: benchmark set
MV: Motion Vector
HEVC: High Efficiency Video Coding
SEI: Supplementary Enhancement Information
VUI: Video Usability Information
GOPs: Groups of Pictures
TUs: Transform Units,
PUs: Prediction Units
CTUs: Coding Tree Units
CTBs: Coding Tree Blocks
PBs: Prediction Blocks
HRD: Hypothetical Reference Decoder
SNR: Signal Noise Ratio
CPUs: Central Processing Units
GPUs: Graphics Processing Units
CRT: Cathode Ray Tube
LCD: Liquid-Crystal Display
OLED: Organic Light-Emitting Diode
CD: Compact Disc
DVD: Digital Video Disc
ROM: Read-Only Memory
RAM: Random Access Memory
ASIC: Application-Specific Integrated Circuit
PLD: Programmable Logic Device
LAN: Local Area Network
GSM: Global System for Mobile communications
LTE: Long-Term Evolution
CANBus: Controller Area Network Bus
USB: Universal Serial Bus
PCI: Peripheral Component Interconnect
FPGA: Field Programmable Gate Areas
SSD: solid-state drive
IC: Integrated Circuit
CU: Coding Unit

While this disclosure has described several exemplary embodiments, there are alterations, permutations, and various substitute equivalents, which fall within the scope of the disclosure. It will thus be appreciated that those skilled in the art will be able to devise numerous systems and methods which, although not explicitly shown or described herein, embody the principles of the disclosure and are thus within the spirit and scope thereof.

What is claimed is:

1. A method of video processing in a decoder, comprising:
receiving a video bitstream comprising a current block in a current picture;
obtaining prediction information from the video bitstream, the prediction information indicative of whether the current block is to be predicted in an inter prediction mode;
in response to the current block being predicted in the inter prediction mode, determining a merge candidate from a merge candidate list;
determining an inter prediction direction based on a syntax element signaled in the video bitstream, the inter prediction direction, signaled separately from the merge candidate, being one of a first uni-prediction from a first reference picture list, a second uni-prediction from a second reference picture list, and a bi-prediction from the first reference picture list and the second reference picture list;
determining a motion vector for a prediction of the current block based on the merge candidate; and
reconstructing the current block based on the inter prediction direction and the motion vector.

2. The method of claim 1, wherein the determining the inter prediction direction further comprises:
decoding one or more signals from the video bitstream, the one or more signals indicative of the inter prediction direction.

3. The method of claim 1, wherein the video bitstream complies with enhanced compression model (ECM).

4. The method of claim 1, wherein the determining the inter prediction direction further comprises:
inferring that the inter prediction direction is the bi-prediction in response to a merge type of the current block being based on the bi-prediction.

5. The method of claim 2, wherein the one or more signals comprises a syntax with:
a first value indicating a uni-prediction and a second value indicating the bi-prediction.

6. The method of claim 2, wherein the one or more signals comprises a syntax with:
a first value indicating the first uni-prediction, a second value indicating the second uni-prediction, and a third value indicating the bi-prediction.

7. The method of claim 2, wherein the one or more signals comprises:
a first flag indicating whether the first reference picture list is in the inter prediction direction; and
a second flag indicating whether the second reference picture list is in the inter prediction direction.

8. The method of claim 2, wherein the decoding the one or more signals in the video bitstream further comprises:
in response to a high level syntax indicative of an allowance of bi-prediction, decoding one or more signals from the video bitstream.

9. The method of claim 1, wherein the inter prediction direction is the bi-prediction, and the method further comprises:
decoding, from the video bitstream, an index that indicates a specific weighting candidate in a weighting candidate list, the weighting candidate list comprising a plurality of weighting candidates respectively providing weighting values for combining predictions from the first reference picture list and the second reference picture list.

10. The method of claim 9, wherein the weighting candidate list comprises at least:
a default equal weighting candidate and an inherited weighting candidate from the merge candidate.

11. A method of video processing in a decoder, comprising:
receiving a video bitstream comprising a current block in a current picture;
decoding, from the video bitstream, information that indicates the current block in the current picture being an inter prediction block in a merge mode;
constructing an extended merge candidate list based on at least a first merge candidate with motion parameters obtained from a neighboring block, the extended merge candidate list comprising at least the first merge candidate, and a non-redundant merge candidate extended from the first merge candidate, the non-redundant merge candidate having at least a motion vector of the first merge candidate;
decoding an index indicative of a specific merge candidate in the extended merge candidate list; and
reconstructing the current block based on the specific merge candidate.

12. The method of claim 11, wherein the first merge candidate is a bi-prediction candidate with a first motion vector associated with a first reference picture list and a second motion vector associated with a second reference picture list, the constructing the extended merge candidate list further comprises:
constructing the extended merge candidate list that comprises the first merge candidate and at least one of:
a second merge candidate that is a uni-prediction candidate having the first motion vector associated with the first reference picture list; and
a third merge candidate that is a uni-prediction candidate having the second motion vector associated with the second reference picture list.

13. The method of claim 11, wherein the first merge candidate is a bi-prediction candidate with a first motion vector associated with a first reference picture list and a second motion vector associated with a second reference picture list, the constructing the extended merge candidate list further comprises:
constructing the extended merge candidate list that comprises the first merge candidate and at least one of:
a second merge candidate that is a bi-prediction candidate having the first motion vector associated with the second reference picture list and the second motion vector associated with the first reference picture list;
a third merge candidate that is a uni-prediction candidate having the first motion vector associated with the first reference picture list;
a fourth merge candidate that is a uni-prediction candidate having the second motion vector associated with the second reference picture list;
a fifth merge candidate that is a uni-prediction candidate having the second motion vector associated with the first reference picture list; and
a six merge candidate that is a uni-prediction candidate having the first motion vector associated with the second reference picture list.

14. The method of claim 11, wherein the first merge candidate is a bi-prediction candidate coded with bi-prediction with CU level weight (BCW), the first merge candidate comprises a first motion vector associated with a first reference picture list and a first weight value and a second motion vector associated with a second reference picture list and a second weight value, the constructing the extended merge candidate list further comprises:
constructing the extended merge candidate list that comprises the first merge candidate and:
a second merge candidate that is a uni-prediction candidate having the first motion vector associated with the first reference picture list in response to the first weight value being larger than the second weight value; or
a third merge candidate that is a uni-prediction candidate having the second motion vector associated with the second reference picture list in response to the first weight value being smaller than the second weight value.

15. The method of claim 11, wherein the first merge candidate is a uni-prediction candidate with a first motion vector associated with a first reference picture list, the constructing the extended merge candidate list further comprises:
constructing the extended merge candidate list that comprises the first merge candidate and a second merge candidate that is a uni-prediction candidate having the first motion vector associated with a second reference picture list.

16. The method of claim 11, wherein the first merge candidate is a bi-prediction candidate coded with a first bi-prediction with CU level weight (BCW) index value, the first merge candidate comprises motion information with a first motion vector associated with a first reference picture list and a second motion vector associated with a second reference picture list, the constructing the extended merge candidate list further comprises:
constructing the extended merge candidate list that comprises the first merge candidate and:
one or more second merge candidates that each comprises the motion information in the first merge candidate and is coded with a different BCW index value from the first BCW index value.

17. The method of claim 11, wherein the first merge candidate is a bi-prediction candidate coded with a first bi-prediction with CU level weight (BCW) index value corresponding to non equal weighting, the first merge candidate comprises motion information with a first motion vector associated with a first reference picture list and a second motion vector associated with a second reference picture list, the constructing the extended merge candidate list further comprises:
constructing the extended merge candidate list that comprises the first merge candidate and:
a second merge candidate that comprises the motion information in the first merge candidate and is coded with a second BCW index value corresponding to equal weighting.

18. The method of claim 11, wherein the constructing the extended merge candidate list further comprises:
ordering merge candidates in the extended merge candidate list according to template matching costs.

19. A method of video processing in a decoder, comprising:
receiving a video bitstream comprising a current block in a current picture;
decoding, from the video bitstream, information that indicates the current block in the current picture being an inter prediction block in a merge mode;
constructing a merge candidate list that comprises a plurality of merge candidates obtained from neighboring blocks;
decoding an index indicative of a specific merge candidate in the merge candidate list;
selecting a specific inter prediction direction for associating with the specific merge candidate from a plurality of direction candidates based on template matching costs of the plurality of direction candidates; and
reconstructing the current block based on the specific merge candidate with the specific inter prediction direction.

20. The method of claim 19, wherein the selecting the specific inter prediction direction further comprises at least one of:
determining the specific inter prediction direction for the specific merge candidate in response to the specific merge candidate being obtained from a neighboring block;
determining the specific inter prediction direction for the specific merge candidate in response to a finish of a motion vector refinement on the specific merge candidate;
determining the specific inter prediction direction for the specific merge candidate in response to a finish of a template matching based reordering of the plurality of merge candidates; and
determining the specific inter prediction direction for the specific merge candidate in response to the decoding of the index.
